(19) United States
(12) Patent Application Publication
(10) Pub. No.: US 2014/0343222 A1
(43) Pub. Date: Nov. 20, 2014

(54) POLY(LACTONE)S, METHOD OF MANUFACTURE, AND USES THEREOF

(71) Applicant: SEGETIS, INC., GOLDEN VALLEY, MN (US)

(72) Inventors: Dorie J. Yontz, Bloomington, MN (US); Brian D. Mullen, Delano, MN (US); Cora M. Liebig, Maple Grove, MN (US); Marc David Rodwogin, Minneapolis, MN (US); Vivek Badarinarayana, St. Louis Park, MN (US); Friederike Theresia Stollmaier, Rheinmuenster (DE)

(73) Assignee: SEGETIS, INC, GOLDEN VALLEY, MN (US)

(21) Appl. No.: 14/357,670

(22) PCT Filed: Nov. 12, 2012
(86) PCT No.: PCT/US12/64709

§ 371 Date: May 12, 2014

Related U.S. Application Data
(60) Provisional application No. 61/558,983, filed on Nov. 11, 2011.

(51) Int. Cl. C08G 63/08; B05D 3/00; C09D 167/04

(52) U.S. Cl. CPC C08G 63/08; C09D 167/04; B05D 3/007
USPC 524/599; 528/354; 427/385.5

(57) ABSTRACT

A poly(lactone) of formula (I) wherein b=0 or 1; the molar ratio of w:r:s:t=(0-30):(99.9-2):(0-98):(0-30), and w+s+t is at least 1; R^{1′} R², and R³ are each independently a hydrogen or C₁₋₄ alkyl; R⁴, R⁵, R⁶, and R⁷ are each independently hydrogen, C₁₋₄ alkyl, or F wherein F is a functional group that imparts a property to the poly(lactone) I, at least one and no more than two of R^{4′} R⁵, R⁶, and R⁷ are F, and F is the same or different in each instance; Q′ is a C₁₋₃₀ hydrocarbyl group post-reacted with a crosslinking group and optionally crosslinked with one to five additional polymer backbones, wherein the additional polymer backbone comprises units of formula I; G′ is a single bond to an additional polymer backbone or G′ is a C₁₋₃₀ hydrocarbyl group crosslinked with one to five additional polymer backbones.

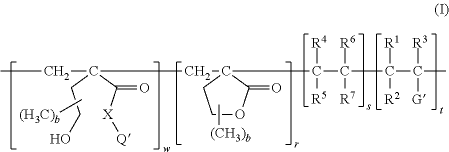

### BACKGROUND

This disclosure relates to biosourced poly(lactone)s, methods for the manufacture of the poly(lactone)s, and uses thereof.

Poly(lactone)s as used herein are polymers that contain lactone groups where a carbon atom of the lactone ring is incorporated into the polymer backbone. Such poly(lactone)s can be distinguished from polymers containing lactone groups where the lactone is pendant from the polymer backbone, on the basis of their methods of manufacture, reactivity, properties, and uses.

### SUMMARY

There remains a continuing need in the art for new types of poly(lactone)s, and in particular poly(lactone)s manufactured from biological, rather than petroleum feedstocks.

Accordingly, in an aspect, the invention is a poly(lactone) comprising units of formula I

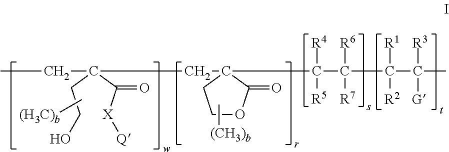

wherein

each b=0 or 1;

the molar ratio of w:r:s:t=(0-30):(99.9-2):(0-98):(0-30), wherein
w is the number of post-reacted and post-crosslinked α-methylene lactone repeat units, r is the number of α-methylene lactone repeat units, s is the number of comonomer repeat units, t is the number of crosslinked repeat units, and
w+s+t is at least 1;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I, at least one and no more than two of R⁴, R⁵, R⁶, and R⁷ are F, and F is the same or different in each instance;

X is a nucleophile residue;

Q′ is a C₁₋₃₀ hydrocarbyl group post-reacted with a crosslinking group and optionally crosslinked with one to five additional polymer backbones, wherein the additional polymer backbone comprises units of formula I;

G′ is a single bond to an additional polymer backbone or G′ is a C₁₋₃₀ hydrocarbyl group crosslinked with one to five additional polymer backbones, wherein the additional polymer backbone comprises units of formula I. Further, one or both of the following two sets of conditions applies:

first,
when w>0, the total number of units (w+r+s+t) is 100 or greater,
when w=0 and t>0, the total number of units (r+s+t) is 5,000 or greater;
when w=0 and t=0, the total number of units is (r+s) is effective to provide a weight average molecular weight of 5,000,000 g/mole or greater; and/or secondly,
when w>0, the ratio of (w+r):t is greater than 100:1
when w=0 and t>0, the ratio of r:t is greater than 5000:1;
when w=0 and t=0, the total of (r+s) is effective to provide a weight average molecular weight of 500,000 g/mol or greater.

In another aspect, a crosslinked poly(lactone) comprises units of formula I-a

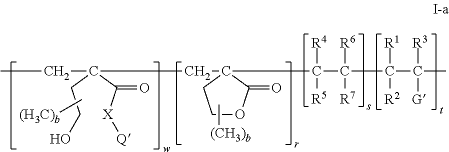

wherein

each b=0 or 1;

the molar ratio of the total of each of w:r:s:t=(0-30):(99.9-2):(0-98):(0.01-30), wherein w is the number of post-reacted α-methylene lactone repeat units, r is the number of α-methylene lactone repeat units, s is the number of comonomer repeat units, t is the number of crosslinked α-methylene lactone repeat units, provided that t is at least 1;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I-a, at least one and no more than two of R⁴, R⁵, R⁶, and R⁷ are F, and F is the same or different in each instance;

X is a nucleophile residue;

Q′ is a C₁₋₃₀ hydrocarbyl group post-reacted with a crosslinking group and optionally crosslinked with one to five additional polymer backbones, wherein the additional polymer backbone comprises units of formula I-a;

G′ is a single bond to an additional polymer backbone or G′ is a C₁₋₃₀ hydrocarbyl group crosslinked with one to five additional polymer backbones, wherein the additional polymer backbone comprises units of formula I-a; and

one or both of the two following conditions are satisfied:
first,
   when w>0, the total number of units (w+r+s+t) is 100 or greater,
   when w=0, the total number of units (r+s+t) is 5,000 or greater; or second,
   when w>0, the ratio of (w+r):t is greater than 100:1
   when w=0 and t>0, the ratio of r:t is greater than 5000:1.

In another aspect, a crosslinked poly(lactone) comprises units of formula I-b

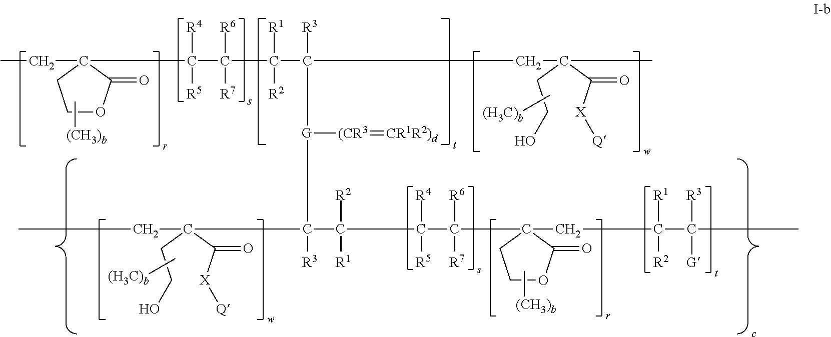

wherein

each b=0 or 1;

the molar ratio of the total of each of w:r:s:t=(0-30):(99.9-2):(0-98):(0.01-30), wherein
w is the number of post-reacted and post-crosslinked α-methylene lactone repeat units, r is the number of α-methylene lactone repeat units, s is the number of comonomer repeat units, and t is the number of crosslinked α-methylene lactone repeat units, and
each value of w, r, s, and t are independent of any other value of w, r, s, and t;

R¹, R², and R³ are each independently a hydrogen or C₁₋₄ alkyl;

R⁴, R⁵, R⁶, and R⁷ are each independently a hydrogen, C₁₋₄ alkyl or F, wherein F is a functional group that imparts a property to the poly(lactone) I-b and at least one and no more than two of R⁴, R⁵, R⁶, and R⁷ are F, and F is the same or different in each instance;

X is a nucleophile residue;

Q′ is a C₁₋₃₀ hydrocarbyl group post-reacted with a crosslinking group and optionally crosslinked with one to five additional polymer backbones;

G′ is a single bond to an additional polymer backbone or G′ is a C₁₋₃₀ hydrocarbyl group crosslinked with one to five additional polymer backbones;

G is a single bond or a C₁₋₃₀ hydrocarbyl group;

c=1-5 and d=0-5 provided that c+d=1-5, and

one or both of the following two conditions are satisfied:
first,
   when w>0, the total number of units (w+r+s+t) is 100 or greater,
   when w=0, the total number of units (r+s+t) is 5,000 or greater; or second,
   when w>0, the ratio of (w+r):t is greater than 100:1
   when w=0 and t>0, the ratio of r:t is greater than 5000:1.

In still another aspect, the invention is a crosslinked poly(lactone) comprising units of formula I-c

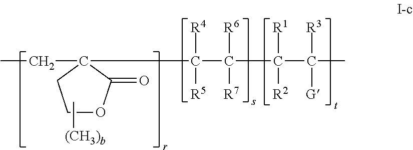

wherein

each b=0 or 1;

the molar ratio of r:s:t=(99.9-2):(0-98):(0-30), wherein r is the number of α-methylene lactone repeat units, s is the number of comonomer repeat units, t is the number of crosslinked repeat units, s+t is at least 1;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I-c, at least one and no more than two of R⁴, R⁵, R⁶, and R⁷ are F, and F is the same or different in each instance;

G is a single bond to an additional polymer backbone or G is a C₁₋₃₀ hydrocarbyl group optionally crosslinked with 0-5 additional polymer backbones, wherein the additional polymer backbone comprises units of formula I-c;

G′ is a single bond to an additional polymer backbone or G′ is a C₁₋₃₀ hydrocarbyl group crosslinked with one to five additional polymer backbones; and

one or both of the following two conditions are satisfied:

first,
the total number of units (r+s+t) is 5,000 or greater; or second,
when t>0, the ratio of r:t is greater than 5,000:1; and
when t=0, the total of (r+s) is effective to provide a weight average molecular weight of 500,000 g/mole or greater.

In another aspect, a poly(lactone) comprises units of formula I-d

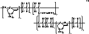

wherein

each b=0 or 1;

the molar ratio of the total of each of r:s:t=(99.9-2):(0-98):(0-30), wherein
r is the number of α-methylene lactone repeat units, s is the number of comonomer repeat units, t is the number of crosslinked repeat units, and s+t=at least 1, and
each value of r, s, and t are independent of any other value of r, s, and t; R¹, R², and R³ are each independently a hydrogen or C₁₋₄ alkyl;

R⁴, R⁵, R⁶, and R⁷ are each independently a hydrogen, C₁₋₄ alkyl or F, wherein F is a functional group that imparts a property to the poly(lactone) I-d and at least one and no more than two of R⁴, R⁵, R⁶, and R⁷ are F, and F is the same or different in each instance;

G is a single bond or a C₁₋₃₀ hydrocarbyl group;

G′ is a single bond to an additional polymer backbone or G′ is a C₁₋₃₀ hydrocarbyl group crosslinked with one to five additional polymer backbones,

when t>0, c=0-5 and d=0-5 provided that c+d=1-5; and

one or both of the following two conditions are satisfied:

first,
the total number of units (r+s+t) is 5,000 or greater; or second,
when t>0, the ratio of r:t is greater than 5,000:1; and
when t=0, the total of (r+s) is effective to provide a weight average molecular weight of 500,000 g/mole or greater.

In still another aspect, a poly(lactone) copolymer is disclosed comprising units of formula I-e,

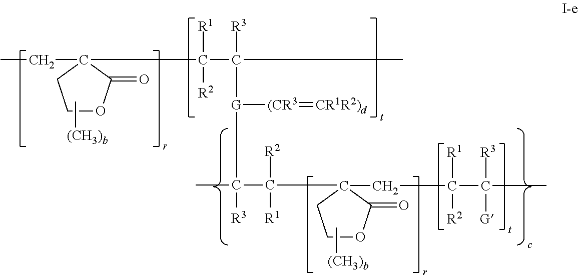

wherein

each b=0 or 1;

the molar ratio of the total of each r:t=(99.99-70):(0.01-30), wherein each value of r and t are independent of any other value of r and t and;

R¹, R², and R³ are each independently a hydrogen or C₁₋₄ alkyl;

G is a single bond or a C₁₋₃₀ hydrocarbyl group;

G′ is a single bond to an additional polymer backbone or G′ is a C₁₋₃₀ hydrocarbyl group crosslinked with one to five additional polymer backbones; and

c=1-5 and d=0-4, provided that c+d=1-5; and

one or both of the following two conditions are satisfied:

first,
the total number of units (r+t) is 5,000 or greater; or second,
when t>0, the ratio of r:t is greater than 5,000:1; and
when t=0, the total of (r+s) is effective to provide a weight average molecular weight of 500,000 g/mole or greater.

In an aspect, the invention is a poly(lactone) comprising units of formula I-f

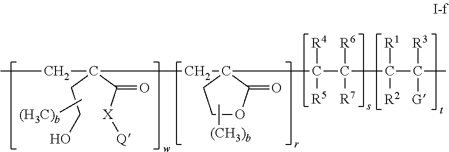

wherein

each b=0 or 1;

the molar ratio of the total of each of w:r:s:t=(0.01-30):(99.99-2):(0-98):(0-30), wherein
w is the mole fraction of post-reacted and post-crosslinked α-methylene lactone repeat units, r is the number of α-methylene lactone repeat units, s is the number of comonomer repeat units, and t is the number of crosslinked α-methylene lacto repeat units, and
each value of w, r, s, and t is independent of every other value of w, r s, and t;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I-f, at least one and no more than two of R⁴, R⁵, R⁶, and R⁷ are F, and F is the same or different in each instance;

G′ is a single bond to an additional polymer backbone or G′ is a C₁₋₃₀ hydrocarbyl group crosslinked with one to five additional polymer backbones;

Q′ is a C₁₋₃₀ hydrocarbyl group crosslinked with one to five additional polymer backbones, wherein the additional polymer backbone comprises units of formula I-f;

X is a nucleophile residue; and

one or both of the following two conditions are satisfied:
first,
   the total number of units (w+r+s+t) is 100 or greater; or second,
   when t>0, the ratio of (w+r):t is greater than 100:1, and
   when t=0, the total of (w1+w2+w3+w4+r+s) is effective to provide a weight average molecular weight of 10,000 g/mol or greater prior to cross-linking.

In still another aspect, the invention is a crosslinked poly(lactone) comprising units of formula I-g

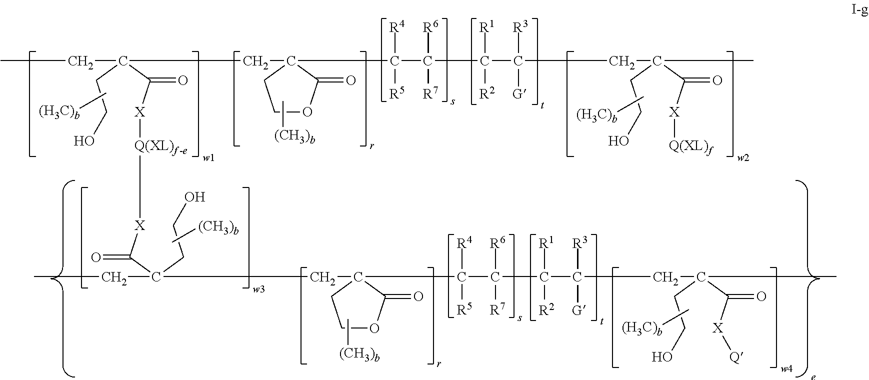

wherein

each b=0 or 1;

the molar ratio of the total of each of (w1+w2+w3+w4):r:s:t=(0.01-30):(99.99-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units,
t is the number of crosslinked repeat units, and
each value of w1, w2, w4, r, s, and t are independent of any other value of w1, w2, w4, r, s, and t, and; and

Q′ is a C₁₋₃₀ hydrocarbyl group post-reacted with a crosslinking group and optionally crosslinked with one to five additional polymer backbones, wherein the additional polymer backbone comprises units of formula I-g;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I-g, at least one and no more than two of R⁴, R⁵, R⁶, and R⁷ are F, and F is the same or different in each instance;

G′ is a single bond to an additional polymer backbone or G′ is a C₁₋₃₀ hydrocarbyl group crosslinked with one to five additional polymer backbones;

Q is a C₁₋₃₀ hydrocarbyl group;

X is a nucleophile residue;

L is a leaving group;

f=1-5 and e=1-5 provided that e+f=1-5; and

and

one or both of the following two conditions are satisfied:
first,
   the total number of units (w1+w2+w3+w4+r+s+t) is 100 or greater; or second,
   when t>0, the ratio of (w1+w2+w3+w4+r):t is greater than 100:1;
   when t=0, the total of (w1+w2+w3+w4+r+s) is effective to provide a weight average molecular weight of 10,000 g/mol or greater prior to cross-linking.

In still another aspect, the invention is a poly(lactone) comprising units of formula I-h

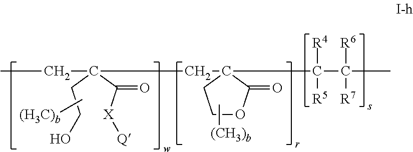

wherein

each b=0 or 1;

the molar ratio of w:r:s=(0.01-30):(99.99-2):(0-97.99), wherein w is the mole fraction of post-reacted and post-crosslinked α-methylene lactone repeat units, r is the number of α-methylene lactone repeat units, and s is the number of comonomer repeat units;

R⁴, R⁵, R⁶, and R⁷ are each independently a hydrogen, C₁₋₄ alkyl, or F, wherein F is a functional group that imparts a property to the poly(lactone) I-h, at least one and no more than two of R⁴, R⁵, R⁶, and R⁷ are F, and F is the same or different in each instance;

X is a nucleophile residue;

Q′ is a C₁₋₃₀ hydrocarbyl group crosslinked with one to five additional polymer backbones, wherein the additional polymer backbone comprises units of formula I-h; and

the total number of units (w+r+s) is 100 or greater, the total of (w+r+s) is effective to provide a weight average molecular weight of 10,000 g/mol or greater prior to cross-linking, or both.

In still another aspect, the invention is a post-crosslinked poly(lactone) comprising units of formula I-i

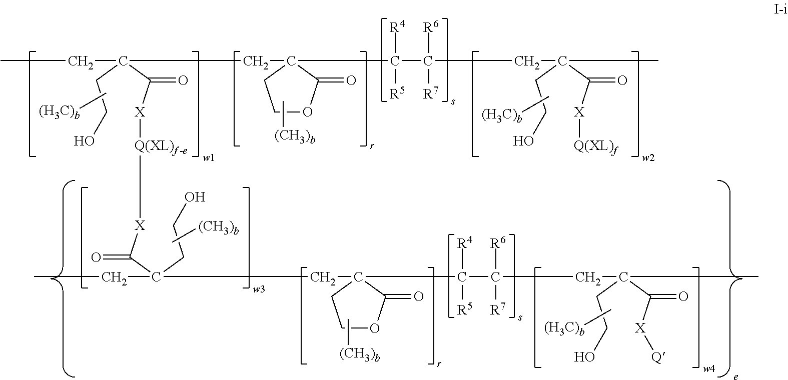

wherein

each b=0 or 1;

the molar ratio of the total of each of (w1+w2+w3+w4):r:s:t=(0.01-30):(99.9-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units, and

each value of w1, w2, w4, r, s, and t are independent of any other value of w1, w2, w4, r, s, and t;

R¹, R², and R³ are each independently a hydrogen or C₁₋₄ alkyl;

R⁴, R⁵, R⁶, and R⁷ are each independently a hydrogen, C₁₋₄ alkyl, or F, wherein F is a functional group that imparts a property to the poly(lactone) I-i, at least one and no more than two of R⁴, R⁵, R⁶, and R⁷ are F, and F is the same or different in each instance;

Q′ is a C₁₋₃₀ hydrocarbyl group post-reacted with a crosslinking group and optionally crosslinked with one to five additional polymer backbones;

Q is a C₁₋₃₀ hydrocarbyl group crosslinked with one to five additional polymer backbones,

X is a nucleophile residue;

L is a leaving group;

f=1-5 and e=1-5 provided that e+1-5; and

the total number of units (w1+w2+w3+w4+r+s) is 100 or greater the total of (w1+w2+w3+w4+r+s) is effective to provide a weight average molecular weight of 10,000 g/mol or greater prior to cross-linking, or both.

In still another aspect, the invention is a crosslinked poly(lactone) comprising units of formula I-j

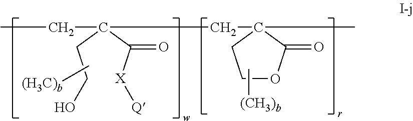

wherein

each b=0 or 1;

the molar ratio of w:r=(0.01-30):(99.99-70), wherein w is the mole fraction of post-reacted and post-crosslinked α-methylene lactone repeat units and r is the number of α-methylene lactone repeat units;

X is a nucleophile residue;

Q′ is a C₁₋₃₀ hydrocarbyl group post-reacted with a crosslinking group wherein at least one Q′ is crosslinked with one to five additional polymer backbones; and

the total number of units (w+r) is 100 or greater, the total of (w+r) is effective to provide a weight average molecular weight of 10,000 g/mol or greater prior to cross-linking, or both.

In still another aspect, the invention is a crosslinked poly(lactone) comprising units of formula I-k

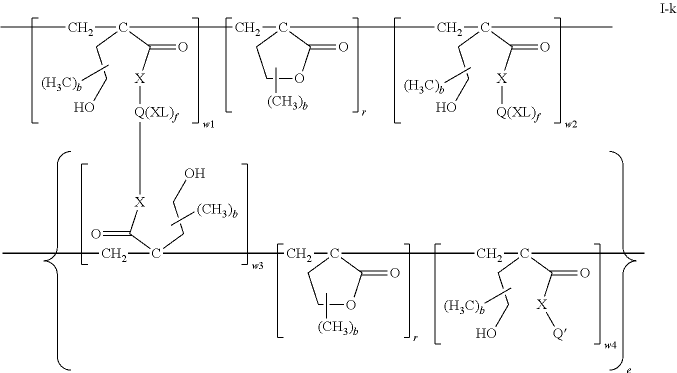

wherein

each b=0 or 1;

the molar ratio of the total of each of (w1+w2+w3+w4):r=(0.01-30):(99.9-70) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least one, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones, and
r is the number of α-methylene lactone repeat units;
each value of w1, w2, w4, and r are independent of any other value of w1, w2, w4, r, s, and t;

Q′ is a C₁₋₃₀ hydrocarbyl group post-reacted with a crosslinking group and optionally crosslinked with one to five additional polymer backbones;

Q is a C₁₋₃₀ hydrocarbyl group crosslinked with one to five additional polymer backbones,

X is a nucleophile residue;

L is a leaving group;

f=1-5 and e=1-5 provided that e+1-5; and

the total number of units (w1+w2+w3+w4+r) is 100 or greater, the total of (w1+w2+w3+w4+r) is effective to provide a weight average molecular weight of 10,000 g/mol or greater prior to cross-linking, or both.

Also disclosed is a method of preparing a poly(lactone) of formula I, including a poly(lactone) of any of formulas I-a to I-k, the method comprising

polymerizing an ethylenically unsaturated monomer of formula II,

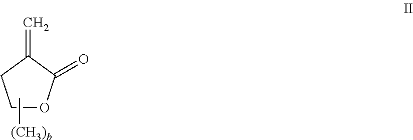

wherein each b=0 or 1, and

a crosslinking monomer of formula III, a comonomer of formula IV, or a combination comprising one or both of crosslinking monomer III and comonomer IV,

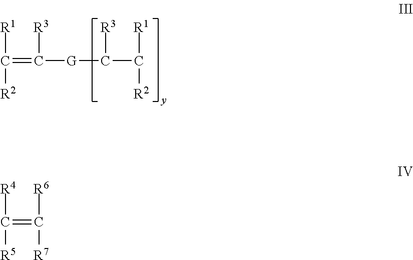

wherein

R¹, R², and R³ are each independently hydrogen or C₁₋₄alkyl;

G is a single bond or a C₁₋₃₀ hydrocarbyl group; and

y=1-5; and

R⁴, R⁵, R⁶ and R⁷ are each independently a hydrogen, C₁₋₄ alkyl or F, wherein F is a functional group that imparts a property to the poly(lactone), and at least one and no more than two of R⁴, R⁵, R⁶ and R⁷ are F, and F is the same or different in each instance, to form an optionally crosslinked polymer; and

optionally, post-reacting crosslinking the polymer with a post-crosslinking monomer of formula VI

[LX]-Q-[XL]_{z} V

wherein

Q is a C₁₋₃₀ hydrocarbyl group;

X is a nucleophile reactive with a lactone group;

L is a leaving group; and

z=1-5.

Also disclosed is a composition including the poly(lactone) of formula I, a poly(lactone) of any of formulas I-a to I-k, or a combination thereof

In another aspect, a poly(lactone) copolymer is disclosed comprising units of formula I-m,

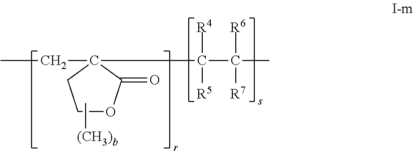

wherein

each b=0 or 1;

the molar ratio of r:s=(99.99-2):(0.01-98);

R⁴, R⁵, R⁶, and R⁷ are each independently a hydrogen, C₁₋₄ alkyl or F, wherein at least one and no more than two of R⁴, R⁵, R⁶ and R⁷ are F and F is the same or different in each instance; and

r and s are integers effective to provide a polymer having a weight average molecular weight of at least 500,000 g/mol.

Also disclosed is a method of preparing a poly(lactone) I-m, comprising polymerizing an ethylenically unsaturated monomer II,

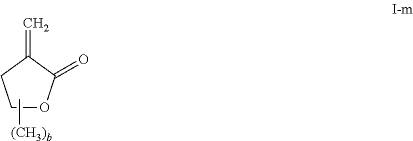

wherein each b=0 or 1, with at least one comonomer of formula IV,

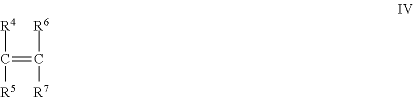

wherein R⁴, R⁵, R⁶ and R⁷ are each independently a hydrogen, C₁₋₄ alkyl or F, wherein F is a functional group that imparts a property to the poly(lactone) I-m, and at least one and no more than two of R⁴, R⁵, R⁶ and R⁷ are F and F is the same or different in each instance.

Also disclosed is a composition including the poly(lactone) I-m.

In yet another embodiment, a poly(lactone) I-n is disclosed,

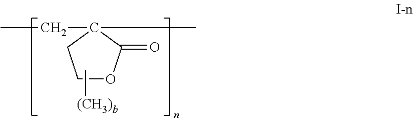

wherein each b=0 or 1 and n is a number effective to provide a molecular weight of 500,000 g/mol or greater.

Also disclosed is a method of preparing a poly(lactone) of formula I-n, comprising polymerizing an ethylenically unsaturated monomer II,

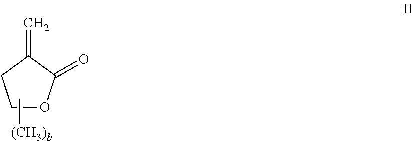

wherein each b=0 or 1.

Also disclosed is a composition including the poly(lactone) I-n.

Films comprising any one or more of the foregoing poly(lactone)s are also described.

In an aspect, a coating composition comprises a polymer binder; an aqueous phase; and the poly(lactone) I, specifically the poly(lactone) I-a to I-o, or a combination thereof. A method of preparing the coating composition comprises combining the polymer binder, the poly(lactone) I, specifically the poly(lactone) I-a to I-o, or a combination thereof, and the aqueous phase.

In another aspect, a coated substrate comprises a substrate having a surface; and a coating disposed on the surface, wherein the coating comprises a polymer binder; optionally a pigment or a dye; and poly(lactone) I, specifically the poly(lactone) I-a to I-o, or a combination thereof. The coatings can be paints, inks, stains, caulks, and clear-coats, for example. A method of coating a substrate comprises contacting a coating composition comprising poly(lactone) I, specifically the poly(lactone) I-a to I-o, or a combination thereof, with a surface of the substrate to form a coating; and drying the coating.

The invention is further illustrated by the following Detailed Description and Examples.

### DETAILED DESCRIPTION

Poly(lactone)s are used in a variety of applications, including use as films and fillers. There remains a continuing need in the art for new types of poly(lactone)s, and in particular poly(lactone)s manufactured from biological, rather than petroleum feedstocks. The option to incorporate various types of functionality into the poly(lactone)s would further be useful, particularly if the type and amount of functional groups could be present in a selected mole percent. A still further advantage would be for such polymers to be crosslinked, or to have additional functionality for crosslinking. The production of poly(lactone)s of high molecular weights would also be advantageous.

A new class of poly(lactone)s is described, wherein each poly(lactone) can contain a biosourced unit. The poly(lactone)s can be copolymerized with various monomer units and/or crosslinking agents to affect the functionality and/or properties of the poly(lactone)s. The percent of poly(lactone) units can be selected to provide the desired properties. It is possible to crosslink the poly(lactone)s using the hydroxyl groups, carboxyl groups, or both of the poly(lactone), with or without an added crosslinking agent. In addition, the poly(lactone)s can be crosslinked by the inclusion of a crosslinking monomer during polymerization of the poly(lactone). The functionality and/or properties of the poly(lactone)s can be modified by incorporation of a selected type and amount comonomer. Advantageously, the poly(lactone)s can be derived from biological feedstocks, in particular poly(lactone)s such as angelica poly(lactone). Additionally, the poly(lactone)s can be derived from petroleum or renewable building blocks such as succinic acid, butanediol, gamma-butyropoly(lactone), gamma-valeropoly(lactone), or levulinic acid/esters.

In an embodiment, a poly(lactone) comprises units as shown in formula I.

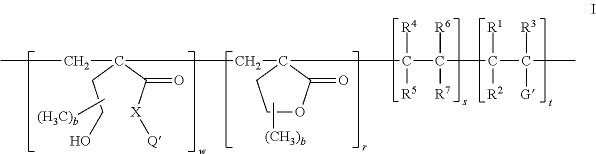

In the poly(lactone) of formula I, b is each independently 0 or 1, i.e., the polymer can contain r units wherein b=0 together with r units wherein b=1. When b is 1, the methyl group can be located on the carbon gamma to the carbonyl group or beta to the carbonyl group. In an embodiment, the methyl group is located gamma to the carbonyl group.

R¹, R² and R³, at each occurrence in the poly(lactone) of formula I are each independently a hydrogen or C₁₋₄ alkyl. In an embodiment, R¹ and R² are hydrogen and R³ at each occurrence is the same or different and is a C₁₋₄ alkyl. In an embodiment each R³ is the same, and is a C₁₋₄ alkyl, specifically methyl. In another embodiment, R¹, R², and R³ are each hydrogen.

R⁴, R⁵, R⁶ and R⁷ in the poly(lactone) of formula I are each independently a hydrogen, C₁₋₄ alkyl or a substituent F, wherein at least one and no more than two of R⁴, R⁵, R⁶ and R⁷ are F. Each F can be the same or different. F is a functional substituent that imparts a property to the poly(lactone) I. Without being limited, exemplary properties include solubility (for example hydrophobicity and/or hydrophilicity), charge, polarity, color, hygroscopicity, degradability (e.g., susceptibility to hydrolysis), detectability (e.g., via a fluorescent tag, radioactivity, luminosity, or the like). The property can affect the production and/or use of the compound. For example, when F is a charged group, the presence of the charged group can affect an emulsion polymerization process used to manufacture the poly(lactone) and/or the final properties of the poly(lactone), and thus its use.

F can be an alcohol, carboxy acid, carboxy acid salt, carboxy (C₁₋₂₄ alkyl) ester, carboxy (C₁₋₂₄ hydroxyalkyl) ester, —NR′R″ (wherein each R′ and R″ is independently hydrogen or C₁₋₂₄ alkyl), thio, carbamyl, C₁₋₂₄ alkyl, C₂₋₂₄ alkenyl, C₂₋₂₄ alkynyl, C₃₋₈ cycloalkyl, C₃₋₇ heterocycloalkyl, C₆₋₁₂ aryl, or C₃₋₁₁ heteroaryl, or two F groups on adjacent carbon atoms can form a 5- or 6-membered cycloalkyl or heterocycloalkyl ring including the carbon atoms, wherein the foregoing hydrocarbyl groups can be unsubstituted or substituted with one or more of a carboxy acid, carboxy acid salt, carboxy (C₁₋₂₄ alkyl) ester, carboxy (C₁₋₂₄ hydroxy alkyl) ester, oxo (═O), —NR′R″ (wherein each R′ and R″ is independently hydrogen or C₁₋₂₄ alkyl,) thio, carbamyl, or combination thereof. In an embodiment, R⁴ and R⁵ are hydrogen, R⁶ is methyl or hydrogen, and R⁷ is a carboxylic acid, ester, or salt, specifically a carboxylic acid. In another embodiment, the group F is derived from reaction of acrylic acid, methacrylic acid, fumaric acid, itaconic acid, maleic acid, maleic anhydride, maleimide, itaconic anhydride, or a combination thereof as a comonomer as described below.

G′ in formula I is a single bond to an additional polymer backbone or G′ is a C₁₋₃₀ hydrocarbyl group crosslinked with one to five additional polymer backbones, wherein the additional polymer backbone comprises units of formula I. It will be understood that the additional polymer backbones crosslinked to G′ can further contain units additional units containing Q′ and/or G′, but for simplicity, the additional polymer backbones have not been shown in formula I.

Q′ in formula I is a C₁₋₃₀ hydrocarbyl group post-reacted with a crosslinking group, where the crosslinking group may optionally be crosslinked with one to five additional polymer backbones, wherein the additional polymer backbone comprises units of formula I. It will be understood that the additional polymer backbones crosslinked to Q′ can further contain units additional units containing Q′ or G′, but for simplicity, the additional polymer backbones have not been shown in formula I.

X in formula I is a nucleophile residue, for example a group containing a nucleophilic phosphorus, oxygen, sulfur, or nitrogen. It will be understood that in all of the formulas herein, the group X is a nucleophile effective to open the lactone in the polymer backbone. In an embodiment, X is a nucleophile residue wherein the nucleophilic atom is an oxygen atom or nitrogen atom. Examples of nucleophile residues containing a nucleophilic oxygen atom include —O— and —OC(═O)C—. Examples of nucleophile residues containing a nucleophilic nitrogen atom include —NH— and —NR— wherein R is a C₁₋₁₀ hydrocarbyl group, for example a C₁₋₃ alkyl group. Other nucleophile residues are known in the art and can be used.

In the poly(lactone) I, w, r, s, and t are used to define the number of each of the units, and are not intended to limit the order of the units in the poly(lactone) or the type of distribution of the units in the poly(lactone). Thus, each of the w r, s, and t units can be randomly or non-randomly arranged, or some units can be randomly arranged and some non-randomly arranged (e.g., in blocks). In addition, the values of w, r, s, and t can vary independently for each crosslinked polymer backbone, i.e., the values of w, r, s, and t in the main polymer fragment of I can be different from the values of r, s, and t in the additional polymer backbones crosslinked to Q′ or G′.

The values of the total of each w, r, s, and t in the poly(lactone)s I will vary depending on the overall length of the poly(lactone) as described in further detail below, as well as the ratio of monomers used to form the poly(lactone). The values for the total of each of w (i.e., all post-reacted and post-crosslinked α-methylene lactone repeat units, irrespective of location in the polymer backbone or additional polymer backbone), r (i.e., all α-methylene lactone repeat units, irrespective of location in the polymer backbone or additional polymer backbone), s (i.e., all comonomer repeat units, irrespective of location in the polymer backbone or additional polymer backbone), and t (i.e., all crosslinked α-methylene lactone repeat units, irrespective of location in the polymer backbone or additional polymer backbone) can be expressed as a molar ratio of the units, which as expressed herein is based on 100 moles of repeat units. Thus, in an embodiment, the molar ratio of the total of each of w:r:s:t=(0-30):(99.99-2):(0-98):(0-30) provided that w+s+t=at least 1, that is, at least one w, s or t unit is present. In a specific embodiment, the molar ratio of the total of each of w:r:s:t=(0-25):(80-1):(0-75):(0-25), provided that w+s+t=at least 1; more specifically, w:r:s:t=(0-25):(70-10):(0-50):(0-25) provided that w+s+t=at least 1; still more specifically w:r:s:t=(0-25):(70-10):(0-40):(0.01-25) provided that t=at least 1; or w:r:s:t=(0.01-25):(70-10):(0-40):(0-25) provided that w=at least 1; or w:r:s:t=(0.01-25):(70-10):(0-40):(0.01-25) provided that w and t is each at least 1. Other ratios are described in the sub-formulas below.

The total number of units (w+r+s+t) as well as the molar ratio of the units is selected based on the desired properties, for example the desired degree of crosslinking, solubility, and other parameters. In an embodiment the total number of units is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, for example where no post-crosslinked α-methylene lactone repeat units are present, the total number of units is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when w>0, the ratio of (w+r):t is greater than 100:1, greater than 200:1, greater than 300:1, greater than 500:1 or greater than 700:1 or greater than 1000:1; or when w=0 and t>0, the ratio of r:t is greater than 5,000:1, greater than 6,000:1, greater than 8,000:1, or greater than 10,000:1, up to 50,000:1 or up to 80,000:1.

The weight average molecular weight (Mw) of the poly(lactone) I can be 10,000, 20,000, 50,000, 100,000, 150,000, 200,000, 250,000, 300,000, 400,000, 500,000, 550,000, 600,000, 700,000, 750,000, 800,000 grams/mole (g/mole) or more. For example, the weight average molecular weight can be 10,000 to 3,000,000 grams per mole; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol. When w=0 and t=0, the total of (r+s) is effective to provide a weight average molecular weight of 500,000 g/mol or greater.

In some embodiments at least one crosslinked α-methylene lactone repeat unit containing G′ is present, such that a crosslinked poly(lactone) comprises units of formula I-a

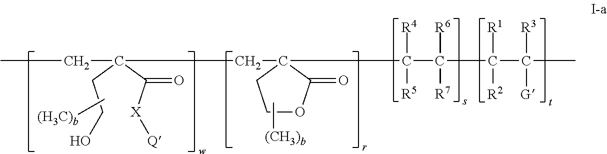

wherein b, R¹, R², R³, R⁴, R⁵, R⁶, R⁷, Q′, and G′ are as described in formula I.

Further in formula I-a, t is at least one, and the molar ratio of the total of each of w:r:s:t=(0-30):(99.99-2):(0-98):(0.01-30). In a specific embodiment, the molar ratio of the total of each of w:r:s:t=(0-25):(80-1):(0-75):(00.1-25); more specifically, w:r:s:t=(0-25):(70-10):(0-50):(1-25); still more specifically w:r:s:t=(0-25):(70-10):(0-40):(3-25).

In an embodiment the total number of units (w+r+s+t) is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, for example where no post-crosslinked α-methylene lactone repeat units are present, the total number of units is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when w>0, the ratio of (w+r):t is greater than 100:1, greater than 200:1, greater than 300:1, greater than 500:1 or greater than 700:1 or greater than 1000:1; or when w=0 and t>0, the ratio of r:t is greater than 5,000:1, greater than 6,000:1, greater than 8,000:1, greater than 10,000:1, up to 50,000:1, or up to 80,000:1.

The weight average molecular weight (Mw) of the poly(lactone) I-a can be 10,000, 20,000, 50,000, 100,000, 150,000, 200,000, 250,000, 300,000, 400,000, 500,000, 550,000, 600,000, 700,000, 750,000, 800,000 grams/mole (g/mole) or more. For example, the weight average molecular weight can be 10,000 to 3,000,000 grams per mole; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

In another aspect wherein t is at least one, a crosslinked poly(lactone) comprises units of formula I-b

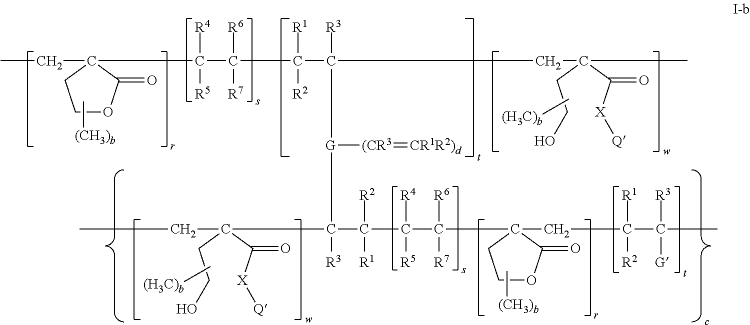

wherein b, R¹, R², R³, R⁴, R⁵, R⁶, R⁷, X, Q′, and G′ are as described in formula I.

G in the poly(lactone)s of formula I is a single bond or a C₁₋₃₀ hydrocarbyl group having a valence c+d+1. G is a single bond or a residue of a crosslinking molecule having at least two (specifically, c+d+1) sites of ethylenic unsaturation, wherein crosslinking can occur upon polymerization as described below. As set forth below in the definitions, a hydrocarbyl group as used herein means a group having the specified number of carbon atoms and the appropriate valence in view of the number of substitutions shown in the structure. Hydrocarbyl groups contain at least carbon and hydrogen, and can optionally contain 1 or more (e.g., 1-8) heteroatoms selected from N, O, S, Si, P, or a combination thereof. Hydrocarbyl groups can be substituted or unsubstituted.

More specifically, G can be a single bond or a C₁₋₁₂ alkyl substituted with 0-6 (C₁₋₆)alkoxycarbonyl groups, 0-6 oxycarbonyl groups, 0-6 aminocarbonyl groups, or a combination thereof, C₂₋₁₂ alkenyl substituted with 0-6 (C₁₋₆)alkoxycarbonyl groups, 0-6 oxycarbonyl groups, 0-6 aminocarbonyl groups, or a combination thereof, C₂₋₁₂ alkynyl substituted with 0-6 (C₁₋₆)alkoxycarbonyl groups, 0-6 oxycarbonyl groups, 0-6 aminocarbonyl groups, or a combination thereof, C₃₋₈ cycloalkyl substituted with 0-4 oxycarbonyl groups, 0-4 aminocarbonyl groups, or a combination thereof, C₃₋₈ heterocycloalkyl substituted with 0-4 (C₁₋₆)alkoxycarbonyl groups, 0-4 oxycarbonyl groups, 0-4 aminocarbonyl groups, or a combination thereof, C₆₋₁₂ aryl substituted with 0-6 (C₁-6)alkoxycarbonyl groups, 0-6 oxycarbonyl groups, 0-6 aminocarbonyl groups, or a combination thereof, C₃₋₁₂ heteroaryl substituted with 0-4 (C₁₋₆)alkoxycarbonyl groups, 0-4 oxycarbonyl groups, 0-4 aminocarbonyl groups, or a combination thereof, or C₂₋₂₄ (C₁₋₄ alkyloxy)ₑ(C₁₋₄alkyl) groups wherein e=1-16 substituted with 0-6 oxycarbonyl groups, 0-6 aminocarbonyl groups, or a combination thereof. Specific types of G groups include ethers, esters, amides, and isocyanurates.

The number of poly(lactone) backbones or fragments c and ethylenically unsaturated groups d per crosslinker unit depends on the number ethylenically unsaturated groups in the crosslinker monomer and the extent to which the ethylenically unsaturated groups react. Accordingly, c=0-5 and d=0-5, provided that c+d=1-5. Alternatively, c=1-5 and d=0-4, provided that c+d=1-5, or c=2-5 and d=0-3, provided that c+d=1-5. When d=0, all ethylenically unsaturated units in the crosslinking monomer have reacted during polymerization.

Further in formula I-b, t is at least one, and the molar ratio of the total of each of w:r:s:t=(0-30):(99.99-2):(0-98):(0.01-30). In a specific embodiment, the molar ratio of the total of each of w:r:s:t=(0-25):(80-1):(0-75):(0.1-25); more specifically, w:r:s:t=(0-25):(70-10):(0-50):(1-25); still more specifically w:r:s:t=(0-25):(70-10):(0-40):(3-25).

In an embodiment the total number of units is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, for example where no post-crosslinked α-methylene lactone repeat units are present, the total number of units is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when w>0, the ratio of (w+r):t is greater than 100:1, greater than 200:1, greater than 300:1, greater than 500:1 or greater than 700:1, greater than 1000:1, or greater than 5,000:1, up to 50,000 to 1 or up to 80,000:1; or when w=0 and t>0, the ratio of r:t is greater than 5,000:1, greater than 6,000:1, greater than 8,000:1, or greater than 10,000:1, up to 50,000:1, or up to 80,000:1.

The weight average molecular weight (Mw) of the poly(lactone) I-b can be 10,000, 20,000, 50,000, 100,000, 150,000, 200,000, 250,000, 300,000, 400,000, 500,000, 550,000, 600,000, 700,000, 750,000, 800,000 grams/mole (g/mole) or more. For example, the weight average molecular weight can be 10,000 to 3,000,000 grams per mole; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol. When w=0 and t=0, the total of (r+s) is effective to provide a weight average molecular weight of 500,000 g/mol or greater

In certain embodiments no post-polymerization reaction or crosslinking is carried out The poly(lactone)s of this type comprise units of formula I-c

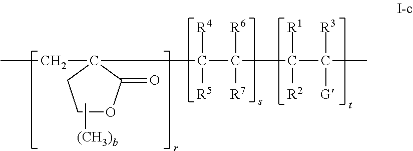

wherein b, R¹, R², R³, R⁴, R⁵, R⁶, R⁷, and G′ are as described in formula I.

In formula I-c, the molar ratio of r:s:t=(99.99-2):(0-98):(0-30) provided that s+t=at least 1, that is, at least one s or t unit is present. In a specific embodiment, the molar ratio of r:s:t=(80-1):(0-75):(0-25), provided that s+t=at least 1; more specifically, r:s:t=(70-10):(0-50):(0-25) provided that s+t=at least 1; still more specifically r:s:t=(70-10):(0-40):(3-25) provided that s+t=at least 1. In still another embodiment, r:s:t=(80-1):(0-50):(0-25) provided that s+t=at least 1, or (70-10):(0-30):(0-20); more specifically, r:s:t=(70-10):(0-30):(0-10); still more specifically r:s:t=(70-10):(1-30):(1-20).

In an embodiment the total number of units (r+s+t) is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when t>0, the ratio of r:t is greater than 5000:1, greater than 6,000:1, greater than 8,000:1, or greater than 10,000:1, up to 80,000:1.

The weight average molecular weight (Mw) of the poly(lactone) I-c can be 500,000, 550,000, 600,000, 700,000, 750,000, 800,000 grams/mole (g/mole) or more, up to 3,000,000 grams per mole, up to 2,500,000 g/mol, up to 2,000,000 g/mol, up to 1,500,000 g/mol, or up to 1,000,000 g/mole or up to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

Poly(lactone)s of this type can alternatively comprise units represented by formula I-d

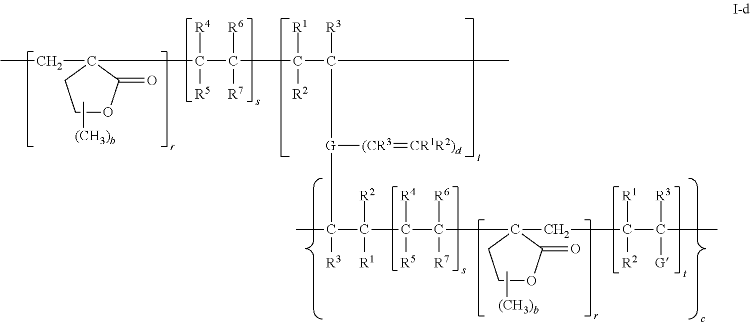

wherein b, R¹, R², R³, R⁴, R⁵, R⁶, R⁷, c, d, G′, and G are as described in formula I and formula I-b.

In formula I-d, the molar ratio of the total of each of r:s:t=(99.99-2):(0-98):(0-30) provided that s+t=at least 1, that is, at least one s or t unit is present. In a specific embodiment, the molar ratio of r:s:t=(80-1):(0-75):(0-25), provided that s+t=at least 1; more specifically, r:s:t=(70-10):(0-50):(0-25) provided that s+t=at least 1; still more specifically r:s:t=(70-10):(0-40):(3-25) provided that s+t=at least 1. In still another embodiment, the total of each of r:s:t=(80-1):(0-50):(0-25) provided that s+t=at least 1, or (70-10):(0-30):(0-20); more specifically, r:s:t=(70-10):(0-30):(0-10); still more specifically r:s:t=(70-10):(1-30):(1-20).

In an embodiment the total number of units (r+s+t) is at least 5,000, at least 6,000, at least 7,000, at least 8,000, at least 9,000, or at least 9,500, up to, for example, 30,000 or less, 25,000 or less, 20,000 or less, 10,000 or less.

In an embodiment the total number of units (r+s+t) is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when t>0, the ratio of r:t is greater than 5000:1, greater than 6,000:1, greater than 8,000:1, or greater than 10,000:1, up to 80,000:1.

The weight average molecular weight (Mw) of the poly(lactone) I-d can be 500,000, 550,000, 600,000, 700,000, 750,000, 800,000 grams/mole (g/mole) or more, up to 3,000,000 grams per mole, up to 2,500,000 g/mol, up to 2,000,000 g/mol, up to 1,500,000 g/mol, or up to 1,000,000 g/mole or up to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

Poly(lactone)s of formula I-d, when the comonomer is not present, comprise units of formula I-e

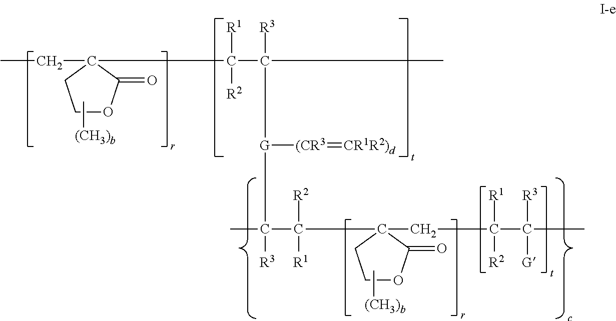

wherein b, R¹, R², R³, c, d, G′, and G are as described in formula I and formula I-b.

In formula I-e, the molar ratio of the total of each r:t=(99.99-70):(0.01-30), provided that t is at least 1. In a specific embodiment, the total of each r:t=(99.9-70):(0.1-30), or =(99-70):(1-30), or (97-70):3-25, again provided that t is at least 1.

In an embodiment the total number of units (r+t) is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when t>0, the ratio of r:t is greater than 5000:1, greater than 6,000:1, greater than 8,000:1, or greater than 10,000:1, up to 80,000:1.

The weight average molecular weight (Mw) of the poly(lactone) I-e can be 500,000, 550,000, 600,000, 700,000, 750,000, 800,000 grams/mole (g/mole) or more, up to 3,000,000 grams per mole, up to 2,500,000 g/mol, up to 2,000,000 g/mol, up to 1,500,000 g/mol, or up to 1,000,000 g/mole or up to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

As described above in reference to formula I, poly(lactone)s comprising post-crosslinked units comprise units of formula I-f

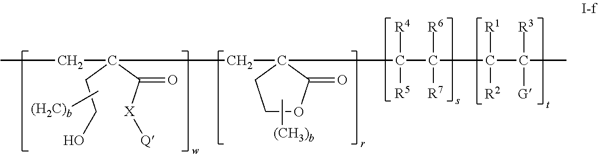

wherein b, R¹, R², R³, R⁴, R⁵, R⁶, R⁷, X, Q′, and G′ are as described in formula I.

Further in formula I-f, w is at least 1, and the molar ratio of the total of each of w:r:s:t=(0.01-30):(99.99-2):(0-98):(0-30), specifically (0.1-30):(99.9-2):(0-97.9):(0-30), or =(1-30):(99-2):(0-97):(0-30), or (3-25):(97-2):(0-95):(0-30). Alternatively in formula I-f, w is at least 1, and the molar ratio of the total of each of w:r:s:t=(0.01-30):(99.98-2):(0-97.98):(0.01-30), specifically (0.1-30):(99.8-2):(0-97.8):(0.1-30), or =(1-30):(98-2):(0-97):(1-30), or (3-25):(97-2):(0-95):(3-25).

In an embodiment the total number of units is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when t>0, the ratio of (w+r):t is greater than 100:1, greater than 200:1, greater than 300:1, greater than 500:1 or greater than 700:1, or greater than 1000:1, greater than 5,000:1, up to 50,000 to 1 or up to 80,000:1.

The weight average molecular weight of the poly(lactone) I-f can be 10,000, 20,000, 50,000, 100,000, 150,000, 200,000, 250,000, 300,000, 400,000, 500,000, 550,000, 600,000, 700,000, 750,000, 800,000 g/mole or more, each prior to crosslinking. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol, each prior to crosslinking. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol, each prior to crosslinking. In an embodiment when t=0, the total of (w+r+s) is effective to provide a weight average molecular weight of 10,000 g/mol or greater, or 500,000 g/mol or greater prior to cross-linking.

Such post-crosslinked poly(lactone)s can comprise repeat units of formula I-g

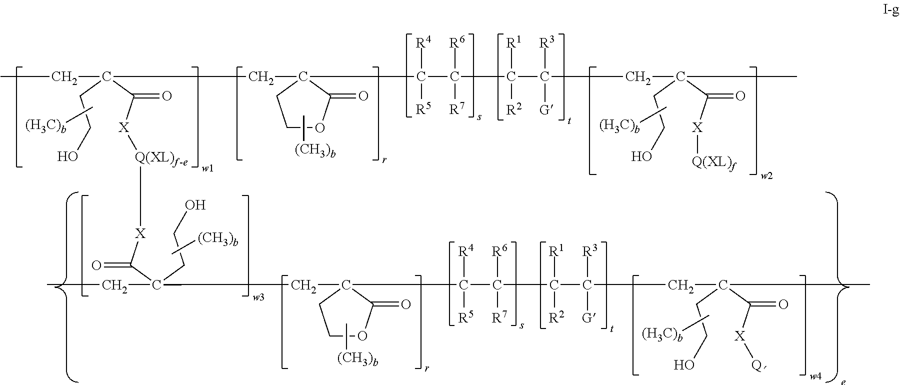

wherein b, R¹, R², R³, R⁴, R⁵, R⁶, R⁷, Q′, X, and G′ are as described in formula I and formula I-b.

Further in formula I-g, 1-5 and e=1-5, provided that e+1-5. In an embodiment, f=1-4 and e=1-4, provided that e+1-4; or 1-3 and e=1-3, provided that e+f=1-3; or 1-2 and e=1-2, provided that e+1-2; or 1 and e=1.

Q in formula I-g is a C₁₋₃₀ hydrocarbyl group, X is a nucleophile residue, and L is a leaving group. As will be described in detail below, the moiety-X-Q(XL)ᵣ-X- is formed by post-reaction of a lactone functionality with the nucleophile -XL of a crosslinking group having at least two (specifically, f) nucleophilic groups -XL, resulting in ring-opening. Subsequent reaction with the second nucleophilic group -XL with a lactone of another polymer chain results in the crosslink -X-Q(XL)_{f-e}-X-. Leaving groups for nucleophile X are known in the art, for example, hydrogen, a halogen, and the like, and depend on the nucleophile.

Q can be a C₁₋₁₂ alkyl substituted with 0-6 (C₁₋₆)alkoxycarbonyl groups, 0-6 oxycarbonyl groups, 0-6 aminocarbonyl groups, or a combination thereof, C₂₋₁₂ alkenyl substituted with 0-6 (C₁₋₆)alkoxycarbonyl groups, 0-6 oxycarbonyl groups, 0-6 aminocarbonyl groups, or a combination thereof, C₂₋₁₂ alkynyl substituted with 0-6 (C₁₋₆)alkoxycarbonyl groups, 0-6 oxycarbonyl groups, 0-6 aminocarbonyl groups, or a combination thereof, C₃₋₈ cycloalkyl substituted with 0-4 oxycarbonyl groups, 0-4 aminocarbonyl groups, or a combination thereof, C₃₋₈ heterocycloalkyl substituted with 0-4 (C₁₋₆)alkoxycarbonyl groups, 0-4 oxycarbonyl groups, 0-4 aminocarbonyl groups, or a combination thereof, C₆₋₁₂ aryl substituted with 0-6 (C₁₋₆)alkoxycarbonyl groups, 0-6 oxycarbonyl groups, 0-6 aminocarbonyl groups, or a combination thereof, C₃₋₁₂ heteroaryl substituted with 0-4 (C₁₋₆)alkoxycarbonyl groups, 0-4 oxycarbonyl groups, 0-4 aminocarbonyl groups, or a combination thereof, or C₂₋₂₄ (C₁₋₄ alkyloxy)ₑ(C₁₋₄alkyl) groups wherein e=1-16 substituted with 0-6 oxycarbonyl groups, 0-6 aminocarbonyl groups, or a combination thereof.

Still further in formula I-g, (w1+w2+w3+w4) is the total number of post-reacted and post-crosslinked α-methylene lactone repeat units in the polymer, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones. As in formula I, r is the number of α-methylene lactone repeat units, s is the number of comonomer repeat units, and t is the number of crosslinked repeat units. Also as in formula I, each value of w1, w2, w4, r, s, and t are independent of any other value of w1, w2, w4, r, s, and t.

In formula I-g, the molar ratio of the total of each of (w1+w2+w3+w4):r:s:t=(0.01-30):(99.99-2):(0-97.99):(0-30), or the total of each of (w1+w2+w3+w4):r:s:t=(0.1-30):(99.9-2):(0-97.9):(0-30), or the total of each of (w1+w2+w3+w4):r:s:t=(1-30):(99-2):(0-97):(0-30), or the total of each of (w1+w2+w3+w4):r:s:t=(3-25):(99-2):(0-95):(0-30). Alternatively, (w1+w2+w3+w4):r:s:t=(0.01-30):(99.98-2):(0-97.98):(0.01-30), or the total of each of (w1+w2+w3+w4):r:s:t=(0.1-30):(99.8-2):(0-97.8):(0.1-30), or the total of each of (w1+w2+w3+w4):r:s:t=(1-30):(98-2):(0-96):(1-30), or the total of each of (w1+w2+w3+w4):r:s:t=(3-25):(94-2):(0-92):(3-25).

In an embodiment the total number of units is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

Alternatively, or in addition, when t>0, the ratio of (w1+w2+w3+w4+r):t is greater than 100:1, greater than 200:1, greater than 300:1, greater than 500:1 or greater than 700:1, or greater than 1000:1, greater than 5,000:1, up to 50,000 to 1 or up to 80,000:1.

The weight average molecular weight of the poly(lactone) I-g can be 10,000, 20,000, 50,000, 100,000, 150,000, 200,000, 250,000, 300,000, 400,000, 500,000, 550,000, 600,000, 700,000, 750,000, 800,000 g/mole or more. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

A specific poly(lactone) where the only crosslinking is provided by post-crosslinked lactone units comprises units of formula I-h

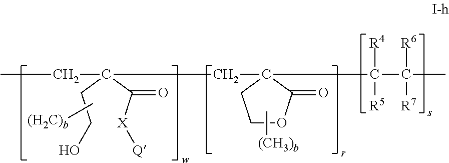

wherein b, R⁴, R⁵, R⁶, R⁷, X, and Q′ are as described in formula I.

In formula I-h, w is at least one, and the molar ratio of w:r:s=(0.01-30):(99.99-2):(0-98), wherein w is the mole fraction of post-reacted and post-crosslinked α-methylene lactone repeat units, r is the number of α-methylene lactone repeat units, and s is the number of comonomer repeat units. Specifically, at least one unit w is present, and the molar ratio of w:r:s=(0.1-30):(99.9-2):(0-97.9), or w:r:s=(1-30):(99-2):(0-97), or w:r:s=(3-25):(97-2):(0-95).

In an embodiment the total number of units (w+r+s) is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

The weight average molecular weight of the poly(lactone) I-h can be 10,000, 20,000, 50,000, 100,000, 150,000, 200,000, 250,000, 300,000, 400,000, 500,000, 550,000, 600,000, 700,000, 750,000, 800,000 g/mole or more. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

Alternatively, a post-crosslinked poly(lactone) of this type comprises units of formula I-i

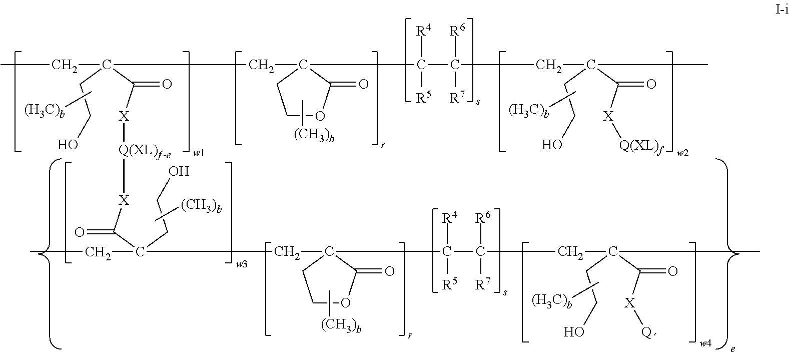

wherein b, R⁴, R⁵, R⁶, R⁷, r, s, Q′, Q, X, L, w1, w2, w3, w4, e, and f are as described in formula I and I-g.

In formula I-i, w1 is at least one, w1=w3, and the molar ratio of the total of each of (w1+w2+w3+w4):r:s=(0.01-30):(99.99-2):(0-98). Specifically, w1 is at least 1, w1=w3, and the molar ratio of (w1+w2+w3+w4):r:s=(0.1-30):(99.9-2):(0-97.9), or (w1+w2+w3+w4):r:s=(1-30):(99-2):(0-97), or (w1+w2+w3+w4):r:s=(3-25):(97-2):(0-95).

In an embodiment the total number of units (w1+w2+w3+w4+r+s) is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

The weight average molecular weight of the poly(lactone) I-i can be 10,000, 20,000, 50,000, 100,000, 150,000, 200,000, 250,000, 300,000, 400,000, 500,000, 550,000, 600,000, 700,000, 750,000, 800,000 g/mole or more. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

Poly(lactone)s comprising only post-reacted lactone units and lactone units are of formula I-j

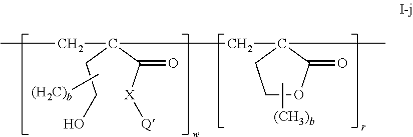

wherein b, R⁴, R⁵, R⁶, R⁷, r, s, Q′, and w are as described in formula I and I-g.

In formula I-j, the molar ratio of w:r=(0.01-30):(99.99-70), wherein w is the mole fraction of post-reacted and post-crosslinked α-methylene lactone repeat units and r is the number of α-methylene lactone repeat units, specifically w:r=(0.1-30):(99.9-70), or w:r=(1-30):(99-70), or w:r=(3-25):(97-75).

In an embodiment the total number of units (w+r) is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

The weight average molecular weight of the poly(lactone) I-i can be 10,000, 20,000, 50,000, 100,000, 150,000, 200,000, 250,000, 300,000, 400,000, 500,000, 550,000, 600,000, 700,000, 750,000, 800,000 g/mole or more. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

Poly(lactone)s of this type can be of formula I-k

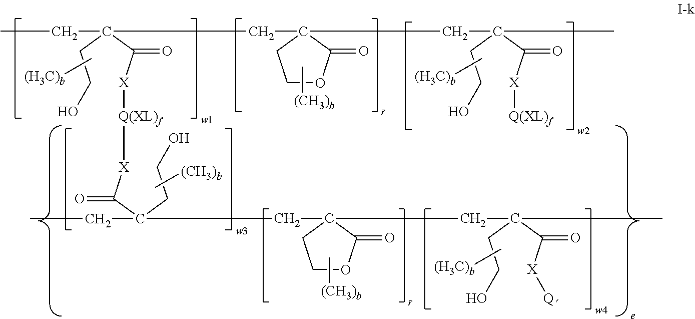

wherein b, r, Q′, Q, X, L, w1, w2, w3, w4, e, and f are as described in formula I and I-g.

In formula I-k, w1 is at least one, w1=w3, and the molar ratio of the total of each of (w1+w2+w3+w4):r=(0.01-30):(99.99-70), specifically (w1+w2+w3+w4):r=(0.1-30):(99.9-70), or (w1+w2+w3+w4):r=(1-30):(99-70), or (w1+w2+w3+w4):r=(3-25):(97-75).

In an embodiment the total number of units (w1+w2+w3+w4+r+s) is at least 100, at least 200, at least 300, at least 400, at least 500, at least 600, at least 700, at least 800, or at least 1,000, up to, for example, 30,000 or less, 25,000 or less, 20,000 or less, 10,000 or less, 8,000 or less, 5,000 or less, 4,000 or less, 3,000 or less, or 2,000 or less. In certain embodiments, the total number of units is at least 5,000, at least 6,000, at least 7,000, at least 8,000, at least 9,000, or at least 9,500, up to, for example, 30,000 or less, 25,000 or less, 20,000 or less, 10,000 or less.

The weight average molecular weight of the poly(lactone) I-k can be 10,000, 20,000, 50,000, 100,000, 150,000, 200,000, 250,000, 300,000, 400,000, 500,000, 550,000, 600,000, 700,000, 750,000, 800,000 g/mole or more. For example, the weight average molecular weight can be 10,000 to 3,000,000 g/mol; or 50,000 to 2,500,000 g/mol; or 100,000 to 2,000,000 g/mol, or 150,000 to 1,500,000 g/mol, or 200,000 to 1,000,000 g/mole or 250,000 to 950,000 g/mol. In an embodiment, the weight average molecular weight is 500,000 to 2,500,000 g/mol, specifically 500,000 to 2,000,000 g/mol, more specifically 500,000 to 1,000,000 g/mol, and more specifically 500,000 to 950,000 g/mol.

In a specific embodiment of poly(lactone) I, w and t are both 0 such that the poly(lactone) is of formula I-m

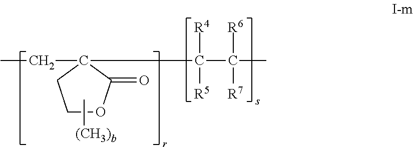

wherein b, r, and s are defined as in formula I.

The values of r and s in the poly(lactone) I-m will vary depending on the overall length of the polymer, as well as the ratio of monomers used to form the polymer. In an embodiment, the molar ratio of r:s=(99.9-2):(0.1-98). In a specific embodiment, the molar ratio of r:s=(95-5):(5-95), (95-25):(5-75), (95-50):(5-50), (90-60):(10-40, or (90-70):(10-30).

The weight average molecular weight (Mw) of poly(lactone) I-m can be 500,000 to 2,500,000 g/mol, specifically 500,000 to 2,000,000 g/mol, more specifically 500,000 to 1,000,000 g/mol, and more specifically 500,000 to 950,000 g/mol.

In still another embodiment of formula I, s and t are both zero, such that poly(lactone) I comprises units as shown in formula I-n.

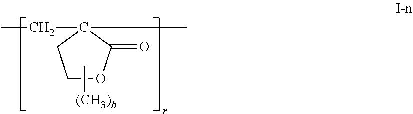

wherein b and r are defined as in formula I.

The weight average molecular weight (Mw) of the poly(lactone) can be 500,000 to 2,500,000 g/mol, specifically 500,000 to 2,000,000 g/mol, more specifically 500,000 to 1,000,000 g/mol, and more specifically 500,000 to 950,000 g/mol.

In yet another specific embodiment, R¹, R², and R³ in the poly(lactone)s I are each hydrogen and d=0, to provide a poly(lactone) of formula I-o,

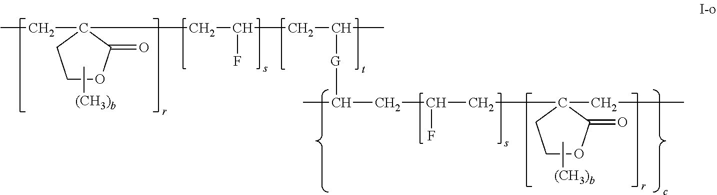

wherein F, G, c, d, r, s, and t are as defined in formula I and formula I-b. Again, it will be understood that the c number of polymer fragments crosslinked to G can further contain units t (—CR¹R²—CR³G-) derived from the crosslinking monomer as described below, but for simplicity, such units have not been shown in formula I-o. This poly(lactone) can also have both s units and t units, or s=0.

The poly(lactone) of formula I, specifically formulas I-a to I-k and I-o can be obtained by co-polymerization of appropriate amounts of the ethylenically unsaturated monomer of formula II,

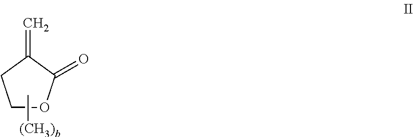

wherein each b=0 or 1, a crosslinking monomer, and a comonomer

The crosslinking monomer is a monomer having at least two polymerizable ethylenically unsaturated groups. The groups can react such that the crosslinking comonomer is incorporated into a first polymer backbone via a first ethylenically unsaturated group and into a second polymer backbone via a second ethylenically unsaturated group as the monomers polymerize. In an embodiment, the crosslinking monomer is of formula III.

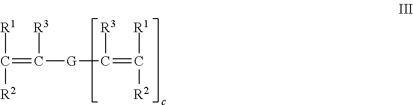

In formula III, R¹, R², and R³ are each independently hydrogen or C₁-C₄ alkyl. In an embodiment, R¹ and R² are hydrogen and R³ is a C₁₋₄ alkyl, specifically methyl. In another embodiment, R¹, R², and R³ are each hydrogen.

The group G in formula III is the same as in formula I, and c=1-5, specifically 1-4, still more specifically 1-3, or 1-2. In particular, G in formula III can be a C₁₋₃₀ hydrocarbyl group having a valence c, for example a C₁₋₁₂ alkyl substituted with 0-6 (C₁₋₆)alkoxycarbonyl groups, 0-6 oxycarbonyl groups, 0-6 aminocarbonyl groups, or a combination thereof, C₂₋₁₂ alkenyl substituted with 0-6 (C₁₋₆)alkoxycarbonyl groups, 0-6 oxycarbonyl groups, 0-6 aminocarbonyl groups, or a combination thereof, C₂₋₁₂ alkynyl substituted with 0-6 (C₁₋₆)alkoxycarbonyl groups, 0-6 oxycarbonyl groups, 0-6 aminocarbonyl groups, or a combination thereof, C₃₋₈ cycloalkyl substituted with 0-4 (C₁₋₆)alkoxycarbonyl groups, 0-4 oxycarbonyl groups, 0-4 aminocarbonyl groups, or a combination thereof, C₃₋₈ heterocycloalkyl substituted with 0-4 (C₁₋₆)alkoxycarbonyl groups, 0-4 oxycarbonyl groups, 0-4 aminocarbonyl groups, or a combination thereof, C₆₋₁₂ aryl substituted with 0-6 (C₁₋₆)alkoxycarbonyl groups, 0-6 oxycarbonyl groups, 0-6 aminocarbonyl groups, or a combination thereof, C₄₋₁₂ heteroaryl substituted with 0-4 oxycarbonyl groups, 0-4 aminocarbonyl groups, or a combination thereof, C₂₋₂₄ (C₁₋₄ alkyloxy)ₑ(C₁₋₄alkyl)) groups wherein e=1-16 substituted with 0-6 oxycarbonyl groups, 0-6 aminocarbonyl groups, or a combination thereof.

Exemplary crosslinking monomers III include N,N′—(C₁₋₁₂alkyl)bisacrylamide, N,N′—(C₁₋₁₂alkyl)bismethacrylamide, a di-, tri-, tetra-, penta-, or hexa(meth)acrylic ester of a C₁₋₁₂ polyol, a di-, tri-, tetra-, penta- or hexa(meth)acrylic ester of a C₁₋₂₄ alkyleneoxide polyol, a mono-, di-, tri-, tetra-, or higher polyester of a mono- di-, tri-, tetra-, or higher carboxylic acid having 2-6 terminal unsaturations, a di-, tri-, tetra-, penta-, or hexa(meth)allyl(C₁₋₁₂ alkane), and di-, tri-, and tetravinyl substituted C₆₋₁₂ aryl compounds. A combination of different ethylenically unsaturated groups can be used, for example a combination of an allyl group and a (meth)acryloyl group.

Specific exemplary crosslinking monomers III include N,N-methylene bisacrylamide, N,N′-methylenebismethacrylamide, 1,2-, 1,3-, and 1,4-butanediol di(meth)acrylate, ethyleneglycol diacrylate, ethyleneglycol dimethacrylate, propylene glycol diacrylate, propylene glycol dimethacrylate, diethyleneglycol diacrylate, diethyleneglycol dimethacrylate, triethyleneglycol diacrylate, triethyleneglycol dimethacrylate, polyethyleneoxide glycol diacrylate, polyethyleneoxide glycol dimethacrylate, dipropyleneglycol diacrylate, dipropyleneglycol dimethacrylate, triethyleneglycol diacrylate, triethyleneglycol dimethacrylate, glycerol diacrylate, glycerol dimethacrylate, glycerol triacrylate, glycerol trimethacrylate, 1,2- and 1,3-propanediol diacrylate, 1,2- and 1,3-propanediol dimethacrylate, 1,2-, 1,3-, 1,4, 1,5- and 1,6-hexanediol diacrylate, 1,2-, 1,3-, 1,4, 1,5- and 1,6-hexanediol dimethacrylate, 1,2- and 1,3-cyclohexanediol diacrylate, 1,2- and 1,3-cyclohexanediol dimethacrylate, pentaerythritol diacrylate, pentaerythritol dimethacrylate, pentaerythritol triacrylate, pentaerythritol trimethacrylate, pentaerythritol tetraacrylate, pentaerythritol tetramethacrylate, trimethylolpropane triacrylate, trimethylolpropane trimethacrylate, ethoxylated trimethylolpropane triacrylate, ethoxylated trimethylolpropane trimethacrylate, tris(2-hydroxyethyl) isocyanurate tri(meth)acrylate, triallyl isocyanurate, allyl(meth)acrylate, pentaerythritol diallyl ether, pentaerythritol triallyl ether, pentaerythritol tetraallyl ether, diallyl ether, tetrallyloxyethane, tetrallyloxypropane, tetrallyloxybutane, triallylamine, divinylbenzene, divinyltoluene, divinyl xylene, trivinyl benzene, and divinyl ether. Other crosslinking monomers known in the art having two or more ethylenically unsaturated groups, in particular vinyl or allyl groups, can be used.

The comonomer can impart functionality, and is a comonomer of formula IV

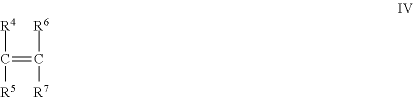

wherein R⁴, R⁵, R⁶, and R⁷, at each occurrence, are each independently a hydrogen, C₁₋₄ alkyl or a substituent F, wherein at least one and no more than two of R⁴, R⁵, R⁶, and R⁷ are F as described in Formula I, and F is the same or different in each instance. As discussed above, the substituent F is a functional group that imparts a property to the poly(lactone) I. Specific examples of monomer XIII include acrylic acid, methacrylic acid, fumaric acid, itaconic acid, maleic acid, maleic anhydride, itaconic anhydride, styrene, n-butyl acrylate, N,N-dimethyl acrylamide, octadecyl acrylate, p-styrene sulfonate, butadiene, 2-vinylpyridine, 4-vinyl benzoic acid, N-vinyl pyrrolidone, methacrylic acid, divinyl benzene, or a combination thereof.

Methods for the polymerization of compounds with ethylenic unsaturation are known in the art and any of these methods can be used to polymerize any of the poly(lactone)s I, IV, or I. Such polymerization methods include anionic and free radical polymerization. The free radical polymerization can be initiated by that of those of redox initiation, thermally activated peroxide initiation, and the like transfer and can be a controlled polymerization via methods of reversible addition-fragmentation chain transfer (ATRP), atom transfer radical polymerization (ATRP), nitroxide mediated polymerization (NMP), and the like. In an embodiment, high molecular weights can be obtained by purification of monomers II and/or III to remove any polymerization inhibitors.

Conversion of monomer to polymer can be effected by a large number of reaction parameters such as temperature, degree of dilution, reaction time, level of active catalyst, chain length distribution, choice of solvent, choice of catalyst, and other variables. Selection of an appropriate combination of such variables to achieve a high conversion can be accomplished by routine experimentation in view of the present disclosure.

A solvent can be used during polymerization to maintain an acceptable viscosity, and is typically a polar or nonpolar aprotic solvent, for example, dimethyl formamide (DMF), benzene, tetrahydrofuran (THF), a halogenated hydrocarbon such as dichloromethane, and when emulsion polymerization is used, water. The solvent can be miscible with the polymer and other reactants, while not entering into unwanted side reactions. The amount of solvent used can vary widely and the optimum amount can be determined by routine experimentation. Too little solvent can result in excessive viscosity of the reaction mixture, sluggish reactions, and the like, while an excess can result in excessive reaction volume, excessive solvent recovery costs, and an undesirably low conversion of monomer to polymer during polymerization.

Polymerization can be batch, semi-batch, or continuous, and can include emulsion polymerization, bulk polymerization, solution polymerization, core-shell polymerization, microemulsion polymerization, suspension polymerization, interpenetrating network polymerization (polymerization in the presence of a non-reacting monomer that is subsequently polymerized), for example. In any case, sufficient time is provided following mixing of the components and attainment of the final reaction temperature to allow the conversion of monomer to polymer to reach the desired level. Usually the desired level would be near the equilibrium conversion corresponding to the final conditions. The time to reach equilibrium varies with such conditions as temperature, viscosity, and catalyst level. The optimum reaction time can be determined for any particular combination of conditions by routine experimentation. Satisfactory results are obtained at atmospheric pressure although higher or lower pressures could be used. Emulsion polymerization can provide a polymer in water (e.g., polymer particles in water), and provide a high molecular weight polymer without the use of an organic solvent and in a process wherein isolation and recovery steps can be omitted if desired.

When emulsion polymerization is used, an anionic, nonionic, or cationic surfactant, specifically an anionic or nonionic surfactant can be included. Representative surfactants include, but are not limited to, alkyl sulfonates, sodium dodecyl sulfate, sodium dodecylbenzene sulfonate, sorbitan fatty acid esters, ethoxylated sorbitan fatty acid esters, ethylene oxide and/or propylene oxide adducts of long chain fatty acids or alcohols, ethylene oxide and/or propylene oxide adducts of alkyl phenols, mixed ethylene oxide/propylene oxide block polymers, diblock and triblock polymers based on polyester derivatives of fatty acids and poly(ethyleneoxide), diblock and triblock polymers based on poly(ethyleneoxide) and poly(propyleneoxide), diblock and triblock polymers based on polyisobutylene succinic anhydride and poly(ethyleneoxide), or a combination comprising at least one of the foregoing. Specific surfactants include sorbitan monooleate, sorbitan sesquioleate, sorbitan trioleate, polyoxyethylene sorbitan monooleate, and surfactants sold by BASF under the PLURONIC trade name and surfactants by Uniqema under the ATLAS and ARLACEL trade names. Functional comonomers, such as acrylic acid and others known to those of skill in the art can be used to stabilize or enable the emulsion.

In addition, ultraviolet (UV) polymerization can be used, optionally in conjunction with a photo-initiator. Specific examples of photo-initiators can include, but are not limited to, benzophenone and substituted benzophenones, 1-hydroxycyclohexyl phenyl ketone, thioxanthones such as iso-45 propylthioxanthone, 2-hydroxy-2-methyl-1-phenylpropan1-one, 2-benzyl-2-dimethylamino-(4-morpholinophenyl) butan-1-one, benzil dimethylketal, bis(2,6-dimethylbenzoyl)-2,4,4-trimethylpentylphosphine oxide, 2,4,6-trimethylbenzoyldiphenylphosphine oxide, 2-methyl-1-[4-(meth-5-ylthio)phenyl]-2-morpholinopropan-1-one, 2,2-dimethoxyl, 2-diphenylethan-1-one or 5,7-diiodo-3-butoxy-6-fluorone, diphenyliodonium fluoride and triphenylsulfonium hexafluorphosphate. A combination comprising at least one of the foregoing can be used. Suitable photo-initiators are disclosed in CRIVELLO, J. V., et al. VOLUME III: Photoinitiators for Free Radical Cation and Anion Photopolymerization, 2nd Edition, edited by BRADLEY, G., London, UK: John Wiley and Sons Ltd, 40 1998, pp. 287-294.

The chain length can be controlled by various means known to one skilled in the art, for example by control of the level of polymerization initiator present in the system during polymerization, as the average chain length tends to decrease with increases in the amount of polymerization initiator present. The polymerization initiator can be an azo compound, an inorganic peroxide, or an organic peroxide, for example. Representative polymerization initiators include 2,2′-azobis(isobutyronitrile), 2,2′-azobis(2,4-dimethylvaleronitrile), ammonium persulfate, hydroxymethanesulfinic acid, potassium persulfate, sodium persulfate, benzoyl peroxide, lauroyl peroxide, dicumyl peroxide, di-tert-butyl peroxide, and others known to those of skill in the art. The polymerization initiator can be used singly or in a combination thereof. The polymerization initiator can be used in an amount of 0.001 to 10 wt %, specifically 0.001 to 5 wt %, or 0.01 to 1.0 wt %, based on the total weight of the ethylenically unsaturated monomer.

Also, the polymer chain lengths can be controlled by adding a chain transfer agent. Representative chain transfer agents include alcohols such as methanol, ethanol, 1-propanol, 2-propanol, butyl alcohol, glycerol, or polyethyleneglycol, sulfur compounds such as alkylthiols, thioureas, sulfites, or disulfides, carboxylic acids such as formic or malic acid, or their salts or phosphites such as sodium hypophosphite or sodium formate. A combination comprising at least one of the foregoing can be used. See Berger et al., “Transfer Constants to Monomer, Polymer, Catalyst, Solvent, and Additive in Free Radical Polymerization,” Section II, pp. 81-151, in “Polymer Handbook,” edited by J. Brandrup and E. H. Immergut, 3d edition, John Wiley & Sons, New York (1989) and George Odian, Principles of Polymerization, second edition, John Wiley & Sons, New York (1981). When emulsion polymerization is used, the chain length can be controlled, for example, by the surfactant concentration, monomer concentration, the initiator, or chain transfer agent, if present.

The poly(lactone)s (i.e., poly(lactone)s of formula I-c, I-d, or I-e) can be obtained in yields of greater than 50% of theory, greater than 75% of theory, greater than 80% of theory, greater than 85% of theory, or greater than 90% of theory, up to 100% of theory.

The architecture of the poly(lactone)s can be linear or branched. The poly(lactone) I can be random, alternating, graft, or block copolymers including diblocks, triblock, tetrablocks, and pentablocks.

If ring-opening of the poly(lactone)s occurs during manufacture or processing, it has been found that all or a portion of the ring-opened units of the poly(lactone)s can be contacted with acid to cause ring-closure and reform the poly(lactone) units. For example, poly(lactone) containing ring-opened poly(lactone) units can be contacted with an acid to reform the poly(lactone) units of the poly(lactone) I. The acid can be a carboxylic acid, such as formic acid, acetic acid, or oxalic acid, or a diacid such as citric acid or malic acid, for example. The acid can also be a strong acid such as H₂SO₄, HCl, HF, HI, and the like.

Poly(lactone)s produced after polymerization can be the crosslinked products of formula I-c, I-d, or I-e described above wherein the crosslinking occurs during manufacture of the poly(lactone) via the crosslinking group containing G (e.g., unit “t” in formula I-c). In an embodiment, further crosslinking can occur via oxidative crosslinking of residual double bonds.

In another embodiment, post-crosslinking occurs via use of a crosslinking agent. In an embodiment, the crosslinking agent can be a two-pot system (i.e. poured together just before use) for an ambient or heated cure. In an embodiment, the crosslinking agent can be a protected crosslinking agent in the case of a one-pot system wherein the crosslinking is initiated when either the crosslinking agent is deprotected with heat (e.g. blocked isocyanates), when a component evaporates, or the crosslinking agent is contained in a separate phase.

The crosslinking agent can be any substance that promotes or regulates intermolecular covalent bonding between the polymer chains. In an embodiment, the crosslinking agent can be a monomer or an oligomer that reacts with the functional groups derived from units containing F, when present. In another embodiment, poly(lactone)s can be post-crosslinked via lactone ring-opening by a post-crosslinking monomer containing group Q, i.e., a post-crosslinking monomer of formula V

[LX]-Q-[XL]_{z} V

wherein Q is a C₁₋₃₀ hydrocarbyl group; X is a nucleophile reactive with a lactone group; L is a leaving group; and z=1-5. Thus, after polymerization, the poly(lactone) can be post-crosslinked to provide post-reacted and post-crossed linked α-methylene lactone repeat units (unit “w” in formula I). As used herein “post-reacted”-methylene lactone repeat units are reacted with the post-crosslinking monomer, but not further crosslinked.

The group Q in formula V is the same as in formula I, and z=1-5, specifically 1-4, still more specifically 1-3, or 1-2. In particular, Q in formula III can be a C₁₋₃₀ hydrocarbyl group having a valence z+1, for example a C₁₋₁₂ alkyl substituted with 0-6 (C₁₋₆)alkoxycarbonyl groups, 0-6 oxycarbonyl groups, 0-6 aminocarbonyl groups, or a combination thereof, C₂₋₁₂ alkenyl substituted with 0-6 (C₁₋₆)alkoxycarbonyl groups, 0-6 oxycarbonyl groups, 0-6 aminocarbonyl groups, or a combination thereof, C₂₋₁₂ alkynyl substituted with 0-6 (C₁₋₆)alkoxycarbonyl groups, 0-6 oxycarbonyl groups, 0-6 aminocarbonyl groups, or a combination thereof, C₃₋₈ cycloalkyl substituted with 0-4 (C₁₋₆)alkoxycarbonyl groups, 0-4 oxycarbonyl groups, 0-4 aminocarbonyl groups, or a combination thereof, C₃₋₈ heterocycloalkyl substituted with 0-4 (C₁₋₆)alkoxycarbonyl groups, 0-4 oxycarbonyl groups, 0-4 aminocarbonyl groups, or a combination thereof, C₆₋₁₂ aryl substituted with 0-6 (C₁₋₆)alkoxycarbonyl groups, 0-6 oxycarbonyl groups, 0-6 aminocarbonyl groups, or a combination thereof, C₄₋₁₂ heteroaryl substituted with 0-4 oxycarbonyl groups, 0-4 aminocarbonyl groups, or a combination thereof, C₂₋₂₄ (C₁₋₄ alkyloxy)ₑ(C₁₋₄alkyl)) groups wherein e=1-16 substituted with 0-6 oxycarbonyl groups, 0-6 aminocarbonyl groups, or a combination thereof

The group -XL in formula V is a nucleophile X and a leaving group L, for example a hydroxyl or activated hydroxyl, amine or activated amine, carboxylic acid halide, and the like. Examples of post-crosslinking monomers include a diol, triol, tetrol, pentol, or hexol, a diamine, triamine, tetramine, pentamine, or hexamine, or a combination comprising at least one of the forgoing the post-crosslinking monomers

Exemplary crosslinking agents, including post-crosslinking monomers V, include polyisocyanates, including polyisocyanate oligomers, various diols and higher polyols, diamines and higher amines, di- or polymeric epoxides, and aminoalcohols, compounds having at least two sites of ethylenic unsaturation, as well as dicarboxyl and higher carboxylic acids and their C₁₋₃alkyl esters and acid halides. Such crosslinking produces crosslinked ionic polymers that can have crosslinks in the r or s units. The crosslinks can accordingly form between the F groups of the comonomer units or the lactone groups. The crosslinks are the crosslink residues of the polyisocyanates, including polyisocyanate oligomers, various diols and higher polyols, diamines and higher amines, di- or polymeric epoxides, and aminoalcohols, compounds having at least two sites of ethylenic unsaturation as well as dicarboxyl and higher carboxylic acids and their C₁₋₃alkyl esters and acid halides.

Conditions for reaction of poly(lactone)s with diisocyanates and higher isocyanates are known, and can be effected by contacting polymer I and optionally another polyol and the appropriate stoichiometry of a di- or polyisocyanate and causing a reaction to occur by heating and/or with a catalyst to accelerate the reaction. Non-limiting examples of catalysts for making the polyurethanes and polyisocyanate compounds include tin catalysts such as dibutyl tin dilaurate, and tertiary amines such as 1,4-diazabicyclo[2.2.2]octane (DABCO™, TED), and the like. The reaction can be carried out in the presence of an inert solvent, which can optionally be removed at the end of the reaction by distillation or extraction. Non-limiting examples of organic polyisocyanates include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl) methane, 2,4′-dicyclohexyl-methane diisocyanate, 4,4′-dicyclohexyl-methane diisocyanate, 1,3-bis-(isocyanatomethyl)-cyclohexane, 1,4-bis-(isocyanatomethyl)-cyclohexane, bis-(4-isocyanato-3-methyl-cyclohexyl)methane, a, a, α′,α′-tetramethyl-1,3-xylylene diisocyanate, a, a, α′,α′-tetramethyl-1,4-xylylene diisocyanate, 1-isocyanato-1-methyl-4(3)-isocyanatomethyl cyclohexane, 2,4-hexahydrotolylene diisocyanate, 2,6-hexahydrotolylene diisocyanate, 1,3-phenylene diisocyanate, 1,4-phenylene diisocyanate, 2,4-tolylene diisocyanate, 2,6-tolylene diisocyanate, 2, 2′-diphenylmethane diisocyanate, 2,4′-diphenylmethane diisocyanate, 4,4′-diphenylmethane diisocyanate, or 1,5-diisocyanato naphthalene. A combination comprising at least one of the foregoing can be used. The organic polyisocyanate can also be in the form of a polyisocyanate adduct. The polyisocyanate adducts include those containing isocyanurate, uretdione, biuret, urethane, allophanate, carbodiimide and/or oxadiazinetrione groups. Examples of polyisocyanate cross-linkers used in coatings and adhesives for outdoor applications where exterior durability is required are bis(4-isocyanatocyclohexyl)methane, the isocyanurate trimers of 1,6-hexanediisocyanate and isophorone diisocyanate, the biuret of 1,6-hexanediisocyanate, and the uretdione of 1,6-hexanediisocyanate. Specific polyisocyanates include diphenylmethane-4,4′-diisocyanate, the reaction product of trimethylolpropane with toluene diisocyanate, and the isocyanurate trimer of toluene diisocyanate.

When a diol or higher polyol is used as a crosslinking agent, crosslinking occurs via esterification. Conditions for such esterification reactions are known. Non-limiting examples of polyols include 1,2-ethanediol (ethylene glycol), 1,2-propanediol (propylene glycol), 1,3-propanediol, 2,2-dimethyl-1,3-propanediol(neopentyl glycol), 2-butyl-2-ethyl-1,3-propanediol, 3-mercaptopropane-1,2-diol(thioglycerol), dithiothreitol, 1,2-butanediol, 1,3-butanediol, 1,4-butanediol, 2,3-butanediol, 1,5-pentanediol, 3-methyl-1,5-pentanediol, 1,6-hexanediol, 2-ethyl-1,3-hexanediol, cyclohexane-1,2-diol, cyclohexane-1,4-diol, 1,4-dimethylolcyclohexane, 1,4-dioxane-2,3-diol, 3-butene-1,2-diol, 4-butenediol, 2,3-dibromobutene-1,4-diol, 1,8-octanediol, 1,10-decanediol, 1,12-dodecanediol, benzene-1,2-diol (catechol), 3-chlorocatechol, indane-1,2-diol, tartaric acid, and 2,3-dihydroxyisovaleric acid, diethylene glycol (DEG), methylene glycol, tetraethylene glycol, dipropylene glycol, tripropylene glycol, tetrapropylene glycol, xylene glycol, 1,3-benzenediol (resorcinol), 1,4-benzenediol (hydroquinone), o-, m-, or p-benzene dimethanol, o-, m-, or p-glycol phthalates, o-, m-, or p-bis-1,2-ethylene glycol phthalates, o-, m-, or p-bis-1,2-propylene glycol phthalates, o-, m-, or p-bis-1,3-propylene glycol phthalates, diols prepared by hydrogenation of dimer fatty acids, hydrogenated bisphenol A, hydrogenated bisphenol F, propoxylated bisphenol A, isosorbide, 2-butyne-1,4-diol, 3-hexyne-3,5-diol (SURFYNOL® 82, available from Air Products of Allentown, Pa.) and other alkyne-based polyol products marketed under the SURFYNOL® brand name by Air Products of Allentown, Pa. Polyether or polyester diols or polyols can be used, for example polyalkylene ethers such as polyethylene glycol, polypropylene glycol, polybutylene glycol, polyethylene polypropylene glycol, the oligomeric and polymeric ethers available under the trade name VORANOL from Dow, and the like.

When a diamine or higher amine is used, the poly(lactone)s are contacted with the diamine or higher amine to crosslink at the carboxyl group, to form water as a byproduct by amidation methods known in the art. Nonlimiting examples of polyamine crosslinking agents include primary or secondary diamine or polyamines in which the radicals attached to the nitrogen atoms can be saturated or unsaturated, aliphatic, alicyclic, aromatic, aromatic-substituted-aliphatic, aliphatic-substituted-aromatic, or heterocyclic. Nonlimiting examples of aliphatic and alicyclic diamines include 1,2-ethylene diamine, 1,2-propylene diamine, 1,8-octane diamine, isophorone diamine, or propane-2,2-cyclohexyl amine. Nonlimiting examples of aromatic diamines include the phenylene diamines and toluene diamines, for example o-phenylene diamine and p-toluene diamine. Representative commercially available polyamines include those available Huntsman Corp., of Houston, Tex. under the designation JEFFAMINE. Representative diamines and polyamines (e.g., tri-, tetra-, and pentamines) useful in crosslinking include JEFFAMINE D-230 (molecular weight 230), JEFFAMINE D-400 (molecular weight 400), and JEFFAMINE D-2000 (molecular weight 2000), JEFFAMINE XTJ-510 (D-4000) (molecular weight 4000), JEFFAMINE XTJ-50 (ED-600) (molecular 60 weight 600), and JEFFAMINE XTJ-501 (ED900) (molecular weight 900), for example.

In still another embodiment, an aminoalcohol can be used to crosslink the poly(lactone)s. Exemplary aminoalcohols are include a primary or secondary amino groups and a primary or secondary hydroxyl group linked by a saturated or unsaturated, aliphatic, alicyclic, aromatic, aromatic-substituted-aliphatic, aliphatic-substituted-aromatic, or heterocyclic C1-18 radical.

When a dicarboxylic or higher carboxylic acid (or acid halide or C₁₋₃ alkyl ester thereof) is used to crosslink the poly(lactone), in particular hydroxyl groups present on F, the poly(lactone) can be contacted with the dicarboxyl or higher carboxylic acid (or the C₁₋₃ alkyl ester or carboxylic halide thereof) to react at the hydroxyl group, to form water, a C₁₋₃ alcohol, or hydrogen halide as a byproduct. Conditions are selected to avoid hydrolysis of the lactone, and condition for such esterification, trans-esterification, or nucleophilic addition are known. Exemplary dicarboxylic acids include C₄₋₃₂ linear or branched saturated or unsaturated aliphatic dicarboxylic acids, C₈₋₂₀ aromatic dicarboxylic acids, polyether dicarboxylic acids, dimethyl terephthalate, or the like, as well as the corresponding C₁₋₃ alkyl esters and carboxylic halides, or a combination comprising at least one of the foregoing. Exemplary aliphatic dicarboxylic acids include succinic acid, adipic acid, sebacic acid, decane dicarboxylic acid, malonic acid, glutaric acid, adipic acid, pimelic acid, suberic acid, azelaic acid, dodecanedioic acid, brassylic acid, α,β-diethylsuccinic acid, α-butyl-α-ethyl glutaric acid, and the like as well as the corresponding C₁₋₃ alkyl esters and carboxylic halides. Exemplary aromatic dicarboxylic acids include phthalic acid, terephthalic acid, isophthalic acid, and the like, as well as the corresponding C₁₋₃ alkyl esters and carboxylic halides. Exemplary polyether dicarboxylic acids can include polyalkylene ethers such as polyethylene glycol, polypropylene glycol, polybutylene glycol, polyethylene polypropylene glycol, and the like, as well as the corresponding C₁₋₃ alkyl ester carboxylic halides.

When the group F includes a site of unsaturation, compounds having at least two sites of ethylenic unsaturation can be used for crosslinking, including compounds of formula III, the crosslinking monomer. Conditions for crosslinking include those used for polymerization as described above.

The degree of crosslinking can be controlled by use of a combination of monofunctional, difunctional, or polyfunctional compounds to provide the crosslinked poly(lactone), the relative amounts of the crosslinking agent, reaction conditions, and like considerations. For example, the crosslinking agent can be present in the crosslinking composition in an amount of 0.25-80 weight percent (wt. %), specifically 0.5-60 wt. %, 1 to 40 wt. %, or 1-30 wt. %, or 1-15 wt. %, based on a total weight of the poly(lactone) and the crosslinking agent. In an embodiment, the residue of the crosslinking agent can be present in the crosslinked poly(lactone) in an amount of 0.01-60 wt. %, specifically 0.01 to 10 wt. %, 0.05-5 wt. %, or more specifically 0.1-1 wt. %, based on the total weight of the crosslinked poly(lactone). In another embodiment, the poly(lactone) is more heavily crosslinked, such that the residue of the crosslinking agent is present in an amount 10-60 wt. %, or 20-40 wt. % based on the total weight of the crosslinked poly(lactone).

A number of methods can be used to recover the poly(lactone)s I, specifically poly(lactone)s I-a to I-k and I-o, including precipitation in a nonsolvent, evaporation, sedimentation, coagulation, and the like. Unless desired, such conditions should not expose the poly(lactone) to conditions that cause depolymerization, such as excessively high temperatures for extended periods of time. Accordingly, the pH can be maintained to be 6 to 9.5, or 8 to 9, above 9.5, or above 10.0. The product can be recovered as a solution, slurry, gel, wet cake, or dry solid, depending upon its intended use. If the product is dried, excessive exposure to high temperature is avoided to prevent degradation and/or excess crosslinking.

Also disclosed is a method of preparing a poly(lactone) I-m, comprising polymerizing an ethylenically unsaturated monomer II,

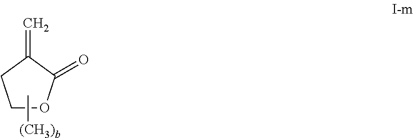

wherein each b=0 or 1, with at least one comonomer of formula IV,

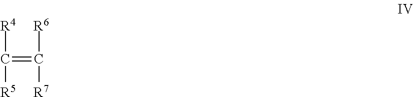

wherein R⁴, R⁵, R⁶ and R⁷ are each independently a hydrogen, C₁₋₄ alkyl or F, wherein F is a functional group that imparts a property to the poly(lactone) Ia, and at least one and no more than two of R⁴, R⁵, R⁶ and R⁷ are F and F is the same or different in each instance. The above-described polymerization conditions can be used.

The poly(lactone) I-n can be obtained by a process comprising polymerization of polymerization of the corresponding ethylenically unsaturated monomer II,

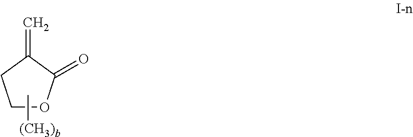

wherein each b=0 or 1. The above-described polymerization conditions can be used.

Poly(lactone)s I, specifically poly(lactone)s I-a to I-o, have a wide variety of uses, depending on their properties, such as molecular weight, identity of any comonomers, degree of crosslinking and crosslinking agent if used. Accordingly, poly(lactone)s I, specifically poly(lactone)s I-a to I-o, can be formulated with a variety of other materials, such as a compatible polymer, curing agent, catalyst, coalescing agent, surfactant, plasticizer, fragrance, defoamer, wetting agent, pigment/colorant, desiccant, preservative, filler, superabsorbent polymer, an antioxidant, an antiozonant, a thermal stabilizer, a mold release agent, a dye, a pigment, an antibacterial, a flavorant, a fragrance molecule, an aroma compound, an alkalizing agent, a pH buffer, a conditioning agent, a chelant, a solvent, a surfactant, an emulsifying agent, a blowing agent, a foam stabilizer, a hydrotrope, a solubilizing agent, a suspending agents, a humectant, an accelerator, a ultraviolet light absorber, or the like, or a combination comprising at least one of the foregoing materials. The poly(lactone) I, specifically poly(lactone)s I-a to I-o, can be formulated with a filler such as fibers, including glass fibers, carbon fibers, polymer fibers, and the like; functional additives including flame retardants, blowing agents, antioxidants, impact modifiers, compatibilizers, mold-release agents, and the like; talc; carbon black; metal; clay; ceramic; and the like.

For example, poly(lactone)s I, specifically poly(lactone)s I-a to I-o, can be combined, e.g., blended, with various other polymers to form a polymer composition, for example with poly(vinyl chloride) (PVC); styrene butadiene rubber (SBR); polystyrene including atactic, isotactic, and syndiotactic; poly(alkyl methacrylates) including poly(methyl methacrylate) (PMMA); polyamide including those made from hexane-1,6-diamine and hexanedioic acid, hexane-1,6-diamine and dodecanedioic acid, butane-1,4-diamine and hexanedioic acid, caprolactam, and caprolactam; polyethylene including high density polyethylene (HDPE), low density polyethylene (LDPE), linear low density polyethylene (LLDPE), and copolyethylene including ethylene octane copolymers; polysiloxanes including poly(dimethyl siloxane) (PDMS); polytetrafluoroethylene (PTFE); acrylonitrile butadiene styrene (ABS); polyurethane; polyester including poly(ethylene terephthalate) (PET), poly(butylene terephthalate) (PBT), poly(butylene succinate) (PBS); polypropylene including atactic and isotactic; polycarbonate; polyimide including aromatic polyimide; ionomers including Suryln and Nafion; polyphenylene ether; styrene-butadiene-styrene; polysulfone; polyether sulfone; polyketones including poly(ether ether ketone) (PEEK); poly(ether imide) (PEI); polyaryl ether; polyacetal including polyoxymethylene (POM); acrylics including acrylic latex; poly(vinyl alcohol) including ethylene vinyl alcohol (EVOH); ethylene propylene diene monomer (EPDM); and the like; or combinations thereof. The polymers to be blended with the poly(lactone)s I, specifically poly(lactone)s I-a to I-o, can be in the form of a copolymer (e.g. added as compatibilizing agents); polymer particles (e.g. SAN, SBS, PMMA, SBR); and the like. Other polymers include a polylactic acid, a polyvinylchloride, a polyacetal, a polyolefin, a polysiloxane, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, or a combination comprising at least one of the foregoing organic polymers. The polymer compositions can be homogeneous or heterogeneous. The polyketal adduct can be added to the organic polymer in amounts of about 0.1 wt % to about 90 wt %, specifically about 4 wt % to about 70 wt %, and more specifically about 40 to 60 wt %, based on the total weight of the polymer composition.

The poly(lactone)s I, specifically poly(lactone)s I-a to I-o, can be processed via continuous melt processing including the methods of extrusion (e.g. twin screw, single screw, disk extruder, co-extrusion with another polymer for stratified structures), thermoforming, single shaft mixer, double shaft mixer, dynamic melt mixer, cavity transfer mixers, calendaring, melt spun fibers, airlaid, and the like. The poly(lactone)s I, or the corresponding crosslinked polymers, can be processed via semi-continuous melt process via injection molding, transfer molding, and the like. The poly(lactone)s I, or the corresponding crosslinked polymers, can be processed via batch melt processing via the methods of roll milling, kinetic energy mixing, compression molding, blow molding, and the like.

The poly(lactone)s I, specifically poly(lactone)s I-a to I-o, can be processed from solids via compacting, compressing, sifting, grinding, tearing, pulverizing, sieving, powder coating, electrostatic coating, electrostatic spraying, centrifugational casting, rotational molding, compression molding, thermoforming, vacuum forming, pressure forming, matched mold forming, forging or cold forming, ablation, lithography, mechanical forces, sintering, and the like.

In a specific embodiment, poly(lactone)s I, specifically poly(lactone)s I-a to I-o, are used in coating compositions to form films. The coating compositions comprise a liquid carrier, poly(lactone)s I, and optionally other functional components, such as a pigment. Thus, a method of use, coating a substrate with a poly(lactone) coating composition is described. The method comprises contacting a surface of the substrate with the poly(lactone) coating composition to form a film; drying the film to harden the film, and optionally curing the film. Advantageously, the film can be transparent. In some embodiments, the film is a roofing film, a composite film, a film for laminated safety glass, or a packaging film. In some embodiments, the packaging container is a food or drink container. The film can also be a paint an ink, a stain, a clear-coat, and the like.

The film can be applied through any known technique including those of casting, from solvent, from water, or from mixed solvent systems; dispensing (e.g. as in nozzle sprays); knife over roll coating, or roll coating, for example, to provide either a continuous coverage or a patterned coverage; shush molding; spray-drying; phase inversion; dip coating; curtain coating; spin coating; pouring, brush, rollers, mops, air-assisted or airless spray, electrostatic spray, foam; anilox; and the like to provide a continuous or patterned coating. Specifically, a composition comprising the poly(lactone) or crosslinked poly(lactone) can be applied to a side of a substrate by roll, pond, or fountain application and metering with a roll, rod, blade, bar, or air knife Printing methods are other suitable application techniques, including gravure, jet printing, screen printing, or screen coating, or by rotary screen printing or rotary screen coating, which is a combination of roll printing or coating and screen printing or coating.

The coating compositions can be applied to fibrous or non-fibrous substrates. Examples of substrates include paper; paperboard; textiles; non-wovens; wood; ceramic; masonry; concrete; a woven web; fabric including knitted fabric, woven fabric, and nonwoven fabric; cellulose tissue; plastic film; laminate; glass a stranded composite; an elastomer net composite; metal; glass; or fiber including glass fiber, natural fiber, or synthetic fiber; or a combination comprising at least one of the foregoing substrates. The coating composition can further be deposited onto filter cartridges or substrates for use in filtration systems for allergen removal, blood filtration, water purification, and the like. Examples of plastic film substrates include those made of polypropylene, polyurethane, and polyolefin including modified and surface-treated polyolefins. The polyolefin can be low density polyethylene, high density polyethylene (“HDPE,” a polyethylene having a density of about 0.95 g/cm³ or greater), linear low density polyethylene (“LLDPE,” polymers of ethylene and a higher alpha-olefin comonomer such as a C₃₋₁₂ comonomer, or a combination thereof, having a density of about 0.900-0.935 g/cm³), and ultra-low density polyethylene (“ULDPE,” polymers of ethylene and a higher alpha-olefin comonomer such as a C₃₋₁₂ comonomer, or a combination thereof, having a density of about 0.860 to less than 0.900 g/cm³).

After application, drying can be performed without crosslinking the film. Drying conditions can be selected to provide for removal of a solvent or water from the poly(lactone) without crosslinking as described in further detail below. However, in another embodiment, the poly(lactone) can be coated onto a substrate and subsequently dried and cured. Alternatively, the poly(lactone) can be partially cured, to provide a poly(lactone) that is insoluble but swells when contacted by a selected solvent, or the poly(lactone) can be highly crosslinked, to provide a poly(lactone) that does not significantly swell when contacted by a variety of solvents. Drying can be accomplished through any known technique including those of freezing or via dryers (e.g. as in yankee drum dryer or belt dryer) and the like.

In some embodiments the curing (crosslinking) is by the post-crosslinking methods described above. In the case of one-pot curing, curing is a single bond or achieved by evaporation in ambient conditions or in heated conditions to accelerate the process or because the solvent has a higher boiling point, or by reaction curing. Reaction curing can be achieved by an oxidative cure in the case of drier, catalysts, and radiation cures; by a blocking curing agent wherein deblocking occurs either thermally by some transformative process (e.g. loss of blocking agent, with heat, through evaporation, and the like); by a two phase system, wherein the reactants are contained in separate phases; or by temperature-activated curing, wherein there are slow reaction rates at manufacturing and storage conditions. In the case of two-pot curing, curing is a single bond or achieved by chemical reaction with a crosslinking agent and can occur in ambient conditions, wherein the components are mixed just before use, or in heated conditions. The film can be factory applied, wherein the equipment, such as ovens or radiation via UV, e-beam, and the like, is used to assist curing or drying or in the field, wherein the curing is a single bond or achieved at ambient conditions.

The poly(lactone) I, specifically poly(lactone)s I-a to I-o, can also be used as an additive in a coating for a variety of purposes, for example to alter the viscosity of a coating composition, or enhance the plasticity or durability of the coating. When used as an additive in a coating composition (for example, to modify rheology, or to change adhesion characteristics), a relatively low concentration of the poly(lactone) (e.g., less than 10 wt. %, specifically less than 5 wt. %, less than 2 wt. %, or less than 1 wt. %) can be present. Alternatively, the poly(lactone) can act as a binder in the coating composition.

For example, the poly(lactone) I, specifically poly(lactone)s I-a to I-o, can act as an additive or binder in a variety of coating compositions, for example paints, inks, solvent borne, or coating compositions. Depending on the end use of the composition, the ketal adducts can function as a polymer binder, a solvent, or a condensation reactive product. However, it is to be understood that the ketal adducts can have more than one function, including one or more of solubilization, solvent coupling, surface tension reduction, viscosity reduction, and the like. In an embodiment, the poly(lactone) I can also function as a plasticizer, increasing the flexibility of the compositions. In a highly advantageous feature, selection of the specific G′, Q′, R¹, R², R³, R⁴, R⁶, and R⁷ groups, and b in the poly(lactone) I allows the chemical and physical properties of the poly(lactone) I to be adjusted to achieve the desired combination of properties, for example, solubilizing activity and volatility.

Thus, in an embodiment, a coating composition comprises the poly(lactone) I, specifically poly(lactone)s I-a to I-o, as a binder and a carrier, such as water or an organic solvent.

The poly(lactone) I, specifically poly(lactone)s I-a to I-o, can be present in carrier completely dissolved, i.e., in the form of a solution, in the form of aggregates, or an aqueous dispersion, and can include about 5 to about 85 weight percent (wt. %) solids, specifically about 10 to about 75 wt. % solids (i.e., the weight percentage of the poly(lactone) I based on the total weight of the coating composition). As used herein, “solids” refers to the 100% binder in whatever form, such as a solid or liquid. The polymer binder can be present in a wide variety of particle sizes, for example a mean polymer binder particle size from about 10 to about 1,000 nanometers (nm), specifically about 50 to about 800 nm. The particle size distribution can be mono-modal or multimodal, for example bimodal.

A method of preparing coating composition comprises combining the poly(lactone) I, specifically poly(lactone)s I-a to I-o, carrier (e.g., organic or aqueous phase (i.e., water and any cosolvents if present)), and any additives, if present, to form a coating composition. The components can be added in any suitable order to provide the coating composition.

In a specific embodiment, the poly(lactone) I, specifically poly(lactone)s I-a to I-o, is used in a water-borne paint compositions, stain composition, or clear-coat compositions. Thus, in an embodiment, a water-borne paint, stain, or clear-coat composition comprises water, optionally a pigment, and the poly(lactone) I, specifically poly(lactone)s I-a to I-o. When the poly(lactone) is thermosetting, the coating compositions comprise the uncured polymer and one or more of a curing agent, catalyst, initiator, or promoter, if used.

A pigment can be present in the paint or stain composition. The term “pigment” as used herein includes non-film-forming solids such as extenders and fillers, for example an inorganic pigment aluminum oxide, barites (barium sulfate), CaCO3 (in both ground and precipitated forms), clay (aluminum silicate), chromium oxide, cobalt oxide, iron oxides, magnesium oxide, potassium oxide, silicon dioxide, talc (magnesium silicate), TiO2 (in both anastase and rutile forms), zinc oxide, zinc sulfite, an organic pigment such as solid (high Tg) organic latex particles added to modify hardness or (as in the case of hollow latex particles) to replace TiO2, carbon black, and a combination comprising at least one of the foregoing. Representative combinations include blends of metal oxides such as those sold under the marks Minex® (oxides of silicon, aluminum, sodium and potassium commercially available from Unimin Specialty Minerals), Celites® (aluminum oxide and silicon dioxide commercially available from Celite Company), Atomites® (commercially available from English China Clay International), and Attagels® (commercially available from Engelhard). Specifically, the pigment includes TiO₂, CaCO₃, or clay.

Generally, the mean particle sizes of the pigments are about 0.01 to about 50 micrometers. For example, the TiO₂ particles used in the aqueous coating composition typically have a mean particle size from about 0.15 to about 0.40 micrometers. The pigment can be added to the aqueous coating composition as a powder or in slurry form.

A dye can be present in the paint or stain composition, in addition to or instead of a pigment. The term “dye” as used herein includes organic compounds generally soluble in the compositions, and that impart color to the compositions.

The paint, stain, or clear-coat composition can contain additional additives, as known in the art, to modify the characteristics of the composition, provided that the additives do not significantly adversely affect the desired properties of the paint, stain, or clear-coat, for example, viscosity, drying time, or other characteristic. These additives can include a plasticizer, drying retarder, dispersant, surfactant or wetting agent, rheology modifier, defoamer, thickener, biocide, mildewcide, colorant, wax, perfume, pH adjuster, or cosolvent. The additives are present in the amount ordinarily used in paint, stain, or clear-coat compositions. In an embodiment, the paint, stain, or clear-coat composition consists essentially of water, an optional pigment, an optional dye, and a poly(lactone) I, specifically poly(lactone)s I-a to I-k. As used herein, the phrase “consists essentially of” encompasses the polymer binder, water, optional pigment, and poly(lactone) I, specifically poly(lactone)s I-a to I-o, and optionally one or more of the additives defined herein, but excludes any additive that significantly adversely affects the desired properties of the composition or the dried coating derived therefrom.

The poly(lactone) I, specifically poly(lactone)s I-a to I-o, can be present in the paint composition in an amount from about 2 to about 60 wt. %, and more specifically about 4 to about 40 wt. % of the paint composition, based on the dry weight of the polymer binder. When present, the pigment can be used in the paint composition in an amount from about 2 to about 50 wt. %, specifically about 5 to about 40 wt. % of the total solids in the paint composition.

The poly(lactone) I, specifically poly(lactone)s I-a to I-o, can be present in the stain composition in an amount from about 0.1 to about 50 wt. %, and more specifically about 0.5 30 wt. % of the stain composition, based on the dry weight of the poly(lactone) I, specifically poly(lactone)s I-a to I-o. When present, the pigment or dye can be used in the stain composition in an amount from about 0.1 to about 40 wt. %, specifically about 0.5 to about 30 wt. % of the total solids in the stain composition. When present, the dye can be used in the paint or stain composition in an amount from about 0.001 to about 10 wt. %, specifically about 0.005 to about 5 wt. % of the total solids in the paint or stain composition.

The paint composition can include about 5 to about 85 wt. % and more specifically about 35 to about 80 wt. % water, i.e., the total solids content of the paint composition can be about 15 to about 95 wt. %, more specifically, about 20 to about 65 wt. % of the total composition. The compositions can be formulated such that the hardened (dried) coatings comprise at least about 2 to about 98 volume % (vol.%) polymer solids and about 2 to about 98 vol.% of non-polymeric solids in the form of pigments or a combination of a pigment and a dye, together with other additives (if present).

The stain composition can includes about 10 to about 95 wt. % and more specifically about 25 to about 90 wt. % water, i.e., the total solids content of the stain composition can be about 5 to about 75 wt. %, more specifically, about 10 to about 75 wt. % of the total composition. The stain compositions are typically formulated such that the hardened (dried) coatings comprise at least about 1 vol. %, for example about 5 to about 98 vol.% poly(lactone) I, specifically poly(lactone)s I-a to I-o, and about 0.1 to about 99 vol.% of non-polymeric solids in the form of pigments and/or dyes, and other additives (if present). A wood stain coating can penetrate the wood substrate to some degree.

The clear-coating composition can include about 10 to about 95 wt. % and more specifically about 25 to about 90 wt. % water, i.e., the total solids content of the clear-coating composition can be about 5 to about 75 wt. %, more specifically, about 10 to about 75 wt. % of the total composition. The compositions are typically formulated such that the hardened (dried) clear-coatings comprise at least about 1 vol.% polymer solids, for example about 1 to about 100 vol.% polymer solids, if present, the poly(lactone) I, specifically poly(lactone)s I-a to I-o, and 0 to about 10 vol.% of non-polymeric solids. For example, in clear-coat compositions certain additives (e.g., calcium carbonate, talc, or silica) can be used that do not impart color, but rather serve primarily to reduce formulation cost, modify gloss levels, or the like.

In an embodiment, a method of preparing a paint, stain, or clear-coating composition comprises combining the poly(lactone) I, specifically poly(lactone)s I-a to I-o, the pigment (if used), carrier such as water, and any optional additives to form a composition. The components can be added in any suitable order to provide the composition.

In another embodiment, the components of the coating composition, e.g., a paint, stain, or clear-coat composition, are provided in two parts that are combined immediately prior to use. For example, a first part of includes poly(lactone) I, specifically poly(lactone)s I-a to I-o, and a second part includes crosslinker. The parts are mixed in a predetermined ratio to provide the system.

In another exemplary embodiment, a method of use, that is, coating a substrate with the paint, stain, or clear-coat composition is described. The method comprises contacting a surface of the substrate with the paint, stain, or clear-coat composition to form a film; and drying the film to harden the film. The composition can at least partially impregnate the substrate after contacting. The film can further optionally be cured.

The substrate can be a wide variety of materials, including but not limited to, paper, wood, concrete, metal, glass, textiles, ceramics, plastics, plaster, roofing substrates such as asphaltic coatings, roofing felts, foamed polyurethane insulation, polymer roof membranes, and masonry substrates such as brick, cinderblock, and cementitious layers, including EIFS systems (synthetic stucco made from engineered layers of polystyrene insulation with a cement-like mud called a topcoat or basecoat, and which is applied with a trowel). The substrates include previously painted, primed, undercoated, worn, or weathered substrates.

The coating composition can be applied to the materials by a variety of techniques well known in the art such as, for example, curtain coating, brush, rollers, mops, air-assisted or airless spray, electrostatic spray, and the like. Paints and clear-coats may or may not partially penetrate, i.e., partially impregnate the substrate upon coating. In an embodiment, a paint composition does not substantially penetrate or impregnate the substrate. In another embodiment, a clear-coat composition does not substantially penetrate or impregnate the substrate. Stains are generally designed to partially or fully impregnate the substrate upon coating. In embodiment, the substrate is fully impregnated by the stain composition, such that the film formed conforms to the interior of the coated substrate, and may be continuous or discontinuous.

Hardening can be by drying, for example storage under atmospheric conditions at room temperature. Drying can also include solvent wicking, for example by the substrate itself (e.g., wood or paper). Heat can be used as an aid to drying. Curing can be used to further harden the film. Curing may be carried out before drying, during drying, or after drying, or any combination thereof. The dried coating can be disposed on a surface of the substrate, in the form of a film that can partially or completely cover the surface. The coating can be disposed directly on the surface, or one or more intermediate layers (e.g., a primer) can be present between the coating and the surface of the substrate. In addition, or alternatively, as described above, the coating can be partially or fully impregnated into the substrate and conform to interior surfaces of the substrate.

The poly(lactone)s I, specifically poly(lactone)s I-a to I-o, have a wide variety of other uses, depending on their properties, such as molecular weight, degree of crosslinking, and crosslinking agent if used. For example, the poly(lactone)s I, specifically poly(lactone)s I-a to I-o, can be used in paper manufacturing, textile finishes, oil production, plastics, coatings, personal care compositions aqueous ink compositions, food packaging, construction materials (e.g., masonry, grout, concrete formulations, and the like, for example to retard drying time) and biomedical applications, among others. The poly(lactone)s I, specifically poly(lactone)s I-a to I-o, can function as coatings, horticultural additives, rheology modifiers and grease thickeners, adhesives, or binders. The poly(lactone)s I, specifically poly(lactone)s I-a to I-o, can function as parts including films; laminates; sheets (e.g. artificial glass); shaped articles including automotive parts (e.g. head lamps, bumpers, body panels, doors, dashboards, trunk or trunk liners, tailgates, display panels, roof racks, door handles, and the like), housings and casings (e.g. for electronics, medical equipment, and the like), pipes, beams, protective articles (e.g. eye wear, splash shields, and the like), furniture, containers (e.g. trays (e.g. food, surgical, and the like), bottles, boxes, drums, and the like); decorative items; cable sheathing; wire sheathing; and the like. The poly(lactone)s I, specifically poly(lactone)s I-a to I-o, can function as mechanical property modifiers as incorporated as a blend, as a particulate (e.g. rubber particles in high impact polystyrene (HIPS)), as a fiber and can function as an adhesive (e.g. when polymerized with rubbery comonomers), or as an poly(lactone) (e.g. when polymerized with ionic comonomers).

The poly(lactone)s I, specifically poly(lactone)s I-a to I-o, can be used in specific applications such as gel mouse pads, air fresheners, or as thickening agents for example for water based paints and coatings. When the poly(lactone) I, specifically poly(lactone)s I-a to I-o, are to be used as a chelant, dispersant, or detergent builder, the total number of units can be 20 to 200, or 50 to 100.

The invention is further illustrated by the following Examples, which are not limiting.

### EXAMPLES

The following are illustrative examples in which all parts and percentages are by weight and all temperatures are in degrees Centigrade unless otherwise noted.

Number average molecular weight average (Mn), weight average molecular weight (Mw), and polydispersity were determined by gel permeation chromatography using a dimethylformamide mobile phase containing 1 wt. % LiBr relative to a poly(methyl methacrylate) (PMMA) standard, unless otherwise indicated.

Measurement of absorption under load (AUL) was determined as follows. A 100-mesh nylon screen was put onto a perforated metal plate with holes of 4 millimeters (mm) followed by a filter paper. A stainless steel cylinder with an inside diameter of 25.4 mm and wall thickness of 4 mm with a height of 50 mm whose both sides were open, was put onto the nylon screen. 167 milligrams (mg) of polymer was placed into the cylinder and evenly distributed, covered by a filter paper of a diameter of 25.4 mm. It was pressed down with a plastic piston of 25.4 mm, which carries a weight. The total weight of piston and cylinder is 106.8 g to give a 2.1 kilopascals (kPa) (0.3 pounds per square inch (psi)) load. The metal plate with the product in the cylinder on top was immersed into a 0.9% saline solution. The level of the saline solution had the same level as the nylon screen so that the filter paper and the particles could absorb water. A soak time of 1 hour was applied. The plate was then removed from the saline solution and the excess water in the holes of the plate was removed with a tissue. The weight was removed from the swollen gel and the gel was weighed. The ratio of absorbed saline solution to polymer particles was reported as the absorption under load.

Free Absorbency (tea bag method) was measured as follows. Approximately 0.25 g of dried, crushed polymer was placed in a tea bag (small Press 'N Brew tea bag from Mountain Rose Herbs of Eugene, Oreg.), which was then heat-sealed with a hot iron. The masses of the empty bag and the polymer were recorded before the start of the experiment. Beakers of the test solutions were prepared by taring the beakers, rinsing them with the test liquid (either DI water, 0.9% NaCl solution in water, or 8% NaCl solution in water), and filling with 125 g of the test liquid. A single sealed tea bag was then placed in each of the test solutions. The tea bags were periodically pulled from the test solutions by tweezers, allowed to drain until liquid no longer freely dripped, and then weighed on a tared balance. The total mass (bag+polymer+absorbed liquid) was recorded as a function of time. The amount of absorbed liquid was calculated by subtracting the starting masses of the dried bag and the dried polymer. Blank bags were soaked in separate containers of the test liquids to estimate how much liquid was absorbed by the bag. The mass uptake per gram of polymer (free absorbency capacity) was calculated according to the following equation, where m_{blank} si the average absorbency of an empty tea bag in the test liquid:

$$free absorbency capacity = \frac{{m}_{absorbed} - {m}_{blank}}{{m}_{polymer}} \qquad Equation 1$$

Water solubility was visually assessed by dissolving 0.1 g of polymer in 1 g of water and visually assessing whether a clear solution formed or whether a gel formed.

Glass transition temperature was determined by differential scanning calorimetry (DSC) at a heating/cooling rate of 10° C./min. The sample was initially heated to 250° C. and cooled to −60° C. after a 2-minute hold at 250° C. The Tg was measured on the second scan to 250° C.

### Example 1

### Synthesis of 191 kDa poly(α-methylene-γ-butyrolactone-acrylic acid)

To a 250 mL round bottom flask equipped with a magnetic stir bar was added 44.080 g (2.45 mol) water and 0.523 g (1.81×10⁻³ mol) sodium dodecyl sulfate (20% aqueous solution). The mixture was heated under flowing nitrogen to 75° C., at which time a monomer mixture consisting of 20.81 g (2.12×10⁻¹ mol) α-methylene-γ-butyrolactone that had been previously filtered over basic alumina and 1.100 g (1.83×10⁻² mol) acrylic acid was added dropwise over 110 minutes. After 10 minutes of monomer mixture addition, an aqueous mixture consisting of 83.48 g (4.63 mol) water, 1.32 g (4.58×10⁻³ mol) sodium dodecyl sulfate (20% aqueous solution), 0.065 g (2.73×10⁻⁴ mol) sodium persulfate, and 0.18 g of a 20% aqueous sodium hydroxide solution was added dropwise over 110 minutes. After both the monomer and aqueous mixtures were added completely, the emulsion was allowed to stir for an additional 60 minutes, after which the reaction was cooled to room temperature and dried under vacuum at 90° C. overnight. Size exclusion chromatography yielded a weight average molecular weight of 191 kDa and a polydispersity of 1.62, relative to polystyrene standards.

### Example 2

### Synthesis of 507 kDa poly(α-methylene-γ-butyrolactone-acrylic acid)

To a 250 mL round bottom flask equipped with a magnetic stir bar was added 44.045 g (2.44 mol) water and 0.512 g (1.78×10⁻³ mol) sodium dodecyl sulfate (20% aqueous solution). The mixture was heated under flowing nitrogen to 74° C., at which time a monomer mixture consisting of 20.805 g (2.13×10⁻¹ mol) α-methylene-γ-butyrolactone that had been previously filtered over basic alumina and 1.100 g (1.83×10⁻³ mol) acrylic acid was added dropwise over 110 minutes. After 10 minutes of monomer mixture addition, an aqueous mixture consisting of 83.37 g (4.63 mol) water, 1.32 g (4.58×10⁻³ mol) sodium dodecyl sulfate (20% aqueous solution), 0.047 g (1.97×10⁻⁴ mol) sodium persulfate, and 0.175 g of a 20% aqueous sodium hydroxide solution was also added via syringe pump over 110 minutes. After both the monomer and aqueous mixtures had added completely, the emulsion was allowed to stir for an additional 60 minutes, after which the reaction was cooled to room temperature and dried under vacuum at 90° C. overnight. Size exclusion chromatography yielded a weight average molecular weight of 507 kDa and a polydispersity of 1.75, relative to polystyrene standards.

### Example 3

### Synthesis of 817 kDa poly(α-methylene-γ-butyrolactone-acrylic acid)

To a 50 mL round bottom flask equipped with a magnetic stir bar was added 5.890 g (0.327 mol) water and 0.090 g (3.12×10⁻⁴ mol) sodium dodecyl sulfate (20% aqueous solution). The mixture was heated under flowing nitrogen to 74° C., at which time a monomer mixture consisting of 2.850 g (2.91×10⁻² mol) α-methylene-γ-butyrolactone that had been previously fractionally distilled and filtered over basic alumina and 0.150 g (2.50×10⁻³ mol) acrylic acid was added via syringe pump over 130 minutes. After 10 minutes of monomer mixture addition, an aqueous mixture consisting of 11.130 g (0.618 mol) water, 0.185 g (6.42×10⁻⁴ mol) sodium dodecyl sulfate (20% aqueous solution), 0.002 g (9.24×10⁻⁶ mol) sodium persulfate, and 0.061 g of a 20% aqueous sodium hydroxide solution was also added via syringe pump over 130 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a weight average molecular weight of 817 kDa and a polydispersity of 1.87, relative to polystyrene standards.

### Example 4

### Synthesis of 647 kDa poly(α-methylene-γ-valerolactone-acrylic acid)

To a 50 mL round bottom flask equipped with a magnetic stir bar was added 6.172 g (0.343 mol) water and 0.078 g (2.70×10⁻⁴ mol) sodium dodecyl sulfate (20% aqueous solution). The mixture was heated under flowing nitrogen to 73° C., at which point a monomer mixture consisting of 2.913 g (2.58×10⁻² mol)α-methylene-γ-valerolactone that had been previously fractionally distilled and filtered over basic alumina and 0.154 g (2.56×10⁻³ mol)acrylic acid were added via syringe pump over 120 minutes. After 10 minutes of monomer mixture addition, an aqueous mixture consisting of 11.677 g (0.649 mol) water, 0.198 g (6.87×10⁻⁴ mol) sodium dodecyl sulfate (20% aqueous solution), 0.004 g (1.68×10⁻⁵ mol) sodium persulfate, and 0.029 g of a 20% aqueous sodium hydroxide solution was also added via syringe pump over 120 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a weight average molecular weight of 647 kDa and a polydispersity of 2.77, relative to polystyrene standards.

### Example 5

### Synthesis of 931 kDa poly(α-methylene-γ-valerolactone-acrylic acid)

To a 50 mL round bottom flask equipped with a magnetic stir bar was added 7.3769 (0.343 mol) water and 0.084 g (2.70×10⁻⁴ mol) sodium dodecyl sulfate. (20% aqueous solution). The mixture was heated under flowing nitrogen to 73° C., at which point a monomer mixture consisting of 3.4691 g (2.58×10⁻² mol) α-methylene-γ-valerolactone and 0.184 g (2.56×10⁻³ mol) acrylic acid was added via syringe pump over 115 minutes. After 10 minutes of monomer mixture addition, an aqueous mixture consisting of 13.9194 g (0.649 mol) water, 0.2360 g (6.87×10⁻⁴ mol) sodium dodecyl sulfate (20% aqueous solution), 0.0201 g (1.68×10⁻⁵ mol) sodium persulfate, and 0.0376 g of a 20% aqueous sodium hydroxide solution was also added via syringe pump over 120 minutes. After both the monomer and aqueous mixtures were added completely, the emulsion was allowed to stir for an additional 60 minutes, after which the reaction was cooled to room temperature and dried under vacuum at 100° C. Analysis of the polymer by DSC showed a single T_{g} at 210° C. Size exclusion chromatography yielded a molecular weight of 931 kDa and a PDI of 2.00.

### Example 6

### Addition of caustic solution to 191 kDa poly(α-methylene-γ-butyrolactone-acrylic acid)

To a high-pressure stainless steel reactor containing 0.201 g of the 191 kDa poly(α-methylene-γ-butyrolactone-acrylic acid) prepared in Example 1 was added 3.993 g of a 10% caustic solution. The reactor was sealed tightly and placed in a 140° C. oven for 5 hours. After the allotted time, the reactor was removed and cooled to room temperature in air. The contents of the reactor were emptied into a 120 mL jar and the residual NaOH was back-titrated to pH 7 using 81 mL of 0.1 N HCl, suggesting 93% saponification of the lactone groups.

### Example 7

### Addition of KOH to 191 kDa poly(α-methylene-γ-butyrolactone-acrylic acid)

To a high pressure stainless steel reactor, 0.2505 g of the 191 kDa poly(α-methylene-γ-butyrolactone-acrylic acid) prepared in Example 1 was added along with 3.3066 g of a 4.25% KOH. The reactor was sealed and heated in a 140° C. oven for 5 hours, at which point it was cooled to room temperature. Once cool, the reactor contents were emptied into a 60 mL jar and the residual base was back-titrated to a pH of 7 with 0.1 N HCl. Using 3.0 mL of titrant, the degree offing opening was calculated to be 73%.

### Example 8

### Addition of 0.1 molar equivalents based on the number of lactone groups of NaOH to 191 kDa poly(α-methylene-γ-butyrolactone-acrylic acid)

To a scintillation vial charged with 0.198 g of the 191 kDa poly(α-methylene-γ-butyrolactone-acrylic acid) prepared in Example 1 was added 0.0420 g of a 20% NaOH(aq) solution (0.1 molar equivalents based on the number of lactone groups). The vial was capped and heated at 90° C. for 2 hours before being removed from the oven and left to cool in air. The reaction had a measured pH of 7, suggesting complete conversion of the base and 10% saponification of the lactone groups.

### Example 9

### Addition of 0.3 molar equivalents based on the number of lactone groups of NaOH to 191 kDa poly(α-methylene-γ-butyrolactone-acrylic acid)

To a scintillation vial charged with 0.190 g of the 191 kDa poly(α-methylene-γ-butyrolactone-acrylic acid) prepared in Example 1 was added 0.1167 g of a 20% NaOH(aq) solution (0.3 molar equivalents based on the number of lactone groups). The vial was capped and heated at 90° C. for 2 hours before being removed from the oven and left to cool in air. The unreacted NaOH was back-titrated to pH 7 using 0.4 mL 0.1 N HCl, suggesting 92% conversion of the base and 27% saponification of the lactone groups.

### Example 10

### Addition of DMF to 191 kDa poly(α-methylene-γ-butyrolactone-acrylic acid)

To a scintillation vial equipped with a magnetic stir bar was added 0.82 g of the 191 kDa poly(α-methylene-γ-butyrolactone-acrylic acid) prepared in Example 1, 2.95 mL DMF, and 0.041 g triethylamine. The reaction was capped and stirred at 65° C. before the dropwise addition of 0.92 g of a 51% KOH solution and 7 mL water. The reaction was stirred for an additional 90 minutes before being allowed to cool and the residual base backtitrated to pH 7 with 27 mL 0.1 N HCl, suggesting 74% saponification.

### Example 12

### Prophetic-Addition of LiOH to poly(α-methylene-γ-butyrolactone-acrylic acid)

To a high-pressure stainless steel reactor containing 0.200 g (1.05×10⁻⁶ mol) of the 191 kDa poly(α-methylene-γ-butyrolactone-acrylic acid) prepared in Example 1 is added 0.0451 g (1.88×10⁻³ mol) LiOH. The reactor is sealed tightly and placed in a 140° C. oven. When the reaction is complete, the reactor is cooled to room temperature in air, emptied into a 120 mL jar and the residual LiOH is back-titrated to pH 7 using 0.1 N HCl to determine the degree of ring opening. The anticipated degree of ring opening is expected to be greater than 50%.

### Example 13

### Prophetic-Addition of CsOH to poly(α-methylene-γ-butyrolactone-acrylic acid)

To a high-pressure stainless steel reactor containing 0.200 g (1.05×10⁻⁶ mol) of the 191 kDa poly(α-methylene-γ-butyrolactone-acrylic acid) prepared in Example 1 is added 0.2823 g (1.88×10⁻³ mol) CsOH. The reactor is sealed tightly and placed in a 140° C. oven. When the reaction is complete, the reactor is cooled to room temperature in air, emptied into a 120 mL jar and the residual LiOH is back-titrated to pH 7 using 0.1 N HCl to determine the degree of ring opening. The anticipated degree of ring opening is expected to be greater than 50%.

### Example 14

### Addition of a caustic solution to 507 kDa poly(α-methylene-γ-butyrolactone-acrylic acid)

A 0.510 g sample of the poly(α-methylene-γ-butyrolactone-acrylic acid) prepared in Example 2 with a weight-average molecular weight of 507 kDa and a polydispersity of 1.75 was added to a scintillation vial, along with 3.40 g (0.189 mol) of water and homogenized in a sonication bath to create a stable suspension of polymer particles in water. The suspension was then exposed to 24 kHz ultrasonic oscillations in 0.5-second bursts via a 14 mm titanium ultrasonic horn placed just below the liquid surface in the scintillation vial. After 5 minutes of ultrasonic agitation, 1.38 g of a 20% caustic solution was added to the vial and the reaction mixture was loosely capped and placed in a 90° C. oven for 125 minutes. The reaction cooled to room temperature under vacuum before 1H NMR analysis. Comparison of the protons corresponding to the ring opened lactone with those of the ring close lactone showed 86% of the original lactone groups had been successfully saponified.

### Example 15

### Addition of a 20% NaOH solution to 507 kDa poly(α-methylene-γ-butyrolactone-acrylic acid)

To a scintillation vial charged with 0.6321 g of the 507 kDa poly(α-methylene-γ-butyrolactone-acrylic acid) prepared in Example 2 was added 4.988 g water and 1.1802 g of a 20% NaOH(aq) solution. The vial was capped and placed in a 90° C. oven for 120 minutes before removing the vial and adjusting the pH of the reaction mixture to 7 using a 5% aqueous citric acid solution before drying. The resulting dry polymer was completely soluble in water, as determined optically as a homogenous solution.

### Example 16

### Addition of a 50% NaOH solution to 507 kDa poly(α-methylene-γ-butyrolactone-acrylic acid)

To a scintillation vial charged with 0.4866 g of a the 507 kDa poly(α-methylene-γ-butyrolactone-acrylic acid) prepared in Example 2 was added 2.7303 g water and 1.8717 g of a 50% NaOH solution. The reaction was mixed ultrasonically using 0.5-second bursts of 24 kHz agitation for 120 minutes at 90° C. The reaction was allowed to cool to room temperature before being transferred to a 250 mL beaker and the residual NaOH was back-titrated using 171 mL of 0.1 N HCl, corresponding to 66% of the lactone rings being saponified.

### Example 17

### Formation of a clear poly(α-methylene-γ-valerolactone-acrylic acid) film

To a scintillation vial was added 267 mg of the poly(α-methylene-γ-butyrolactone-acrylic acid) prepared in Example 5 and 5.14 mL DMSO on a platform shaker. Once dissolved, the solution was pipetted onto a foil-lined steel panel and placed in a 100° C. oven. Vacuum was applied to remove the solvent over approximately 60 minutes. The result was a 2 cm×2 cm transparent poly(α-methylene-γ-valerolactone-acrylic acid) film.

### Examples 18-22

### Degree of ring opening of 191 kDa poly(α-methylene-γ-butyrolactone-acrylic acid)

To a scintillation vial was added a prescribed amount of the 191 kDa poly(α-methylene-γ-butyrolactone-acrylic acid) prepared in Example 1 polymer along with approximately 1 molar equivalent of a 10% NaOH(aq) solution. The vials were capped and placed in a 95° C. oven for 120 minutes before being removed from the oven and allowed to cool to room temperature in air. The residual base was then back-titrated using 0.1 N HCl(aq) to a pH of 7. The conversion of base was calculated and used to calculate the degree of ring opening, with the results summarized in Table 2.

TABLE 2
Results of saponification as a function of reaction media dilution.

| | Mass | Mass 10% NaOH_{(aq)} | Volume H₂O | % Ring |
|---|---|---|---|---|
| Example | Polymer (g) | solution (g) | Added (mL) | Opened |
| 18 | 0.2514 | 0.9930 | 2.148 | 53.0 |
| 19 | 0.2557 | 0.9940 | 0.915 | 56.9 |
| 20 | 0.2520 | 1.0190 | 0.493 | 61.0 |
| 21 | 0.2460 | 1.0010 | 0.287 | 61.1 |
| 22 | 0.2529 | 1.0002 | 0.156 | 62.1 |

As can be seen from the results in Table 2, decreasing the amount of water added results in a greater percent of rings opened.

### Examples 23-24 and Comparative Examples 25-27

### Post-synthesis crosslinking of 507 kDa poly(α-methylene-γ-butyrolactone-acrylic acid) through the pendant lactone groups

Examples 23-24 were prepared according to the following procedure. Approximately 50 mg of the 507 kDa poly(α-methylene-γ-butyrolactone-acrylic acid) prepared in Example 11 that had been dried, ground, and sieved to a particle size between 297 and 595 μm (30 and 50 mesh sieves, respectively) was added to a vial with approximately 15 mg of a 50 wt. % methanolic solution of the dinucleophile to be tested. In some cases, a catalyst was added to increase the reactivity of the crosslinking reagent. The sample was then placed in a 100° C. oven for 120 minutes or until the methanol had evaporated, whichever was longer. After removing the vials and allowing them to cool, 0.300 mL DMSO was added to each vial and the solubility or insolubility of the sample was determined optically (i.e. the sample was either optically homogeneous or optically heterogeneous). Insolubility was taken as evidence for the formation of a crosslinked network. Comparative Examples 33 and 34 were prepared in the same manor except no crosslinker solution was added. Comparative Example 35 was prepared in the same manor except no crosslinker was solution was added and the sample was not heated. The results of solubility experiments are shown in Table 3.

TABLE 3
Results of post-synthesis crosslinking experiments using
dinucleophillic reagents through pendant lactone groups.

| | | | Mass 50% | Catalyst | Time | |
|---|---|---|---|---|---|---|
| | | Mass | Crosslinker | 20% | at | Solubility |
| Example | Crosslinker | Polymer | Solution | NaOH_{(aq)} | 100° C. | in DMSO |
| 23 | 1,6-Hexanediol | 44.4 mg | 47 mg | 10 μL | 2 hr | Insoluble |
| 24 | 1,6- | 51.0 mg | 16 mg | — | 2 hr | Insoluble |
| | Hexanediamine | | | | | |
| CE 25 | None | 42.2 mg | — | 10 μL | 2 hr | Soluble |
| CE 26 | None | 55 mg | — | — | 2 hr | Soluble |
| CE 27 | None | 51 mg | — | — | — | Soluble |

As can be seen from the results in Table 3, the formation of an insoluble, crosslinked polymer was observed with the addition of a crosslinker.

### Examples 28-29

### Prophetic-Post-synthesis crosslinking of 647 kDa poly(α-methylene-γ-valerolactone-acrylic acid) through the pendant lactone groups

Similar to examples 23-24, except the polymer sample to be crosslinked is a poly(α-methylene-γ-valerolactone-acrylic acid) sample similar to that prepared in Example 4. Example 28 is reacted with 1,6-hexanediol in the presence of a NaOH catalyst to yield a cross-linked, insoluble network, while Example 29 is reacted with 1,6-Hexanediamine without a catalyst also yielding a cross-linked, insoluble network. Insolubility, as in the above examples, is determined by eye as the presence of either a homogenous solution or two-phase mixture.

### Examples 30-32 and Comparative Examples 33-34

### Post-synthesis crosslinking of 507 kDa poly(α-methylene-γ-butyrolactone-acrylic acid) using dielectrophilic reagents

In addition to post-synthesis crosslinking through the pendant lactone groups, post-synthesis crosslinking of the saponified poly(α-methylene-γ-butyrolactone-acrylic acid) can be accomplished using dielectrophilic reagents. In these examples, the vials were charged with approximately 0.50 g of the poly(α-methylene-γ-butyrolactone-acrylic acid) prepared in Example 2 in which 67% of the lactone rings had been saponified by aqueous caustic solution at 90° C. for 120 minutes. To each vial was added approximately 40 μL of a crosslinker and the reaction mixtures were heated at 90° C. for 120 minutes. Comparative Examples 33 and 34 were prepared in the same manor except no crosslinker solution was added.

TABLE 4
Results of post-Synthesis crosslinking of partially saponified poly(α-methylene-
γ-butyrolactone-acrylic acid) experiments using dielectrophilic reagents.

| | | | Vol of | Vol of | | |
|---|---|---|---|---|---|---|
| | | | 20% | 50% | | |
| | | Mass | NaOH | Crosslinker | Time at | Soluble in |
| Example | Crosslinker | Polymer | Catalyst | solution | 90° C. (hr) | Water? |
| 30 | Diethyl | 48 mg | 2.3 μL | 40 μL | 2 | Insoluble |
| | Sebacate | | | | | |
| 31 | Butanediol | 45 mg | 2.3 μL | 40 μL | 2 | Insoluble |
| | Diglycidyl | | | | | |
| | Ether | | | | | |
| 32 | Isophorone | 51 mg | — | 80 μL | 2 | Insoluble |
| | Diisocyanate | | | | | |
| CE 33 | None | 48 mg | 2.3 μL | — | 2 | Soluble |
| CE 34 | None | 47 mg | — | — | — | Soluble |

As can be seen from the results in Table 4, the formation of an insoluble, cross-linked polymer formed in Examples 38 through 40.

### Examples 35-37

### Prophetic-Post-synthesis crosslinking of 647 kDa poly(α-methylene-γ-valerolactone-acrylic acid) using dielectrophilic reagents

Similar to examples 38-41, except the polymer sample to be crosslinked is a poly(α-methylene-γ-valerolactone-acrylic acid) sample similar to that prepared in Example 10. Example 35 is cross-linked with diethyl sebacate in the presence of a NaOH catalyst to yield a cross-linked, insoluble network. Example 36 is reacted with butanediol diglycidyl ether in the presence of a NaOH catalyst, to yield a cross-linked, insoluble network. Finally, Example 37 is reacted with isophorone diisocyanate without a catalyst to yield a cross-linked, insoluble network. Insolubility, as in the above examples, is determined by eye as the presence of either a homogenous solution or two-phase mixture.

### Examples 38-40

### Sol-Gel determination of poly(α-methylene-γ-valerolactone-acrylic acid)

To a 150 mL round bottom flask equipped with a magnetic stir bar was added 11.730 g (0.651 mol) water and 0.140 g (4.85×10⁻⁴ mol) sodium dodecyl sulfate (20% aqueous solution). The mixture was heated under flowing nitrogen to 71° C., at which time a monomer mixture consisting of 5.561 g (4.91×10⁻² mol) α-methylene-γ-valerolactone, 0.290 g (4.83×10⁻³ mol) acrylic acid, and either 0.2%, 0.5%, or 1.0% by weight of pentaerythritol allyl ether crosslinker (70% purity) were added dropwise over 110 minutes. After 5 minutes of monomer mixture addition, an aqueous mixture consisting of 22.270 g (1.237 mol) water, 0.355 g (1.23×10⁻³ mol) sodium dodecyl sulfate (20% aqueous solution), 0.039 g (1.63×10⁻⁴ mol) sodium persulfate, and 0.053 g of a 20% aqueous sodium hydroxide solution was also added dropwise over 110 minutes. After both the monomer and aqueous mixtures were added completely, the emulsion was allowed to stir for an additional 60 minutes, after which the reaction was cooled to room temperature and dried for 16 hours at 90° C. under vacuum. In each experiment, a 100-fold excess of DMF was added to the polymer sample and allowed to sit on a platform shaker for 22 hours. The DMF was then decanted and the solvent removed under vacuum to determine the mass of the soluble chains. The insoluble portion was also dried under vacuum to determine the insoluble fraction.

TABLE 5
Sol and Gel fraction determination for Examples 38-40.

| | Pentaerythritol | | | | |
|---|---|---|---|---|---|
| | Allyl Ether | Mass Gel | Mass | | |
| | Loading | Fraction | Soluble | | |
| Example | (wt. %) | (g) | Fraction (g) | Gel % | Sol % |
| 38 | 0.2% | 0.165 | <0.001 | >99% | <1% |
| 39 | 0.5% | 0.178 | <0.001 | >99% | <1% |
| 40 | 1.0% | 0.155 | <0.001 | >99% | <1% |

The results in Table 5 show the soluble and insoluble fractions obtained from three poly(α-methylene-γ-valerolactone-acrylic acid) polymerizations utilizing varying amounts of pentaerythritol allyl ether crosslinker.

### Example 41

### Prophetic—Synthesis of poly(α-methylene-γ-valerolactone-triallyl amine-acrylic acid) copolymer

To a 150 mL round bottom flask equipped with a magnetic stir bar is added 10.00 g (0.555 mol) water and 0.115 g (3.99×10⁻⁴ mol) sodium dodecyl sulfate (20% aqueous solution). The mixture is pre-heated under flowing nitrogen to 75° C., at which time a monomer mixture consisting of 4.725 g (4.18×10⁻² mol) α-methylene-γ-valerolactone, 0.250 g (4.16×10⁻³ mol) acrylic acid, and 0.036 g (2.62×10⁻⁴ mol) triallyl amine is added dropwise over 120 minutes. After 5 minutes of monomer mixture addition, an aqueous mixture consisting of 18.937 g (1.05 mol) water, 0.300 g (1.04×10⁻³ mol) sodium dodecyl sulfate (20% aqueous solution), 0.033 g (1.39×10⁻⁴ mol) sodium persulfate, and 0.037 g of a 20% aqueous sodium hydroxide solution is also added dropwise over 120 minutes. After addition of both the monomer and aqueous mixtures are complete, the emulsion stirs for an additional 60 minutes, after which the reaction is cooled to room temperature and the polymer can be dried under vacuum for isolation.

The resulting polymer can be saponified as described above.

### Example 42

### Prophetic—Synthesis of poly(α-methylene-γ-butyrolactone-triallyl amine-acrylic acid) copolymer

Similar to Example 33, except α-methylene-γ-butyrolactone is used in place of α-methylene-γ-valerolactone.

The resulting polymer can be saponified as described above.

### Example 42

### Synthesis of poly(α-methylene-γ-butyrolactone-n-butyl acrylate-acrylic acid) copolymer

To a 100 mL round bottom flask equipped with a magnetic stir bar was added 8.819 g (0.490 mol) water and 0.116 g (4.02×10⁻⁴ mol) sodium dodecyl sulfate (20% aqueous solution). The mixture was heated under flowing nitrogen to 73° C., at which time a monomer mixture consisting of 2.102 g (2.14×10⁻² mol) α-methylene-γ-butyrolactone, 2.102 g n-butyl acrylate (1.64×10⁻² mol) and 0.220 g (3.66×10⁻³ mol) acrylic acid was added via syringe pump over 115 minutes. After 10 minutes of monomer mixture addition, an aqueous mixture consisting of 16.711 g (0.928 mol) water, 0.267 g (9.26×10⁻⁴ mol) sodium dodecyl sulfate (20% aqueous solution), 0.026 g (1.09×10⁻⁴ mol) sodium persulfate, and 0.033 g of a 20% aqueous sodium hydroxide solution was added via syringe pump over 115 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a monomodal peak with a weight average molecular weight of 296 kDa and a polydispersity of 2.84, relative to polystyrene standards. Differential scanning calorimetry showed a single first order transition at approximately 21° C.

The resulting polymer can be saponified as described above.

### Example 44

### Synthesis of poly(α-methylene-γ-butyrolactone-n-butyl acrylate-acrylic acid) copolymer

Similar to Example 34, with the following exception: 3.390 g (3.46×10⁻² mol) α-methylene-γ-butyrolactone and 1.075 g (8.39×10⁻³ mol) n-butyl acrylate were used in the monomer mixture, yielding a polymer with a glass transition temperature of 145° C. Comparison to the Fox equation suggests the statistical copolymer contains approximately 11% n-butyl acrylate repeat units.

The resulting polymer can be saponified as described above.

### Example 45a and b

### Prophetic—Synthesis of poly(α-methylene-γ-valerolactone-n-butyl acrylate-acrylic acid) copolymer

Similar to Example 35 and Example 36, except α-methylene-γ-valerolactone is used in place of α-methylene-γ-butyrolactone.

The resulting polymer can be saponified as described above.

### Example 46

### Synthesis of poly(α-methylene-γ-butyrolactone-styrene-acrylic acid) copolymer

To a 100 mL round bottom flask equipped with a magnetic stir bar was added 8.825 g (0.490 mol) water and 0.117 g (4.06×10⁻⁴ mol) sodium dodecyl sulfate (20% aqueous solution). The mixture was heated under flowing nitrogen to 73° C., at which time a monomer mixture consisting of 3.079 g (3.14×10⁻² mol) α-methylene-γ-butyrolactone, 1.082 g styrene (1.04×10⁻² mol) and 0.220 g (3.66×10⁻³ mol) acrylic acid was added via syringe pump over 130 minutes. After 10 minutes of monomer mixture addition, an aqueous mixture consisting of 16.694 g (0.927 mol) water, 0.269 g (9.33×10⁻⁴ mol) sodium dodecyl sulfate (20% aqueous solution), 0.033 g (1.39×10⁻⁴ mol) sodium persulfate, and 0.041 g of a 20% aqueous sodium hydroxide solution was added via syringe pump over 130 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a monomodal peak with a weight average molecular weight of 104 kDa and a polydispersity of 1.96, relative to polystyrene standards. Differential scanning calorimetry showed a single first order transition at approximately 167° C.

The resulting polymer can be saponified as described above.

### Example 47

### Prophetic—Synthesis of poly(α-methylene-γ-valerolactone-styrene-acrylic acid) copolymer

Similar to Example 46, except α-methylene-γ-valerolactone is used in place of α-methylene-γ-butyrolactone.

The resulting polymer can be saponified as described above.

### Example 48

### Synthesis of poly(α-methylene-γ-butyrolactone-acrylic acid) copolymer

To a 100 mL round bottom flask equipped with a magnetic stir bar was added 8.800 g (0.489 mol) water and 0.108 g (3.75×10⁻⁴ mol) sodium dodecyl sulfate (20% aqueous solution). The mixture was heated under flowing nitrogen to 73° C., at which time a monomer mixture consisting of 4.103 g (4.18×10⁻² mol) α-methylene-γ-butyrolactone and 0.278 g (4.63×10⁻³ mol) acrylic acid was added via syringe pump over 135 minutes. After 15 minutes of monomer mixture addition, an aqueous mixture consisting of 16.661 g (0.926 mol) water, 0.282 g (9.78×10⁻⁴ mol) sodium dodecyl sulfate (20% aqueous solution), 0.034 g (1.43×10⁻⁴ mol) sodium persulfate, and 0.032 g of a 20% aqueous sodium hydroxide solution was added via syringe pump over 135 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a monomodal peak with a weight average molecular weight of 126 kDa and a polydispersity of 2.12, relative to polystyrene standards. Differential scanning calorimetry showed a single first order transition at approximately 174° C.

The resulting polymer can be saponified as described above.

### Example 49

### Prophetic—Synthesis of poly(α-methylene-γ-valerolactone-acrylic acid) copolymer

Similar to Example 44, except α-methylene-γ-valerolactone is used in place of α-methylene-γ-butyrolactone. The resulting polymer can be saponified as described above.

### Example 50

### Synthesis of poly(α-methylene-γ-butyrolactone-N,N-dimethyl acrylamide) copolymer

To a 100 mL round bottom flask equipped with a magnetic stir bar was added 8.844 g (0.491 mol) water and 0.121 g (4.20×10⁻⁴ mol) sodium dodecyl sulfate (20% aqueous solution). The mixture was heated under flowing nitrogen to 73° C., at which time a monomer mixture consisting of 2.053 g (2.09×10⁻² mol) α-methylene-γ-butyrolactone and 2.113 g (2.13×10⁻² mol) N,N-dimethyl acrylamide was added via syringe pump over 120 minutes. After 10 minutes of monomer mixture addition, an aqueous mixture consisting of 16.658 g (0.925 mol) water, 0.264 g (9.15×10⁻⁴ mol) sodium dodecyl sulfate (20% aqueous solution), 0.029 g (1.22×10⁻⁴ mol) sodium persulfate, and 0.028 g of a 20% aqueous sodium hydroxide solution was added via syringe pump over 120 minutes. After both the monomer and aqueous mixtures were added completely, the emulsion was allowed to stir for an additional 60 minutes, after which the reaction was cooled to room temperature and dried under vacuum under vacuum at 90° C. overnight. Size exclusion chromatography yielded a monomodal peak with a weight average molecular weight of 200 kDa and a polydispersity of 3.32, relative to polystyrene standards. Differential scanning calorimetry showed a first order transition at approximately 162° C.

The resulting polymer can be saponified as described above.

### Example 51

### Prophetic—Synthesis of poly(α-methylene-γ-valerolactone-N,N-dimethyl acrylamide) copolymer

Similar to Example 50, except α-methylene-γ-valerolactone is used in place of α-methylene-γ-butyrolactone.

The resulting polymer can be saponified as described above.

### Example 52

### Prophetic—Synthesis of poly(α-methylene-γ-butyrolactone-itaconic acid-acrylic acid)

To a 100 mL round bottom flask with a magnetic stir bar and reflux condenser is added 25 g (1.389 mol) water and 22.75 g (1.75×10⁻¹ mol) itaconic acid. The mixture is heated under flowing nitrogen to 75° C., at which time a monomer mixture consisting of 17.20 g (1.75×10⁻¹ mol) α-methylene-γ-butyrolactone and 2.00 g (3.33×10⁻² mol) acrylic acid is added via syringe pump over 300 minutes at reflux. After 10 minutes of monomer mixture addition, an aqueous mixture consisting of 18.015 g (1.00 mol) water, 1.42 g (5.97×10⁻³ mol) sodium persulfate, and 1.32 g (3.33×10⁻² mol) sodium hydroxide is added via syringe pump over 300 minutes at reflux. After both the monomer and aqueous mixtures are added completely, the emulsion is allowed to stir for an additional 60 minutes before cooling to room temperature and drying under vacuum at elevated temperature for isolation.

The resulting polymer can be saponified as described above.

### Example 53

### Prophetic—Synthesis of poly(α-methylene-γ-valerolactone-acrylic acid)

Similar to Example 52, except α-methylene-γ-valerolactone is used in place of α-methylene-γ-butyrolactone.

The resulting polymer can be saponified as described above.

### Example 54

### Prophetic—Synthesis of poly(α-methylene-γ-butyrolactone-octadecyl acrylate) copolymer

To a high-pressure reactor with a magnetic stirrer is charged 31.50 g (1.75 mol) water, 13.50 g (0.232 mol) acetone, 25.0 g (7.70×10⁻² mol) octadecyl acrylate, 25.0 g (0.255 mol) α-methylene-γ-butyrolactone, 1.25 g (4.08×10⁻³ mol) sodium stearate, and 0.13 g (5.46×10⁻⁴ mol) sodium persulfate. Two freeze-pump-thaw cycles using liquid nitrogen sufficiently degass the reaction medium prior to sealing the reactor and heating to 60° C. The reaction is stirred for 16 hours at 60° C. before cooling to room temperature and drying under vacuum at elevated temperature for isolation.

The resulting polymer can be saponified as described above.

### Example 55

### Prophetic—Synthesis of poly(α-methylene-γ-valerolactone-octadecyl acrylate) copolymer

Similar to Example 54, except α-methylene-γ-valerolactone is used in place of α-methylene-γ-butyrolactone.

The resulting polymer can be saponified as described above.

### Example 56

### Prophetic—Synthesis of poly(α-methylene-γ-butyrolactone-acrylonitrile-p-styrene sulfonate) copolymer

To a high-pressure stainless steel reactor with overhead stirring is added 7.82 g (0.147 mol) of acrylonitrile, 7.82 g (7.97×10⁻² mol) of α-methylene-γ-butyrolactone, 0.50 g (2.42×10⁻³ mol) of sodium p-styrene sulfonate and 36.88 g (2.05 mol) of water. The reactor is purged with nitrogen and 0.78 g (5.33×10⁻³ mol) di-tert-butyl peroxide is added to the reaction mixture before the reactor is tightly closed and heated to 160° C. After 10 minutes at 160° C., the polymerization is allowed to cool to room temperature before drying the polymer under vacuum at elevated temperature for isolation.

The resulting polymer can be saponified as described above.

### Example 57

### Prophetic—Synthesis of poly(α-methylene-γ-valerolactone-acrylonitrile-p-styrene sulfonate) copolymer

Similar to Example 56, except α-methylene-γ-valerolactone is used in place of α-methylene-γ-butyrolactone.

The resulting polymer can be saponified as described above.

### Example 58

### Prophetic—Synthesis of poly(α-methylene-γ-butyrolactone-butadiene-acrylic acid) copolymer

A 150 mL round bottom flask with a magnetic stir bar is charged with 17 g (0.943 mol) of water, 0.01 g (6.49×10⁻⁵ mol) of sodium hydroxymethylsulfinate and 0.001 g (2.63×10⁻⁶ mol) of tetrasodium ethylene diamine tetraacetate. The reactor is heated to 80° C. under nitrogen. After 5 minutes at 80° C., 8 g of a monomer pre-emulsion consisting of 26.5 g (0.490 mol) of butadiene, 18.5 g (0.189 mol) of α-methylene-γ-butyrolactone, 1.5 g (2.50×10⁻² mol) of acrylic acid, 1.332 g (3.82×10⁻³ mol) of sodium dodecyl benzenesulfonate (15% aqueous solution), 0.25 g (1.24×10⁻³ mol) of tert-dodecylmercaptan and 22 g (1.22 mol) of water is added by cannula over 3 minutes. Additionally, 1 g of an aqueous mixture consisting of 0.25 g (4.20×10⁻³ mol) of sodium persulfate and 7 g (0.389 mol) of water is added over 2 minutes. After stirring for 20 minutes at 80° C., the remainder of the monomer pre-emulsion and aqueous mixture is added uniformly over 300 minutes. When all additions were completed, the polymerization is allowed to stir for an additional 7 hours at 80° C. Upon completion, steam is passed through the mixture under reduced pressure and a solution of 0.25 g (1.62×10⁻³ mol) of sodium hydroxymethylsulfinate in 1 g (5.55×10⁻² mol) of water is added slowly, with stirring. The pH of the dispersion is brought to 7 with 10% strength aqueous ammonia before the dispersion is dried under vacuum at elevated temperature for isolation.

The resulting polymer can be saponified as described above.

### Example 59

### Prophetic—Synthesis of poly(α-methylene-γ-butyrolactone-butadiene-acrylic acid) copolymer

Similar to Example 58, except α-methylene-γ-valerolactone is used in place of α-methylene-γ-butyrolactone.

The resulting polymer can be saponified as described above.

### Example 60

### Prophetic—Synthesis of core-shell particles of poly(α-methylene-γ-butyrolactone-butadiene)

A 250 mL flask with stirring is charged with 42.3 g (2.35 mol) water, 0.06 g (2.83×10⁻⁴ mol) tripotassium phosphate, 6.53 g of a 10% C₁₄-C₁₈ unsaturated potassium salt solution, 0.54 g of a 20% solution of a disproportionate rosin acid potassium salt, 0.12 g of a 47.5% sodium naphthalene sulfonate formaldehyde active dispersion. The pH of the solution is adjusted with a 20% aqueous potash solution to between 10.5-11. To the reactor is added 1.01 g of an activator stock solution (containing 10 g (0.555 mol) water, 0.1 g (6.49×10⁻⁴ mol) hydroxymethane-sulfinic acid monosodium salt dihydrate, and 0.03 g (8.17×10⁻⁵ mol) EDTA ferric sodium complex) and 23.75 g (0.242 mol) of α-methylene-γ-butyrolactone. The reactor is purged with nitrogen before the addition of 1.25 g (2.31×10⁻² mol) of 1,3-butadiene. The reactor is sealed and heated at 23° C. with stirring before the addition of 0.02 g of a 44% active pinane hydroperoxide solution. The seed polymerization is deemed complete when solids content reached a plateau.

Polymerization of the shell begins with the addition of 23.3 g of the above emulsion, 46.7 g (2.59 mol) water and 1.01 g of the activator stock solution from above to a 250 ml, flask with stirring. The mixture is purged with nitrogen before the addition of 7.5 g (0.139 mol) 1,3-butadiene is added and the reactor is sealed and heated to 23° C. with stirring. Polymerization is initiated with the addition of 0.02 g of a 44% active pinane hydroperoxide solution. The polymerization is deemed complete when the solids content reached a plateau, at which point the core shell particles are isolated via drying at elevated temperature.

The resulting polymer can be saponified as described above.

### Example 61

### Prophetic—Synthesis of core-shell particles of poly(α-methylene-γ-valerolactone-butadiene)

Similar to Example 60, except α-methylene-γ-valerolactone is used in place of α-methylene-γ-butyrolactone.

The resulting polymer can be saponified as described above.

### Example 62

### Prophetic—Synthesis of particles with poly(α-methylene-γ-butyrolactone) core and polystyrene shell

A reactor is charged with water (2358 g), seed latex (0.39 g), and sodium persulfate (3.1 g) and heated to 80° C. A monomer mixture of 382.8 g α-methylene-γ-butyrolactone, 277.2 g methacrylic acid, and 2.8 g sodium alkyl benzene sulfonate are added over 120 minutes to the initial charge. The emulsion is allowed to stir for an additional 60 minutes, after which the reactor is cooled to room temperature and the polymer core is removed

A reactor is charged with 1713 g water, 192.2 g the core latex, and 3.27 g sodium persulfate and heated to 92° C. A monomer mixture of 733.6 g styrene and 8.5 g acrylic acid are added over the course of 100 minutes while simultaneously feeding an aqueous mixture of 112.3 g water and 0.71 g sodium alkylbenzene sulfonate. The emulsion is allowed to stir for an additional 60 minutes, after which the reactor is cooled to room temperature and the core/shell latex is removed.

Saponification of the core/shell latex: A high-pressure reactor is charged with 45 g water, 100 g of the core/shell latex, 0.6 g sodium alkyl sulfonate, and 0.9 g sodium hydroxide. The mixture is heated at 140° C. for 10-14 hours.

### Example 63

### Prophetic—Synthesis of particles with poly(of α-methylene-γ-valerolactone) core and polystyrene shell

Similar to Example 62, except α-methylene-γ-valerolactone is used in place of α-methylene-γ-butyrolactone.

### Example 64

### Synthesis of poly(α-methylene-γ-butyrolactone-2-vinylpyridine) copolymer

To a dry 500 mL round bottom flask with a magnetic stir bar was added 1 g (3.28×10⁻³ mol) sodium oleate and 71.43 g (3.96 mol) water. The reaction is heated to 60° C. while stirring under nitrogen. After 10 minutes at 60° C., a monomer mixture consisting of 22.86 g (0.217 mol) 2-vinylpyridine and 21.33 g (0.217 mol α-methylene-γ-butyrolactone, as well as an aqueous mixture consisting of 1.14 g (3.74×10⁻³ mol) sodium oleate, 0.36 g (9.00×10⁻³ mol) NaOH, 0.36 g (1.51×10⁻³ mol) sodium persulfate, and 142.86 g (7.93 mol) water are added over 210 minutes. The polymerization is allowed to stir at 60° C. for an additional 90 minutes before cooling to room temperature and drying under vacuum for isolation.

The resulting polymer can be saponified as described above.

### Example 65

### Prophetic—Synthesis of poly(α-methylene-γ-valerolactone-2-vinylpyridine) copolymer

Similar to Example 64, except α-methylene-γ-valerolactone is used in place of α-methylene-γ-butyrolactone.

The resulting polymer can be saponified as described above.

### Example 66

### Prophetic—Synthesis of poly(α-methylene-γ-butyrolactone-hydroxyethyl methacrylate-4-vinyl benzoic acid) copolymer

To a 250 mL round bottom flask equipped with a magnetic stir bar is added 50 g (2.78 mol) water and 1.67 g of the surfactant Abex EP-110 (Rhodia). The mixture is heated under flowing nitrogen to 75° C., at which time a monomer mixture consisting of 14.70 g (1.50×10⁻¹ mol) α-methylene-γ-butyrolactone, 19.55 g (1.50×10⁻¹ mol) hydroxyethyl methacrylate, and 1.71 g (1.16×10⁻² mol) 4-vinyl benzoic acid is added via syringe pump over 180 minutes at reflux. After 10 minutes of monomer mixture addition, an aqueous mixture consisting of 16.667 g (0.925 mol) water, 0.12 g (5.04×10⁻⁴ mol) sodium persulfate, is added via syringe pump over 180 minutes at reflux. After both the monomer and aqueous mixtures are completely added, the emulsion is allowed to stir for an additional 60 minutes, after which the reaction is allowed to cool to room temperature and dried under vacuum at elevated temperature for isolation.

The resulting polymer can be saponified as described above.

### Example 67

### Prophetic—Synthesis of poly(α-methylene-γ-valerolactone-hydroxyethyl methacrylate-4-vinyl benzoic acid) copolymer

Similar to Example 66, except α-methylene-γ-valerolactone is used in place of α-methylene-γ-butyrolactone.

The resulting polymer can be saponified as described above.

### Example 68

### Prophetic—Synthesis of poly(α-methylene-γ-butyrolactone-N-vinyl pyrrolidone-methacrylic acid) copolymer

To a 100 mL flask with stirring is added 15.1 g (0.838 mol) water, 0.3 wt. % of a phosphate ester acid surfactant at pH=6.5 (Gafac RE-410 by GAF Corporation, for example), 0.08 g (8,87×10⁻⁴ mol) t-butyl mercaptan, 0.02 g (1.41×10⁻⁴ mol) disodium pyrophosphate, 0.01 g (4.02×10⁻⁵ mol) sodium persulfate, 0.01 wt. % metal complexing agent (such as picolinic acid), 9.1 g (9.28×10⁻² mol) α-methylene-γ-butyrolactone, 0.5 g (4.50×10⁻³ mol) N-vinyl pyrrolidone, and 0.3 g (3.49×10⁻³ mol) methacrylic acid. The flask is sealed and heated at 65° C. for 12 hours before cooling and drying under vacuum for isolation.

The resulting polymer can be saponified as described above.

### Example 69

### Prophetic—Synthesis of poly(α-methylene-γ-valerolactone-N-vinyl pyrrolidone-methacrylic acid) copolymer

Similar to Example 66, except α-methylene-γ-valerolactone is used in place of α-methylene-γ-butyrolactone.

The resulting polymer can be saponified as described above.

### Example 70

### Synthesis of poly(α-methylene-γ-valerolactone-divinyl benzene) copolymer

To a dry 100 mL round bottom flask equipped with a magnetic stir bar was charged 1.0153 g (8.98×10⁻³ mol) α-methylene-γ-valerolactone, 16.78 g (0.215 mol) benzene, 0.0561 g (4.31×10⁻⁴ mol) divinyl benzene, and 0.0067 g (4.08×10⁻⁵ mol) azobisisobutylnitrile. The reactor was purged with nitrogen for 30 minutes before heating to 65° C. The reactor was held at 65° C. for 5 hours before letting cooling the reaction mixture to room temperature and drying under vacuum.

The resulting polymer can be saponified as described above.

### Example 71

### Prophetic-Ring opening of poly(α-methylene-γ-butyrolactone-styrene) copolymer

To a scintillation vial is charged 0.200 g of a poly(α-methylene-γ-butyrolactone-styrene) copolymer akin to Example 46, along with approximately 0.5 g of a 20% aqueous caustic solution. The vial is capped and placed in a 100° C. oven until the solution turns from milky to clear. Once the solution turns clear the reaction is allowed an additional 60 minutes at elevated temperature before being removed from the oven. The degree of ring opening is expected to be greater than 50% with respect to the number of lactone rings in the copolymer.

### Example 72

### Formation of a clear film of poly(methylene-butyrolactone-n-butyl acrylate) copolymer

To a scintillation vial was charged 0.020 g of the poly(methylene-butyrolactone-n-butyl acrylate) copolymer prepared in Example 43 and 2.00 mL DMSO. The vial was capped and agitated on a platform shaker until the polymer had dissolved, at which time the solution was placed on a clean stainless steel coupon coated with aluminum foil and placed in a vacuum oven at 100° C. for 30 minutes. After baking at reduced pressure, the coupon was removed and cooled to room temperature before the film was removed. A tough, optically clear film resulted.

As used herein, the terms “a” and “an” do not denote a limitation of quantity, but rather denote the presence of at least one of the referenced item. “Or” means “and/or.” Unless defined otherwise, technical and scientific terms used herein have the same meaning as is commonly understood by one of skill in the art to which this invention belongs. Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

“Crosslinked” as used herein refers to a covalent or bond that links one polymer or polymer chain to another polymer or polymer chain.

A “hydrocarbyl group” as used herein means a group having the specified number of carbon atoms and the appropriate valence in view of the number of substitutions shown in the structure. Hydrocarbyl groups contain at least carbon and hydrogen, and can optionally contain 1 or more (e.g., 1-8) heteroatoms selected from N, O, S, Si, P, or a combination thereof. Hydrocarbyl groups can be unsubstituted or substituted with one or more substituent groups up to the valence allowed by the hydrocarbyl group independently selected from a C1-30 alkyl, C2-30 alkenyl, C2-30 alkynyl, C6-30 aryl, C7-30 arylalkyl, C1-12 alkoxy, C1-30 heteroalkyl, C3-30 heteroarylalkyl, C3-30 cycloalkyl, C3-15 cycloalkenyl, C6-30 cycloalkynyl, C2-30 heterocycloalkyl, halogen (F, Cl, Br, or I), hydroxy, nitro, cyano, amino, azido, amidino, hydrazino, hydrazono, carbonyl, carbamyl, thiol, carboxy (C1-6alkyl) ester, carboxylic acid, carboxylic acid salt, sulfonic acid or a salt thereof, and phosphoric acid or a salt thereof.

“Alkyl” refers to a straight or branched chain saturated aliphatic hydrocarbyl group having the specified number of carbon atoms and the appropriate valence in view of the structure. “Alkenyl” refers to a straight or branched chain hydrocarbyl group that comprises at least one carbon-carbon double bond and the appropriate valence in view of the structure. “Cycloalkyl” refers to a groups having the indicated number of carbon atoms in the ring of the valence dictated by the structure, and that comprises one or more saturated and/or partially saturated rings in which all ring members are carbon, such as cyclopropyl, cyclobutyl, cyclopentyl, cyclohexyl, and cycloheptyl. “Cycloalkenyl” refers to a cycloalkyl group that is at least partially unsaturated. “Aryl” refers to a cyclic moiety having the appropriate valence in view of the structure, in which all ring members are carbon and at least one ring is a single bond or aromatic, the moiety having the specified number of carbon atoms. More than one ring can be present, and any additional rings can be independently aromatic, saturated or partially unsaturated, and can be fused, pendant, spirocyclic or a combination thereof.

“Alkoxy” refers to an alkyl moiety that is linked via an oxygen (i.e., —O-alkyl). Nonlimiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups. “Hetero” means a group or compound including at least one heteroatom (e.g., 1 to 4 heteroatoms) each independently N, O, S, Si, or P. (Meth)acryl is inclusive of both acryl and methacryl groups.

All references are incorporated herein in their entirety.

While this disclosure describes representative embodiments, it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the scope thereof. Therefore, it is intended that this disclosure not be limited to the particular embodiments disclosed as the best mode contemplated for carrying out this disclosure.

What is claimed is:

1. A poly(lactone) comprising units of formula I 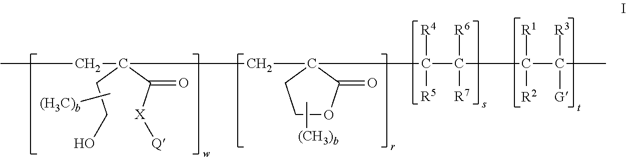
wherein
each b=0 or 1;
the molar ratio of w:r:s:t=(0-30):(99.9-2):(0-98):(0-30), wherein
w is the number of post-reacted and post-crosslinked α-methylene lactone repeat units, r is the number of α-methylene lactone repeat units, s is the number of comonomer repeat units, t is the number of crosslinked repeat units, and
w+s+t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I, at least one and no more than two of R⁴, R⁵, R⁶, and R⁷ are F, and F is the same or different in each instance;
Q′ is a C₁₋₃₀ hydrocarbyl group optionally containing a heteroatom wherein Q′ is covalently bonded to at least a second polymer backbones, wherein the second polymer backbone comprises units of formula I;
X is a nucleophile residue;
G′ is a single bond to an additional polymer backbone or G is a C₁₋₃₀ hydrocarbyl group crosslinked with one to five additional polymer backbones, wherein the additional polymer backbone comprises units of formula I;
when w>0, the total number of units (w+r+s+t) is 100 or greater,
when w=0 and t>0, the total number of units (r+s+t) is 5,000 or greater;
when w=0 and t=0, the total number of units is (r+s) is effective to provide a weight average molecular weight of 5,000 or greater.

2. The poly(lactone) of claim 1 having the formula I-a 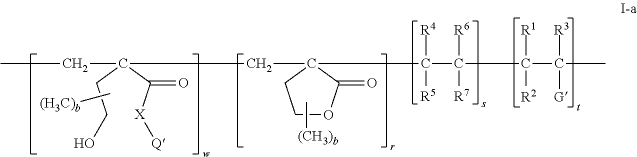
wherein
each b=0 or 1;
the molar ratio of the total of each of w:r:s:t=(0-30):(99.9-2):(0-98):(0.01-30), wherein w is the number of post-reacted α-methylene lactone repeat units, r is the number of α-methylene lactone repeat units, s is the number of comonomer repeat units, t is the number of crosslinked α-methylene lactone repeat units, provided that t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-a, at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones, wherein the additional polymer backbone comprises units of formula I-a;
G′ is a single bond to an additional polymer backbone or G′ is a C₁₋₃₀ hydrocarbyl group crosslinked with one to five additional polymer backbones, wherein the additional polymer backbone comprises units of formula I-a;
when w>0, the total number of units (w+r+s+t) is 100 or greater,
when w=0 and t>0, the total number of units (r+s+t) is 5,000 or greater;
when w=0 and t=0, the total number of units is (r+s) is effective to provide a weight average molecular weight of 500,000 g/mole or greater.

3. The poly(lactone) of claim 1 having the formula I-b 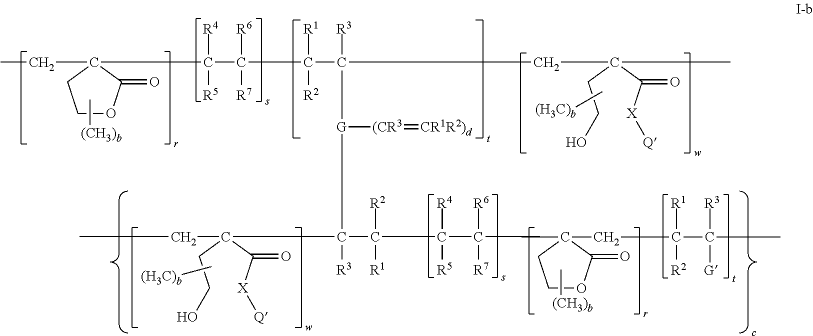
wherein
each b=0 or 1;
the molar ratio of the total of each of w:r:s:t=(0-30):(99.9-2):(0-98):(0.01-30), wherein
w is the number of post-reacted and post-crosslinked α-methylene lactone repeat units, r is the number of α-methylene lactone repeat units, s is the number of comonomer repeat units, and t is the number of crosslinked α-methylene lactone repeat units, and
each value of w, r, s, and t are independent of any other value of w, r, s, and t;
R¹, R², and R³ are each independently a hydrogen or C₁₋₄ alkyl;
R⁴, R⁵, R⁶, and R⁷ are each independently a hydrogen, C₁₋₄ alkyl or F, wherein F is a functional group that imparts a property to the poly(lactone) I-b and at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones;
G′ is a single bond to an additional polymer backbone or G′ is a C₁₋₃₀ hydrocarbyl group crosslinked with one to five additional polymer backbones;
G is a single bond or a C₁₋₃₀ hydrocarbyl group;
c=1-5 and d=0-5 provided that c+d=1-5, and
when w>0, the total number of units (w+r+s+t) is 100 or greater,
when w=0, the total number of units (r+s+t) is 5,000 or greater;

4. The poly(lactone) of claim 1 having the formula I-c 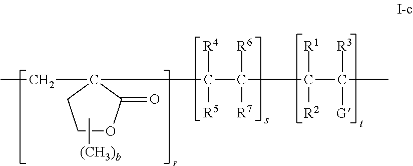
wherein
each b=0 or 1;
the molar ratio of r:s:t=(99.9-2):(0-98):(0-30), wherein r is the number of α-methylene lactone repeat units, s is the number of comonomer repeat units, t is the number of crosslinked repeat units, s+t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-c, at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones; and
the total number of units (r+s+t) is 5,000 or greater.

5. The poly(lactone) of claim 1 having the formula I-d 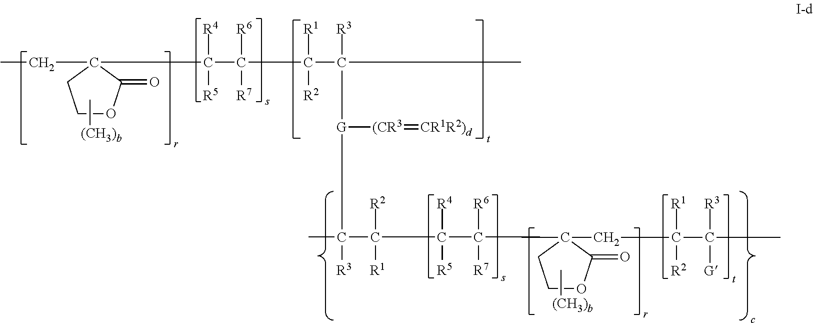
wherein
each b=0 or 1;
the molar ratio of the total of each of r:s:t=(99.9-2):(0-98):(0-30), wherein
r is the number of α-methylene lactone repeat units, s is the number of comonomer repeat units, t is the number of crosslinked repeat units, and s+t=at least 1, and
each value of r, s, and t are independent of any other value of r, s, and t;
R¹, R², and R³ are each independently a hydrogen or C₁₋₄ alkyl;
R⁴, R⁵, R⁶, and R⁷ are each independently a hydrogen, C₁₋₄ alkyl or F, wherein F is a functional group that imparts a property to the poly(lactone) I-d and at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones,
G is a single bond or a C₁₋₃₀ hydrocarbyl group;
when t>0, c=0-5 and d=0-5 provided that c+d=1-5; and
the total number of units (r+s+t) is 5,000 or greater.

6. The poly(lactone) of claim 1 having the formula I-e 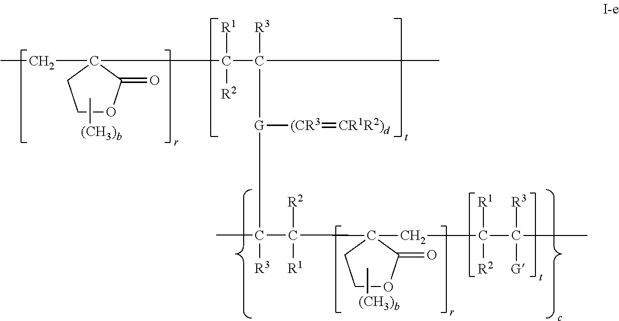
wherein
each b=0 or 1;
the molar ratio of the total of each r:t=(99.99-70):(0.01-30), wherein each value of r and t are independent of any other value of r and t and;
R¹, R², and R³ are each independently a hydrogen or C₁₋₄ alkyl;
G′ is a single bond to an additional polymer backbone or G′ is a C₁₋₃₀ hydrocarbyl group crosslinked with one to five additional polymer backbones,
G is a single bond or a C₁₋₃₀ hydrocarbyl group;
c=1-5 and d=0-4, provided that c+d=1-5.

7. The poly(lactone) of claim 1 having the formula I-f 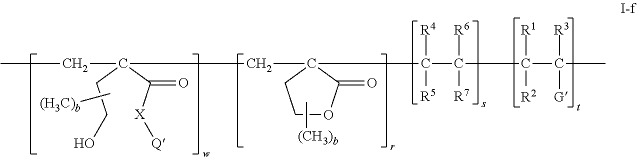
wherein
each b=0 or 1;
the molar ratio of the total of each of w:r:s:t=(0.01-30):(99.99-2):(0-98):(0-30), wherein
w is the mole fraction of post-reacted and post-crosslinked α-methylene lactone repeat units, r is the number of α-methylene lactone repeat units, s is the number of comonomer repeat units, and t is the number of crosslinked α-methylene lacto repeat units, and
each value of w, r, s, and t is independent of every other value of w, r s, and t;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-f, at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones;
Q′ is a C₁₋₃₀ hydrocarbyl group crosslinked with one to five additional polymer backbones, wherein the additional polymer backbone comprises units of formula I-f; and
the total number of units (w+r+s+t) is 5,000 or greater.

8. The poly(lactone) of claim 1 having the formula I-g 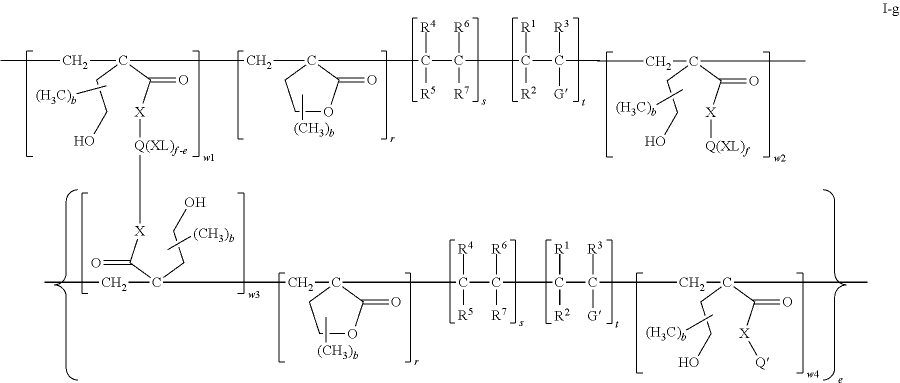
wherein
each b=0 or 1;
the molar ratio of the total of each of (w1+w2+w3+w4):r:s:t=(0.01-30):(99.99-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units,
t is the number of crosslinked repeat units, and
each value of w1, w2, w4, r, s, and t are independent of any other value of w1, w2, w4, r, s, and t, and; and
Q′ is a C₁₋₃₀ hydrocarbyl group post-reacted with a crosslinking group and optionally crosslinked with one to five additional polymer backbones, wherein the additional polymer backbone comprises units of formula I-g;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-g, at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones;
Q is a C₁₋₃₀ hydrocarbyl group, X is a nucleophile residue;
L is a leaving group;
f=1-5 and e=1-5 provided that e+1-5; and
the total number of units (w1+w2+w3+w4+r+s+t) is 100 or greater.

9. The poly(lactone) of claim 1 having the formula I-h 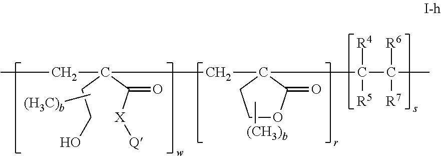
wherein
each b=0 or 1;
the molar ratio of w:r:s=(0.01-30):(99.99-2):(0-97.99), wherein w is the mole fraction of post-reacted and post-crosslinked α-methylene lactone repeat units, r is the number of α-methylene lactone repeat units, and s is the number of comonomer repeat units;
R⁴, R⁵, R⁶, and R⁷ are each independently a hydrogen, C₁₋₄ alkyl, or F, wherein F is a functional group that imparts a property to the poly(lactone) I-h, at least one and no more than two of R⁴, R⁵, R⁶, and R⁷ are F, and F is the same or different in each instance;
Q′ is a C₁₋₃₀ hydrocarbyl group crosslinked with one to five additional polymer backbones, wherein the additional polymer backbone comprises units of formula I-h;
the total number of units (w+r+s) is 100 or greater.

10. The poly(lactone) of claim 1 having the formula I-i 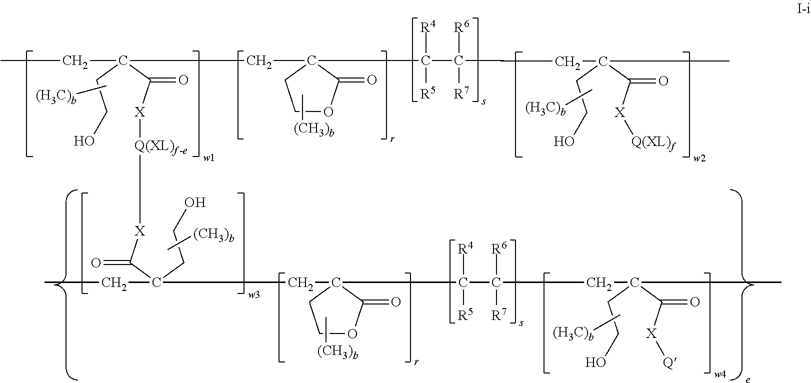
wherein
each b=0 or 1;
the molar ratio of the total of each of (w1+w2+w3+w4):r:s:t=(0.01-30):(99.9-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units, and
each value of w1, w2, w4, r, s, and t are independent of any other value of w1, w2, w4, r, s, and t;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-i, at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones;
Q is a C₁₋₃₀ hydrocarbyl group crosslinked with one to five additional polymer backbones,
X is a nucleophile residue;
L is a leaving group;
f=1-5 and e=1-5 provided that e+1-5; and
the total number of units (w1+w2+w3+w4+r+s) is 100 or greater;

11. The poly(lactone) of claim 1 having the formula I-j 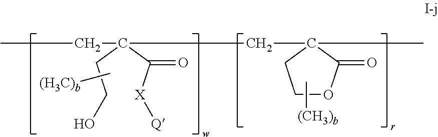
wherein
each b=0 or 1;
the molar ratio of w:r=(0.01-30):(99.99-70), wherein w is the mole fraction of post-reacted and post-crosslinked α-methylene lactone repeat units and r is the number of α-methylene lactone repeat units;
X is a nucleophile residue;
Q′ is a C₁₋₃₀ hydrocarbyl group post-reacted with a crosslinking group wherein at least one Q′ is crosslinked with one to five additional polymer backbones; and
the total number of units (w+r) is 100 or greater.

12. The poly(lactone) of claim 1 having the formula I-k 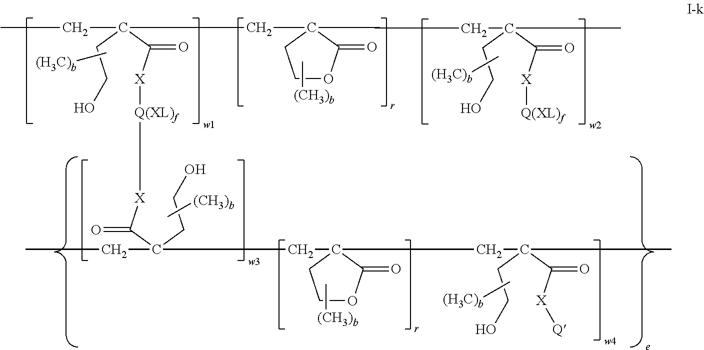
wherein
each b=0 or 1;
the molar ratio of the total of each of (w1+w2+w3+w4):r=(0.01-30):(99.9-70) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones, and
r is the number of α-methylene lactone repeat units;
each value of w1, w2, w4, and r are independent of any other value of w1, w2, w4, r, s, and t;
Q′ is a C₁₋₃₀ hydrocarbyl group post-reacted with a crosslinking group and optionally crosslinked with one to five additional polymer backbones;
Q is a C₁₋₃₀ hydrocarbyl group crosslinked with one to five additional polymer backbones,
X is a nucleophile residue;
L is a leaving group;
f=1-5 and e=1-5 provided that e+1-5; and
the total number of units (w1+w2+w3+w4+r) is 100 or greater.

13. The poly(lactone) of claim 1 having the formula I-m 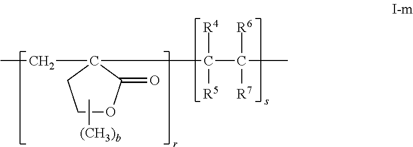
wherein
each b=0 or 1;
the molar ratio of r:s=(99.99-2):(0.01-98);
R⁴, R⁵, R⁶, and R⁷ are each independently a hydrogen, C₁₋₄ alkyl or F, wherein at least one and no more than two of R⁴, R⁵, R⁶ and R⁷ are F and F is the same or different in each instance; and
r and s are integers effective to provide a polymer having a weight average molecular weight of at least 500,000 g/mol.

14. The poly(lactone) of claim 1 having the formula I-n 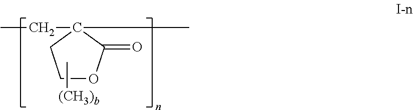
wherein each b=0 or 1 and n is a number effective to provide a molecular weight of at least 500,000 g/mol.

15. (canceled)

16. The poly(lactone) of claim 1, wherein the methyl group is located gamma to the carbonyl group.

17. The poly(lactone) of claim 1, wherein R⁴ and R⁵ are hydrogen, R⁶ is methyl or hydrogen, and R⁷ is carboxylic acid.

18. The poly(lactone) of claim 1, wherein c=1-4.

19. (canceled)

20. (canceled)

21. The poly(lactone) of claim 1, wherein G is a single bond or a C₁₋₁₂ alkyl substituted with 0-6 (C₁₋₆)alkoxycarbonyl groups, 0-6 oxycarbonyl groups, 0-6 aminocarbonyl groups, or a combination comprising at least one of the foregoing, C₂₋₁₂ alkenyl substituted with 0-6 (C₁₋₆)alkoxycarbonyl groups, 0-6 oxycarbonyl groups, 0-6 aminocarbonyl groups, or a combination comprising at least one of the foregoing, C₂₋₁₂ alkynyl substituted with 0-6 (C₁₋₆)alkoxycarbonyl groups, 0-6 oxycarbonyl groups, 0-6 aminocarbonyl groups, or a combination comprising at least one of the foregoing, C₃₋₈ cycloalkyl substituted with 0-4 (C₁₋₆)alkoxycarbonyl groups, 0-4 oxycarbonyl groups, 0-4 aminocarbonyl groups, or a combination comprising at least one of the foregoing, C₃₋₈ heterocycloalkyl substituted with 0-4 (C₁₋₆)alkoxycarbonyl groups, 0-4 oxycarbonyl groups, 0-4 aminocarbonyl groups, or a combination comprising at least one of the foregoing, C₆₋₁₂ aryl substituted with 0-6 (C₁₋₆)alkoxycarbonyl groups, 0-6 oxycarbonyl groups, 0-6 aminocarbonyl groups, or a combination comprising at least one of the foregoing, C₄₋₁₂ heteroaryl substituted with 0-4 (C₁₋₆)alkoxycarbonyl groups, 0-4 oxycarbonyl groups, 0-4 aminocarbonyl groups, or a combination comprising at least one of the foregoing, C₂₋₂₄ (C₁₋₄ alkyloxy)ₑ(C₁₋₄ alkyl)) groups wherein e=1-16 substituted with 0-6 oxycarbonyl groups, 0-6 aminocarbonyl groups, or a combination comprising at least one of the foregoing.

22. The poly(lactone) of claim 1 further comprising a crosslink between two F groups, wherein the crosslink is the crosslink residue of a diol or higher polyol, a diisocyanate or higher isocyanate, a diamine or higher amine, a diacid or higher acid, the C₁₋₃alkyl esters thereof, or the acid halide thereof, a diepoxide or higher epoxide, an alcohol-amine, a compound having two or more ethylenic unsaturations, a polyvalent ion, or a combination comprising at least one of the forgoing crosslinkers.

23. (canceled)

24. A method of preparing a poly(lactone) of claim 1, the method comprising
polymerizing an ethylenically unsaturated monomer of formula II, 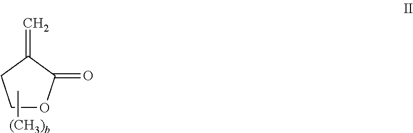
wherein each b=0 or 1, optionally with
a crosslinking monomer of formula III, a comonomer of formula IV, or a combination comprising one or both of crosslinking monomer III and comonomer IV, 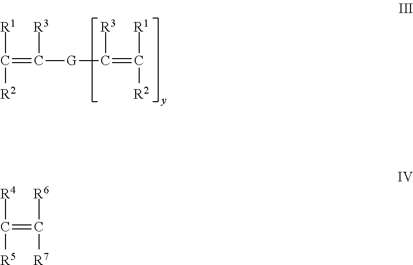
wherein
R¹, R², and R³ are each independently hydrogen or C₁₋₄alkyl;
G is a single bond or a C₁₋₃₀ hydrocarbyl group; and
y=1-5; and
R⁴, R⁵, R⁶ and R⁷ are each independently a hydrogen, C₁₋₄ alkyl or F, wherein F is a functional group that imparts a property to the poly(lactone), and at least one and no more than two of R⁴, R⁵, R⁶ and R⁷ are F, and F is the same or different in each instance, to form an optionally crosslinked polymer; and
optionally, crosslinking the optionally crosslinked polymer with a crosslinking agent, a post-crosslinking monomer of formula V, or a combination thereof
[LX]-Q-[XL]_{z} V
wherein
Q is a C₁₋₃₀ hydrocarbyl group;
X is a nucleophile reactive with a lactone group;
L is a leaving group; and
z=1-5.

25. The method of claim 24, wherein the crosslinking monomer III is an N,N′—(C₁₋₁₂ alkyl)bis(meth)acrylamide, a di-, tri-, tetra-, penta-, or hexa(meth)acrylic ester of a C₁₋₁₂ polyol, a di-, tri-, tetra-, penta- or hexa(meth)acrylic ester of a C₁₋₂₄ alkyleneoxide polyol, a mono-, di-, tri-, tetra-, or higher polyester of a mono- di-, tri-, tetra-, or higher carboxylic acid having 2-6 terminal unsaturations, a di-, tri-, tetra-, penta-, or hexa(meth)allyl(C₁₋₁₂ alkane), and di-, tri-, and tetravinyl substituted C₆₋₁₂ aryl compounds.

26. The method claim 24, wherein the crosslinking monomer III is an N,N′-methylenebis(meth)acrylamide, 1,2-, 1,3-, and 1,4-butanediol di(meth)acrylate, ethyleneglycol di(meth)acrylate, propylene glycol di(meth)acrylate, diethyleneglycol di(meth)acrylate, triethyleneglycol di(meth)acrylate, polyethyleneoxide glycol di(meth)acrylate, dipropyleneglycol di(meth)acrylate, triethyleneglycol di(meth)acrylate, glycerol di(meth)acrylate, glycerol tri(meth)acrylate, 1,2- and 1,3-propanediol di(meth)acrylate, 1,2-, 1,3-, 1,4, 1,5- and 1,6-hexanediol di(meth)acrylate, 1,2- and 1,3-cyclohexanediol di(meth)acrylate, pentaerythritol di(meth)acrylate, pentaerythritol tri(meth)acrylate, pentaerythritol tetra(meth)acrylate, trimethylolpropane tri(meth)acrylate, ethoxylated trimethylolpropane tri(meth)acrylate, tris(2-hydroxyethyl) isocyanurate triacrylate, triallyl isocyanurate, allyl(meth)acrylate, pentaerythritol diallyl ether, pentaerythritol triallyl ether, pentaerythritol tetraallyl ether, diallyl ether, tetrallyloxyethane, tetrallyloxypropane, tetrallyloxybutane, divinylbenzene, divinyltoluene, divinyl xylene, trivinyl benzene, and divinyl ether.

27. The method of claim 24, wherein the comonomer IV is acrylic acid, methacrylic acid, fumaric acid, itaconic acid, maleic acid, maleic anhydride, maleimide, itaconic anhydride, styrene, n-butyl acrylate, N,N-dimethyl acrylamide, octadecyl acrylate, p-styrene sulfonate, butadiene, 2-vinylpyridine, 4-vinyl benzoic acid, N-vinyl pyrrolidone, methacrylic acid, divinyl benzene, butadiene, or a combination comprising at least one of the foregoing.

28. The method of claim 24, wherein the crosslinking agent is a compound having two or more ethylenic unsaturations, a diol or higher polyol, a diisocyanate or higher isocyanate, a diamine or higher amine, a dicarboxylic acid or higher carboxylic acid, the C₁₋₃alkyl esters thereof, or the acid halide thereof, a polyvalent ion, an alcohol-amine, or a combination comprising at least one of the forgoing crosslinking agents.

29. The method of claim 24, wherein the post-crosslinking monomer of formula V is a diol, triol, tetrol, pentol, or hexol; a diamine, triamine, tetramine, pentamines, or hexamine, or a combination comprising at least one of the forgoing the post-crosslinking monomers.

30. A coating composition comprising
a polymer binder;
an aqueous phase; and
the poly(lactone) of claim 1.

31. A method of preparing the coating composition of claim 30, comprising:
combining the polymer binder, the poly(lactone) of claim 1, and an aqueous phase.

32. A coated substrate, comprising:
a substrate having a surface; and
a coating disposed on the surface, wherein the coating comprises
a polymer binder;
optionally a pigment or a dye; and
the poly(lactone) of claim 1.

33. (canceled)

34. A method of coating a substrate, comprising:
contacting a coating composition comprising
a polymer binder,
an aqueous phase,
optionally a pigment or a dye; and
the poly(lactone) of claim 1 with a surface of the substrate to form a coating; and
drying the coating.

35. A poly(lactone) comprising units of formula I 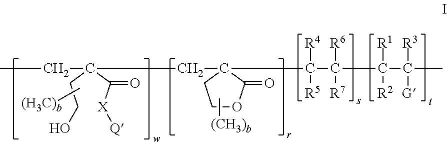
wherein
each b=0 or 1;
the molar ratio of w:r:s:t=(0-30):(99.9-2):(0-98):(0-30), wherein
w is the number of post-reacted and post-crosslinked α-methylene lactone repeat units, r is the number of α-methylene lactone repeat units, s is the number of comonomer repeat units, t is the number of crosslinked repeat units, and
w+s+t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I, at least one and no more than two of R⁴, R⁵, R⁶, and R⁷ are F, and F is the same or different in each instance;
Q′ is a C₁₋₃₀ hydrocarbyl group wherein Q′ is covalently bonded to at least a second polymer backbones, wherein the second polymer backbone comprises units of formula I;
X is N, 0, P or S
G′ is a single bond to an additional polymer backbone or G is a C₁₋₃₀ hydrocarbyl group crosslinked with one to five additional polymer backbones, wherein the additional polymer backbone comprises units of formula I;
when w>0, the ratio of (w+r):t is greater than 100:1;
when w=0 and t>0, the ratio of r:t is greater than 5000:1;
when w=0 and t=0, the total of (r+s) is effective to provide a weight average molecular weight of 500,000 g/mol or greater.

36. The poly(lactone) of claim 35 having the formula I-a 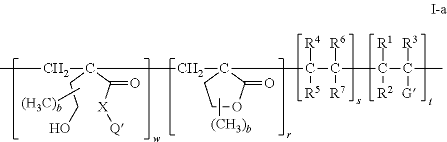
wherein
each b=0 or 1;
the molar ratio of the total of each of w:r:s:t=(0-30):(99.9-2):(0-98):(0.01-30), wherein w is the number of post-reacted α-methylene lactone repeat units, r is the number of α-methylene lactone repeat units, s is the number of comonomer repeat units, t is the number of crosslinked α-methylene lactone repeat units, provided that t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-a, at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones, wherein the additional polymer backbone comprises units of formula I-a;
G′ is a single bond to an additional polymer backbone or G′ is a C₁₋₃₀ hydrocarbyl group crosslinked with one to five additional polymer backbones, wherein the additional polymer backbone comprises units of formula I-a;
when w>0, the ratio of (w+r):t is greater than 100:1 when w=0 and t>0, the ratio of r:t is greater than 5000:1.

37. The poly(lactone) of claim 35 having the formula I-b 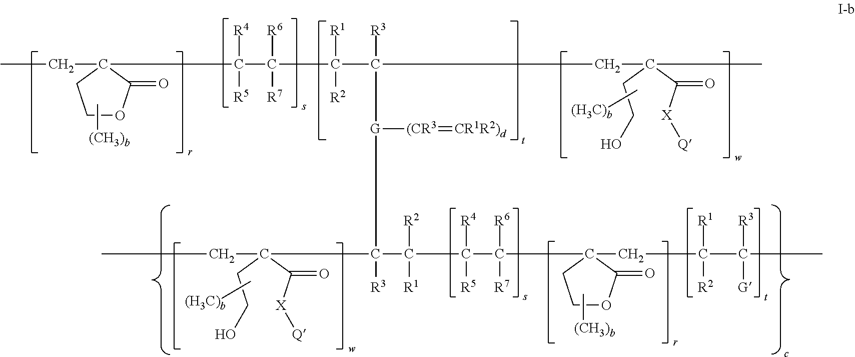
wherein
each b=0 or 1;
the molar ratio of the total of each of w:r:s:t=(0-30):(99.9-2):(0-98):(0.01-30), wherein
w is the number of post-reacted and post-crosslinked α-methylene lactone repeat units, r is the number of α-methylene lactone repeat units, s is the number of comonomer repeat units, and t is the number of crosslinked α-methylene lactone repeat units, and
each value of w, r, s, and t are independent of any other value of w, r, s, and t;
R¹, R², and R³ are each independently a hydrogen or C₁₋₄ alkyl;
R⁴, R⁵, R⁶, and R⁷ are each independently a hydrogen, C₁₋₄ alkyl or F, wherein F is a functional group that imparts a property to the poly(lactone) I-b and at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones;
G′ is a single bond to an additional polymer backbone or G is a C₁₋₃₀ hydrocarbyl group crosslinked with one to five additional polymer backbones;
G is a single bond or a C₁₋₃₀ hydrocarbyl group;
c=1-5 and d=0-5 provided that c+d=1-5, and
when w>0, the ratio of (w+r):t is greater than 100:1
when w=0 and t>0, the ratio of r:t is greater than 5000:1.

38. The poly(lactone) of claim 35 having the formula I-c 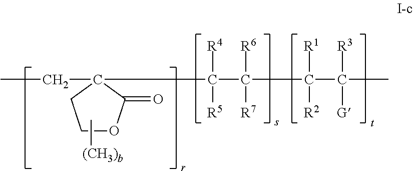
wherein
each b=0 or 1;
the molar ratio of r:s:t=(99.9-2):(0-98):(0-30), wherein r is the number of α-methylene lactone repeat units, s is the number of comonomer repeat units, t is the number of crosslinked repeat units, s+t is at least 1;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-c, at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones,
when t>0, the ratio of r:t is greater than 5000:1; and
when t=0, the total of (r+s) is effective to provide a weight average molecular weight of 500,000 g/mol or greater.

39. The poly(lactone) of claim 35 having the formula I-d 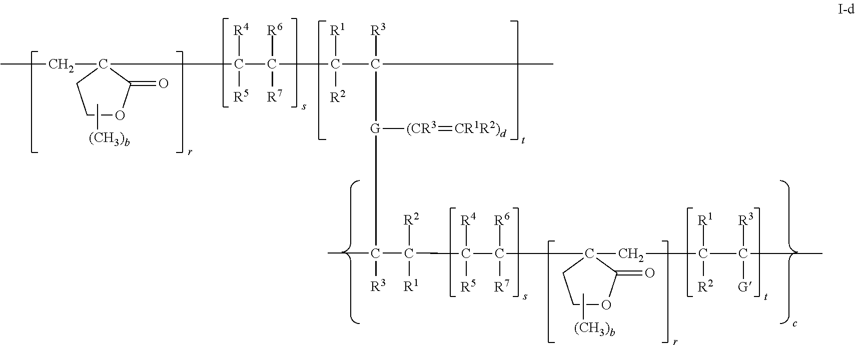
wherein
each b=0 or 1;
the molar ratio of the total of each of r:s:t=(99.9-2):(0-98):(0-30), wherein
r is the number of α-methylene lactone repeat units, s is the number of comonomer repeat units, t is the number of crosslinked repeat units, and s+t=at least 1, and
each value of r, s, and t are independent of any other value of r, s, and t;
R¹, R², and R³ are each independently a hydrogen or C₁₋₄ alkyl;
R⁴, R⁵, R⁶, and R⁷ are each independently a hydrogen, C₁₋₄ alkyl or F, wherein F is a functional group that imparts a property to the poly(lactone) I-d and at least one and no more than two of R⁴, R⁵, R⁶, and R⁷ are F, and F is the same or different in each instance;
G is a single bond or a C₁₋₃₀ hydrocarbyl group;
when t>0,
c=0-5 and d=0-5 provided that c+d=1-5, and
the ratio of r:t is greater than 5000:1; and
when t=0, the total of (r+s) is effective to provide a weight average molecular weight of 500,000 g/mol or greater.

40. The poly(lactone) of claim 35 having the formula I-e 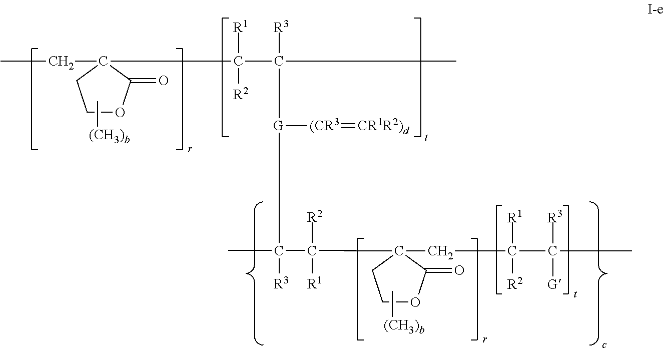
wherein
each b=0 or 1;
the molar ratio of the total of each r:t=(99.99-70):(0.01-30), wherein each value of r and t are independent of any other value of r and t and;
R¹, R², and R³ are each independently a hydrogen or C₁₋₄ alkyl;
G is a single bond or a C₁₋₃₀ hydrocarbyl group;
c=1-5 and d=0-4, provided that c+d=1-5
when t>0,
c=0-5 and d=0-5 provided that c+d=1-5, and
the ratio of r:t is greater than 5000:1; and
when t=0, the total of (r+s) is effective to provide a weight average molecular weight of 500,000 g/mol or greater.

41. The poly(lactone) of claim 35 having the formula I-f 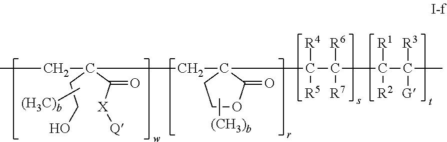
wherein
each b=0 or 1;
the molar ratio of the total of each of w:r:s:t=(0.01-30):(99.99-2):(0-98):(0-30), wherein
w is the mole fraction of post-reacted and post-crosslinked α-methylene lactone repeat units, r is the number of α-methylene lactone repeat units, s is the number of comonomer repeat units, and t is the number of crosslinked α-methylene lacto repeat units, and
each value of w, r, s, and t is independent of every other value of w, r s, and t;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-f, at least one and no more than two of R⁴, R⁵, R⁶, and R⁷ are F, and F is the same or different in each instance;
G′ is a single bond to an additional polymer backbone or G is a C₁₋₃₀ hydrocarbyl group crosslinked with one to five additional polymer backbones;
Q′ is a C₁₋₃₀ hydrocarbyl group crosslinked with one to five additional polymer backbones, wherein the additional polymer backbone comprises units of formula I-f;
when t>0, the ratio of (w+r):t is greater than 100:1; and
when t=0, the total of (w1+w2+w3+w4+r+s) is effective to provide a weight average molecular weight of 10,000 g/mol or greater prior to cross-linking.

42. The poly(lactone) of claim 1 having the formula I-g 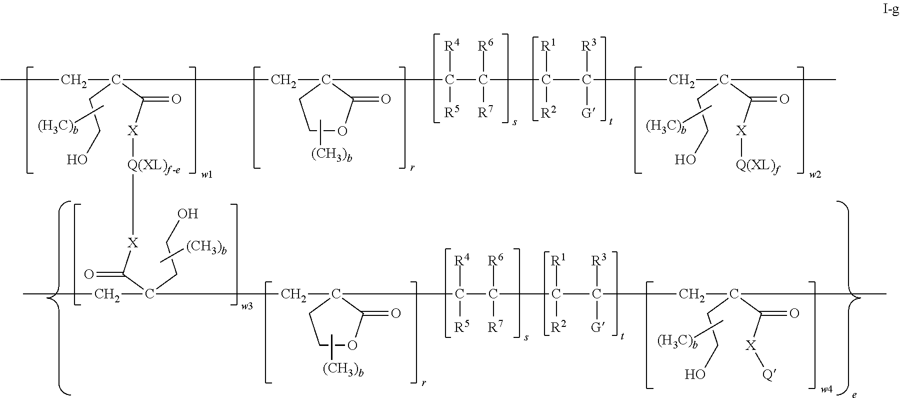
wherein
each b=0 or 1;
the molar ratio of the total of each of (w1+w2+w3+w4):r:s:t=(0.01-30):(99.99-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units,
t is the number of crosslinked repeat units, and
each value of w1, w2, w4, r, s, and t are independent of any other value of w1, w2, w4, r, s, and t, and; and
Q′ is a C₁₋₃₀ hydrocarbyl group post-reacted with a crosslinking group and optionally crosslinked with one to five additional polymer backbones, wherein the additional polymer backbone comprises units of formula I-g;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-g, at least one and no more than two of R⁴, R⁵, R⁶, and R⁷ are F, and F is the same or different in each instance;
G′ is a single bond to an additional polymer backbone or G′ is a C₁₋₃₀ hydrocarbyl group crosslinked with one to five additional polymer backbones;
Q is a C₁₋₃₀ hydrocarbyl group, X is a nucleophile residue;
L is a leaving group;
f=1-5 and e=1-5 provided that e+1-5;
when t>0, the ratio of (w1+w2+w3+w4+r):t is greater than 100:1; and
when t=0, the total of (w1+w2+w3+w4+r+s) is effective to provide a weight average molecular weight of 10,000 g/mol or greater prior to cross-linking.

43. The poly(lactone) of claim 35 having the formula I-h 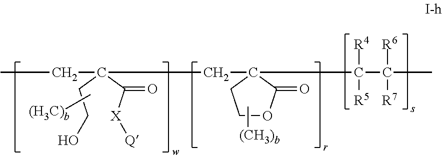
wherein
each b=0 or 1;
the molar ratio of w:r:s=(0.01-30):(99.99-2):(0-97.99), wherein w is the mole fraction of post-reacted and post-crosslinked α-methylene lactone repeat units, r is the number of α-methylene lactone repeat units, and s is the number of comonomer repeat units;
R⁴, R⁵, R⁶, and R⁷ are each independently a hydrogen, C₁₋₄ alkyl, or F, wherein F is a functional group that imparts a property to the poly(lactone) I-h, at least one and no more than two of R⁴, R⁵, R⁶, and R⁷ are F, and F is the same or different in each instance;
Q′ is a C₁₋₃₀ hydrocarbyl group crosslinked with one to five additional polymer backbones, wherein the additional polymer backbone comprises units of formula I-h;
when w>0, the total of (w+r+s) is effective to provide a weight average molecular weight of 10,000 g/mol or greater prior to cross-linking.

44. The poly(lactone) of claim 35 having the formula I-i 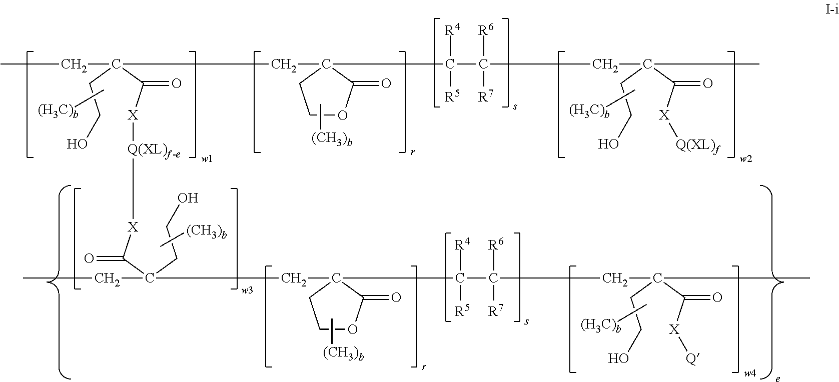
wherein
each b=0 or 1;
the molar ratio of the total of each of (w1+w2+w3+w4):r:s:t=(0.01-30):(99.9-2):(0-98):(0-30) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones,
r is the number of α-methylene lactone repeat units,
s is the number of comonomer repeat units, and
each value of w1, w2, w4, r, s, and t are independent of any other value of w1, w2, w4, r, s, and t;
R¹, R², and R³ are each independently a hydrogen or C₁₋₄ alkyl;
R⁴, R⁵, R⁶, and R⁷ are each independently a hydrogen, C₁₋₄ alkyl, or F, wherein F is a functional group that imparts a property to the poly(lactone) I-i, at least one and no more than two of R⁴, R⁵, R⁶, and R⁷ are F, and F is the same or different in each instance;
Q′ is a C₁₋₃₀ hydrocarbyl group post-reacted with a crosslinking group and optionally crosslinked with one to five additional polymer backbones;
Q is a C₁₋₃₀ hydrocarbyl group crosslinked with one to five additional polymer backbones,
X is a nucleophile residue;
L is a leaving group;
f=1-5 and e=1-5 provided that e+1-5; and
the total of (w1+w2+w3+w4+r+s) is effective to provide a weight average molecular weight of 10,000 g/mol or greater prior to cross-linking;

45. The poly(lactone) of claim 35 having the formula I-j 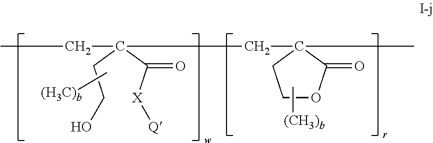
wherein
each b=0 or 1;
the molar ratio of w:r=(0.01-30):(99.99-70), wherein w is the mole fraction of post-reacted and post-crosslinked α-methylene lactone repeat units and r is the number of α-methylene lactone repeat units;
Q′ is a C₁₋₃₀ hydrocarbyl group post-reacted with a crosslinking group wherein at least one Q′ is crosslinked with one to five additional polymer backbones; and
the total of (w+r) is effective to provide a weight average molecular weight of 10,000 g/mol or greater prior to cross-linking.

46. The poly(lactone) of claim 35 having the formula I-k 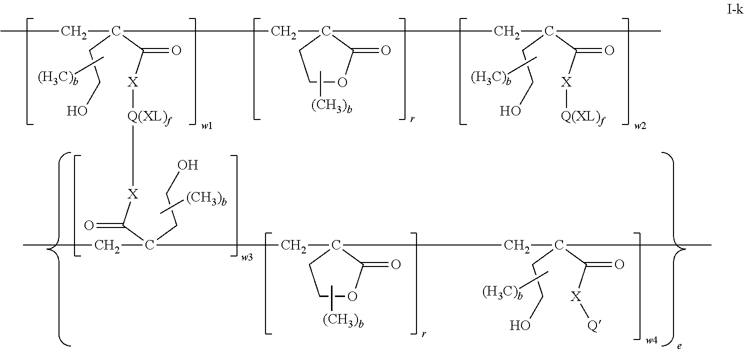
wherein
each b=0 or 1;
the molar ratio of the total of each of (w1+w2+w3+w4):r=(0.01-30):(99.9-70) wherein
(w1+w2+w3+w4) is the number of post-reacted and post-crosslinked α-methylene lactone repeat units, wherein w1 is the number of post-crosslinked α-methylene lactone repeat units in a first polymer backbone and is at least 1, w2 is the number of post-reacted, uncrosslinked α-methylene lactone repeat units in the first polymer backbone, w3=1, and w4 is the number of α-methylene lactone repeat units in an additional polymer backbone post-reacted with a crosslinking group and optionally crosslinked with one to five additional polymer backbones, and
r is the number of α-methylene lactone repeat units;
each value of w1, w2, w4, and r are independent of any other value of w1, w2, w4, r, s, and t;
Q′ is a C₁₋₃₀ hydrocarbyl group post-reacted with a crosslinking group and optionally crosslinked with one to five additional polymer backbones;
Q is a C₁₋₃₀ hydrocarbyl group crosslinked with one to five additional polymer backbones,
X is a nucleophile residue;
L is a leaving group;
f=1-5 and e=1-5 provided that e+1-5; and
the total of (w1+w2+w3+w4+r) is effective to provide a weight average molecular weight of 10,000 g/mol or greater prior to cross-linking.

47. The poly(lactone) of claim 35, wherein the methyl group is located gamma to the carbonyl group.

48. The poly(lactone) of claim 35, wherein R⁴ and R⁵ are hydrogen, R⁶ is methyl or hydrogen, and R⁷ is carboxylic acid.

49. The poly(lactone) of claim 35, wherein c=1-4.

50. (canceled)

51. (canceled)

52. The poly(lactone) of claim 35, wherein G is a single bond or a C₁₋₁₂ alkyl substituted with 0-6 (C₁₋₆)alkoxycarbonyl groups, 0-6 oxycarbonyl groups, 0-6 aminocarbonyl groups, or a combination comprising at least one of the foregoing, C₂₋₁₂ alkenyl substituted with 0-6 (C₁₋₆)alkoxycarbonyl groups, 0-6 oxycarbonyl groups, 0-6 aminocarbonyl groups, or a combination comprising at least one of the foregoing, C₂₋₁₂ alkynyl substituted with 0-6 (C₁₋₆)alkoxycarbonyl groups, 0-6 oxycarbonyl groups, 0-6 aminocarbonyl groups, or a combination comprising at least one of the foregoing, C₃₋₈ cycloalkyl substituted with 0-4 (C₁₋₆)alkoxycarbonyl groups, 0-4 oxycarbonyl groups, 0-4 aminocarbonyl groups, or a combination comprising at least one of the foregoing, C₃₋₈ heterocycloalkyl substituted with 0-4 (C₁₋₆)alkoxycarbonyl groups, 0-4 oxycarbonyl groups, 0-4 aminocarbonyl groups, or a combination comprising at least one of the foregoing, C₆₋₁₂ aryl substituted with 0-6 (C₁₋₆)alkoxycarbonyl groups, 0-6 oxycarbonyl groups, 0-6 aminocarbonyl groups, or a combination comprising at least one of the foregoing, C₄₋₁₂ heteroaryl substituted with 0-4 (C₁₋₆)alkoxycarbonyl groups, 0-4 oxycarbonyl groups, 0-4 aminocarbonyl groups, or a combination comprising at least one of the foregoing, C₂₋₂₄ (C₁₋₄ alkyloxy)ₑ(C₁₋₄ alkyl)) groups wherein e=1-16 substituted with 0-6 oxycarbonyl groups, 0-6 aminocarbonyl groups, or a combination comprising at least one of the foregoing.

53. The poly(lactone) of claim 35 further comprising a crosslink between two F groups, wherein the wherein the crosslink is the crosslink residue of a diol or higher polyol, a diisocyanate or higher isocyanate, a diamine or higher amine, a diacid or higher acid, the C₁₋₃alkyl esters thereof, or the acid halide thereof, a diepoxide or higher epoxide, an alcohol-amine, a compound having two or more ethylenic unsaturations, a polyvalent ion, or a combination comprising at least one of the forgoing crosslinkers.

54. (canceled)

55. A method of preparing a poly(lactone) of claim 35, the method comprising
polymerizing an ethylenically unsaturated monomer of formula II, 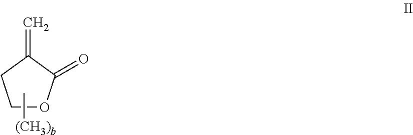
wherein each b=0 or 1, optionally with
a crosslinking monomer of formula III, a comonomer of formula IV, or a combination comprising one or both of crosslinking monomer III and comonomer IV, 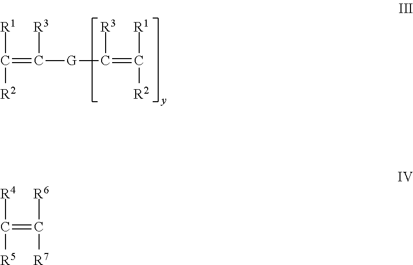
wherein
R¹, R², and R³ are each independently hydrogen or C₁₋₄alkyl;
G is a single bond or a C₁₋₃₀ hydrocarbyl group; and
y=1-5; and
R⁴, R⁵, R⁶ and R⁷ are each independently a hydrogen, C₁₋₄ alkyl or F, wherein F is a functional group that imparts a property to the poly(lactone), and at least one and no more than two of R⁴, R⁵, R⁶ and R⁷ are F, and F is the same or different in each instance, to form an optionally crosslinked polymer; and
optionally, crosslinking the optionally crosslinked polymer with a crosslinking agent, a post-crosslinking monomer of formula V, or a combination thereof
[LX]-Q-[XL]_{z} V
wherein
Q is a C₁₋₃₀ hydrocarbyl group;
X is a nucleophile reactive with a lactone group;
L is a leaving group; and
z=1-5.

56. The method of claim 55, wherein the crosslinking monomer III is an N,N′—(C₁₋₁₂ alkyl)bis(meth)acrylamide, a di-, tri-, tetra-, penta-, or hexa(meth)acrylic ester of a C₁₋₁₂ polyol, a di-, tri-, tetra-, penta- or hexa(meth)acrylic ester of a C₁₋₂₄ alkyleneoxide polyol, a mono-, di-, tri-, tetra-, or higher polyester of a mono- di-, tri-, tetra-, or higher carboxylic acid having 2-6 terminal unsaturations, a di-, tri-, tetra-, penta-, or hexa(meth)allyl(C₁₋₁₂ alkane), and di-, tri-, and tetravinyl substituted C₆₋₁₂ aryl compounds.

57. The method claim 55, wherein the crosslinking monomer III is an N,N′-methylenebis(meth)acrylamide, 1,2-, 1,3-, and 1,4-butanediol di(meth)acrylate, ethyleneglycol di(meth)acrylate, propylene glycol di(meth)acrylate, diethyleneglycol di(meth)acrylate, triethyleneglycol di(meth)acrylate, polyethyleneoxide glycol di(meth)acrylate, dipropyleneglycol di(meth)acrylate, triethyleneglycol di(meth)acrylate, glycerol di(meth)acrylate, glycerol tri(meth)acrylate, 1,2- and 1,3-propanediol di(meth)acrylate, 1,2-, 1,3-, 1,4, 1,5- and 1,6-hexanediol di(meth)acrylate, 1,2- and 1,3-cyclohexanediol di(meth)acrylate, pentaerythritol di(meth)acrylate, pentaerythritol tri(meth)acrylate, pentaerythritol tetra(meth)acrylate, trimethylolpropane tri(meth)acrylate, ethoxylated trimethylolpropane tri(meth)acrylate, tris(2-hydroxyethyl) isocyanurate triacrylate, triallyl isocyanurate, allyl(meth)acrylate, pentaerythritol diallyl ether, pentaerythritol triallyl ether, pentaerythritol tetraallyl ether, diallyl ether, tetrallyloxyethane, tetrallyloxypropane, tetrallyloxybutane, divinylbenzene, divinyltoluene, divinyl xylene, trivinyl benzene, and divinyl ether.

58. The method of claim 55, wherein the comonomer IV is acrylic acid, methacrylic acid, fumaric acid, itaconic acid, maleic acid, maleic anhydride, maleimide, itaconic anhydride, styrene, n-butyl acrylate, N,N-dimethyl acrylamide, octadecyl acrylate, p-styrene sulfonate, butadiene, 2-vinylpyridine, 4-vinyl benzoic acid, N-vinyl pyrrolidone, methacrylic acid, divinyl benzene, butadiene, or a combination comprising at least one of the foregoing.

59. The method of claim 55, wherein the crosslinking agent is a compound having two or more ethylenic unsaturations, a diol or higher polyol, a diisocyanate or higher isocyanate, a diamine or higher amine, a dicarboxylic acid or higher carboxylic acid, the C₁₋₃alkyl esters thereof, or the acid halide thereof, a polyvalent ion, an alcohol-amine, or a combination comprising at least one of the forgoing crosslinking agents.

60. The method of claim 55, wherein the post-crosslinking monomer of formula V is a diol, triol, tetrol, pentol, or hexol; a diamine, triamine, tetramine, pentamines, or hexamine, or a combination comprising at least one of the forgoing the post-crosslinking monomers.

61. A coating composition comprising
a polymer binder;
an aqueous phase; and
the poly(lactone) of claim 35.

62. A method of preparing the coating composition of claim 61, comprising:
combining the polymer binder, the poly(lactone) of claim 35, and an aqueous phase.

63. A coated substrate, comprising:
a substrate having a surface; and
a coating disposed on the surface, wherein the coating comprises
a polymer binder;
optionally a pigment or a dye; and
the poly(lactone) of claim 35.

64. (canceled)

65. A method of coating a substrate, comprising:
contacting a coating composition comprising
a polymer binder,
an aqueous phase,
optionally a pigment or a dye; and
the poly(lactone) of claim 35 with a surface of the substrate to form a coating; and
drying the coating.
